(19) United States
(12) Patent Application Publication
(10) Pub. No.: US 2014/0106968 A1
(43) Pub. Date: Apr. 17, 2014

(54) SUBSTITUTED 1,2,4-TRIAZINE-3,5-DIONES AS HERBICIDES

(71) Applicant: E I Du Pont De Nemours and Company, Wilmington, DE (US)

(72) Inventors: ANDREW EDMUND TAGGI, Newark, DE (US); Andrew Duncan Satterfield, Bear, DE (US)

(73) Assignee: E I DU PONT DE NEMOURS AND COMPANY, Wilmington, DE (US)

(21) Appl. No.: 14/053,690

(22) Filed: Oct. 15, 2013

Related U.S. Application Data
(60) Provisional application No. 61/713,958, filed on Oct. 15, 2012.

(51) Int. Cl. A01N 43/707

(52) U.S. Cl. CPC A01N 43/707
USPC 504/103; 544/182; 504/229; 504/133

(57) ABSTRACT

Disclosed are compounds of Formula 1, including all stereoisomers, N-oxides, and salts thereof,

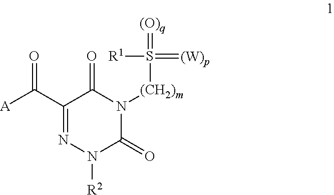

wherein
A is a radical selected from the group consisting of

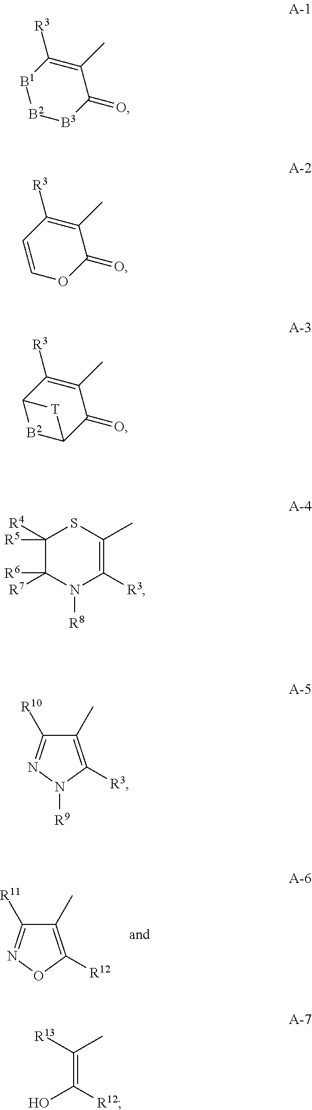

and A, R¹, R², m, p, and q are as defined in the disclosure. Also disclosed are compositions containing the compounds of Formula 1 and methods for controlling undesired vegetation comprising contacting the undesired vegetation or its environment with an effective amount of a compound or a composition of the invention.

### FIELD OF THE INVENTION

This invention relates to certain substituted 1,2,4-triazine-3,5-diones, their salts and compositions, and methods of their use for controlling undesired vegetation.

### BACKGROUND OF THE INVENTION

The control of undesired vegetation is extremely important in achieving high crop efficiency. Achievement of selective control of the growth of weeds especially in such useful crops as rice, soybean, sugar beet, maize, potato, wheat, barley, tomato and plantation crops, among others, is very desirable. Unchecked weed growth in such useful crops can cause significant reduction in productivity and thereby result in increased costs to the consumer. The control of undesired vegetation in noncrop areas is also important. Many products are commercially available for these purposes, but the need continues for new compounds that are more effective, less costly, less toxic, environmentally safe or have different sites of action.

### SUMMARY OF THE INVENTION

This invention is directed to compounds of Formula 1 (including all stereoisomers), N-oxides, and salts thereof, agricultural compositions containing them and their use as herbicides:

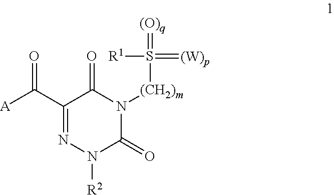

wherein
A is a radical selected from the group consisting of

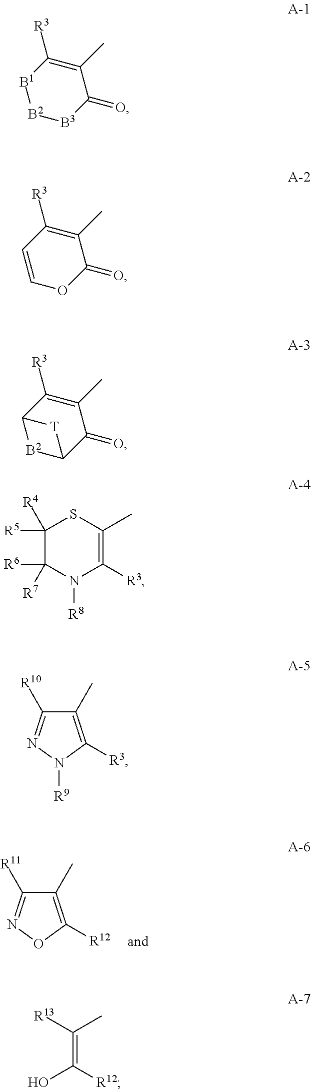

B¹ and B³ are each independently a radical selected from the group consisting of

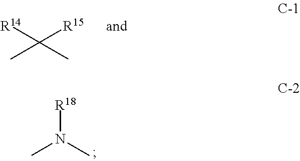

B² is a radical selected from the group consisting of

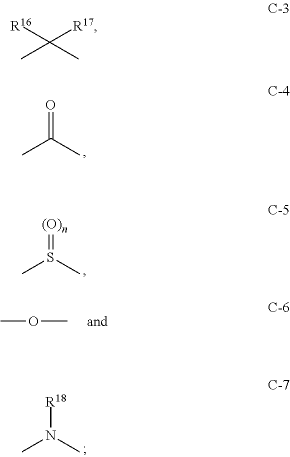

R¹ is C₁-C₆ alkyl, C₃-C₆ alkenyl, C₃-C₆ alkynyl, C₂-C₆ alkoxyalkyl, C₄-C₈ alkoxyalkenyl, C₄-C₈ alkoxyalkynyl, C₃-C₈ alkoxyalkoxyalkyl, C₄-C₁₀ cycloalkylalkyl, C₄-C₁₀ cycloalkoxylalkyl, oxiranyl(C₁-C₃ alkyl), oxetanyl(C₁-C₃ alkyl), tetrahydrofuranyl(C₁-C₃ alkyl) or tetrahydropyranyl(C₁-C₃ alkyl);
m is 1 through 5;
each W is independently O, N—CN, N—NO₂, N—S═O, N—R^{A}, N—OR^{B} or N—N(R^{C})₂;
R^{A} is H, CHO, C₁-C₄ alkyl, C₁-C₄ alkylcarbonyl, C₁-C₄ alkoxycarbonyl; R^{B} is H or C₁-C₄ alkyl;
each R^{C} is H, CHO, C₁-C₄ alkyl, C₁-C₄ alkylcarbonyl, C₁-C₄ alkoxycarbonyl;
N(R^{C})₂ can be taken together to form K;
K is a ring containing, in addition to the nitrogen atom to which the substituent pair (R^{C})₂ is attached, from 2 to 6 atoms of carbon and optionally an additional atom of nitrogen, sulfur or oxygen, said ring optionally substituted with up to four substituents selected from the group consisting of C₁-C₂ alkyl, halogen, CN, NO₂ and C₁-C₂ alkoxy;
each p and q is independently 0 or 1;
T is C₁-C₆ alkylene or C₂-C₆ alkenylene;
R² is C₁-C₄ alkyl, C₂-C₄ alkenyl, C₁-C₄ cyanoalkyl, C₃-C₅ cycloalkyl, C₁-C₄ alkoxy, C₂-C₄ alkoxyalkyl or C₄-C₈ cycloalkylalkyl;
R³ is H, halogen, cyano, hydroxy, —O⁻M⁺, amino, nitro, —CHO, —C(═O)OH, —C(═O)NH₂, —C(═S)NH₂, —SH, —SO₂NH₂, —SO₂NHCN, —SO₂NHOH, —OCN, —SCN, —SF₅, —NHNH₂, —NHOH, —N═C═O, —N═C═S, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₂-C₆ alkynyloxy, C₃-C₆ haloalkynyloxy, C₂-C₈ alkoxyalkoxy, C₂-C₈ alkylcarbonyloxy, C₂-C₈ haloalkylcarbonyloxy, C₄-C₁₀ cycloalkylcarbonyloxy, C₃-C₁₀ alkylcarbonylalkoxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl, C₃-C₈ cycloalkylsulfonyl, C₁-C₆ alkylsulfonyloxy, C₁-C₆ alkylamino, C₂-C₈ dialkylamino, C₁-C₆ haloalkylamino, C₂-C₈ halodialkylamino, C₃-C₈ cycloalkylamino, C₂-C₈ alkylcarbonylamino, C₂-C₈ haloalkylcarbonylamino, C₁-C₆ alkylsulfonylamino or C₁-C₆ haloalkylsulfonylamino; or benzyloxy, phenyloxy, benzylcarbonyloxy, phenylcarbonyloxy, phenylsulfonyloxy, benzylsulfonyloxy, phenylthio, benzylthio, phenylsulfinyl, benzylsulfinyl, phenylsulfonyl or benzylsulfonyl, each optionally substituted on ring members with up to five substituents selected from R¹⁹;
M⁺ is an alkali metal cation or an ammonium cation;
R⁴, R⁵, R⁶ and R⁷ are each independently H, halogen, hydroxy, C₁-C₆ alkyl, C₂-C₆ alkenyl, C₂-C₆ alkynyl, C₁-C₆ haloalkyl, C₁-C₆ alkoxy, C₁-C₆ haloalkoxy, C₃-C₈ cycloalkoxy or C₃-C₈ halocycloalkoxy; or phenyl or benzyl, each optionally substituted on ring members with up to five substituents selected from R¹⁹;
R⁸ is H, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl or C₃-C₈ halocycloalkyl; or benzyl optionally substituted on ring members with up to five substituents selected from R¹⁹;
R⁹ is H, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₆-C₁₄ cycloalkylcycloalkyl, C₄-C₁₀ halocycloalkylalkyl, C₅-C₁₂ alkylcycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl or C₂-C₈ alkylthioalkyl;
R¹⁰ is H, halogen, C₁-C₆ alkyl, C₂-C₆ alkenyl, C₂-C₆ alkynyl or C₃-C₈ cycloalkyl;
R¹¹ is H, halogen, cyano, hydroxy, amino, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₄-C₁₀ halocycloalkylalkyl, C₅-C₁₂ alkylcycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl, C₂-C₈ alkylthioalkyl, C₂-C₈ alkylsulfinylalkyl or C₂-C₈ alkylsulfonylalkyl; or phenyl optionally substituted with up to five substituents selected from R¹⁹;
R¹² is H, halogen, cyano, hydroxy, amino, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₆-C₁₄ cycloalkylcycloalkyl, C₄-C₁₀ halocycloalkylalkyl, C₅-C₁₂ alkylcycloalkylalkyl, C₃-C₈ cycloalkenyl, C₃-C₈ halocycloalkenyl or C₂-C₈ alkoxycarbonylamino;
R¹³ is H, halogen, cyano, hydroxy, amino, nitro or C₂-C₈ alkoxycarbonyl;
n is 0, 1, or 2;
each R¹⁴, R¹⁵, R¹⁶ and R¹⁷ is independently H, halogen, cyano, hydroxy or C₁-C₆ alkyl; or
a pair of R¹⁴ and R¹⁶ is taken together as C₂-C₆ alkylene or C₂-C₆ alkenylene;
R¹⁸ is H, C₁-C₆ haloalkyl, C₂-C₆ haloalkenyl, C₁-C₆ alkoxy, C₁-C₆ haloalkoxy, C₃-C₈ cycloalkoxy, C₁-C₆ alkyl, C₂-C₆ alkenyl, C₂-C₆ alkynyl or C₃-C₈ cycloalkyl; and
each R¹⁹ is independently halogen, cyano, hydroxy, amino, nitro, —CHO, —C(═O)OH, —C(═O)NH₂, —C(═S)NH₂, —C(═O)NHCN, —C(═O)NHOH, —SH, —SO₂NH₂, —SO₂NHCN, —SO₂NHOH, —OCN, —SCN, —SF₅, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl, C₂-C₈ alkylthioalkyl, C₂-C₈ alkylsulfinylalkyl, C₂-C₈ alkoxyhaloalkyl, C₂-C₅ cyanoalkyl, C₁-C₆ hydroxyalkyl, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₂-C₈ alkoxyalkoxy, C₂-C₈ alkylcarbonyloxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl, C₃-C₈ cycloalkylsulfonyl, C₁-C₆ alkylamino, C₂-C₈ dialkylamino, C₁-C₆ haloalkylamino, C₂-C₈ halodialkylamino or C₃-C₈ cycloalkylamino;
provided when
i) W is O and each p and q is 1;
ii) p is 1 and q is 0; or
iii) each p and q is independently 0
then R¹ is other than C₁-C₆ alkyl.

More particularly, this invention pertains to a compound of Formula 1 (including all stereoisomers), an N-oxide, or a salt thereof. This invention also relates to a herbicidal composition comprising a compound of the invention (i.e. in a herbicidally effective amount) and at least one component selected from the group consisting of surfactants, solid diluents and liquid diluents. This invention further relates to a method for controlling the growth of undesired vegetation comprising contacting the vegetation or its environment with a herbicidally effective amount of a compound of the invention (e.g., as a composition described herein).

### DETAILS OF THE INVENTION

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where applicants have defined an invention or a portion thereof with an open-ended term such as “comprising,” it should be readily understood that (unless otherwise stated) the description should be interpreted to also describe such an invention using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As referred to herein, the term “seedling”, used either alone or in a combination of words means a young plant developing from the embryo of a seed.

As referred to herein, the term “broadleaf” used either alone or in words such as “broadleaf weed” means dicot or dicotyledon, a term used to describe a group of angiosperms characterized by embryos having two cotyledons.

As used herein, the term “alkylating agent” refers to a chemical compound in which a carbon-containing radical is bound through a carbon atom to leaving group such as halide or sulfonate, which is displaceable by bonding of a nucleophile to said carbon atom. Unless otherwise indicated, the term “alkylating” does not limit the carbon-containing radical to alkyl; the carbon-containing radicals in alkylating agents include the variety of carbon-bound.

In the above recitations, the term “alkyl”, used either alone or in compound words such as “alkylthio” or “haloalkyl” includes straight-chain or branched alkyl, such as, methyl, ethyl, n-propyl, i-propyl, or the different butyl, pentyl or hexyl isomers. “Alkenyl” includes straight-chain or branched alkenes such as ethenyl, 1-propenyl, 2-propenyl, and the different butenyl, pentenyl and hexenyl isomers. “Alkenyl” also includes polyenes such as 1,2-propadienyl and 2,4-hexadienyl. “Alkynyl” includes straight-chain or branched alkynes such as ethynyl, 1-propynyl, 2-propynyl and the different butynyl, pentynyl and hexynyl isomers. “Alkynyl” can also include moieties comprised of multiple triple bonds such as 2,5-hexadiynyl. “Alkylene” denotes a straight-chain or branched alkanediyl. Examples of “alkylene” include CH₂, CH₂CH₂, CH(CH₃), CH₂CH₂CH₂, CH₂CH(CH₃) and the different butylene isomers. “Alkenylene” denotes a straight-chain or branched alkenediyl containing one olefinic bond. Examples of “alkenylene” include CH═CH, CH₂CH═CH, CH═C(CH₃) and the different butenylene isomers. “Alkynylene” denotes a straight-chain or branched alkynediyl containing one triple bond. Examples of “alkynylene” include C≡C, CH₂C≡C, C≡CCH₂ and the different butynylene isomers.

“Alkoxy” includes, for example, methoxy, ethoxy, n-propyloxy, isopropyloxy and the different butoxy, pentoxy and hexyloxy isomers. “Alkoxyalkyl” denotes alkoxy substitution on alkyl. Examples of “alkoxyalkyl” include CH₃OCH₂, CH₃OCH₂CH₂, CH₃CH₂OCH₂, CH₃CH₂CH₂CH₂OCH₂ and CH₃CH₂OCH₂CH₂. “Alkoxyalkenyl” denotes alkoxy substitution on alkenyl. Examples of “alkoxyalkenyl” include CH₃OCH₂CH═CH, and CH₃OCH₂CH₂CH═CH. “Alkoxyalkynyl” denotes alkoxy substitution on alkynyl. Examples of “alkoxyalkynyl” include CH₃OCH₂CH≡C, and CH₃OCH₂CH₂CH≡C. “Alkoxyalkoxy” denotes alkoxy substitution on alkoxy. “Alkoxyalkoxyalkyl” denotes alkoxy substitution on alkoxyalkyl. “Alkenyloxy” includes straight-chain or branched alkenyloxy moieties. Examples of “alkenyloxy” include H₂C═CHCH₂O, (CH₃)₂C═CHCH₂O, (CH₃)CH═CHCH₂O, (CH₃)CH═C(CH₃)CH₂O and CH₂═CHCH₂CH₂O. “Alkynyloxy” includes straight-chain or branched alkynyloxy moieties. Examples of “alkynyloxy” include HC≡CCH₂O, CH₃C≡CCH₂O and CH₃C≡CCH₂CH₂O. “Alkylthio” includes branched or straight-chain alkylthio moieties such as methylthio, ethylthio, and the different propylthio, butylthio, pentylthio and hexylthio isomers. “Alkylsulfinyl” includes both enantiomers of an alkylsulfinyl group. Examples of “alkylsulfinyl” include CH₃S(O)—, CH₃CH₂S(O)—, CH₃CH₂CH₂S(O)—, (CH₃)₂CHS(O)— and the different butylsulfinyl, pentylsulfinyl and hexylsulfinyl isomers. Examples of “alkylsulfonyl” include CH₃S(O)₂—, CH₃CH₂S(O)₂—, CH₃CH₂CH₂S(O)₂—, (CH₃)₂CHS(O)₂—, and the different butylsulfonyl, pentylsulfonyl and hexylsulfonyl isomers. The term “alkylsulfonyloxy” denotes an alkylsulfonyl group bonded through oxygen. Examples of “alkylsulfonyloxy” include CH₃S(O)₂O—, CH₃CH₂S(O)₂O— and CH₃CH₂CH₂S(O)₂O—. “Alkylthioalkyl” denotes alkylthio substitution on alkyl. Examples of “alkylthioalkyl” include CH₃SCH₂, CH₃SCH₂CH₂, CH₃CH₂SCH₂, CH₃CH₂CH₂CH₂SCH₂ and CH₃CH₂SCH₂CH₂. The terms “alkylsulfinylalkyl” and “alkylsulfonylalkyl” are defined analogously to alkylthioalkyl. “Cyanoalkyl” denotes an alkyl group substituted with one cyano group. Examples of “cyanoalkyl” include NCCH₂, NCCH₂CH₂ and CH₃CH(CN)CH₂. “Hydroxyalkyl” and “nitroalkyl” are defined analogously to cyanoalkyl. “Alkylamino”, “dialkylamino”, and the like, are defined analogously to the above examples. “Alkylcarbonylamino” denotes alkyl substitution on a carbonylamino moiety. Examples of “alkylcarbonylamino” include CH₃C(═O)NH— and CH₃CH₂CH₂C(═O)NH—. “Alkoxycarbonylamino” denotes alkoxy substitution on a carbonylamino moiety. Examples of “alkoxycarbonylamino” include CH₃C(═O)NH— and CH₃CH₂CH₂OC(═O)NH—. The term “alkylsulfonylamino” denotes alkylsulfonyl substitution on an amino group. Examples of “alkylsulfonylamino” include CH₃S(═O)₂NH— and CH₃CH₂CH₂S(═O)₂NH—

“Cycloalkyl” includes, for example, cyclopropyl, cyclobutyl, cyclopentyl and cyclohexyl. The term “alkylcycloalkyl” denotes alkyl substitution on a cycloalkyl moiety and includes, for example, ethylcyclopropyl, i-propylcyclobutyl, 3-methylcyclopentyl and 4-methylcyclohexyl. The term “cycloalkylalkyl” denotes cycloalkyl substitution on an alkyl moiety. Examples of “cycloalkylalkyl” include cyclopropylmethyl, cyclopentylethyl, and other cycloalkyl moieties bonded to straight-chain or branched alkyl groups. The term “alkylcyclalkylalkyl” denotes alkyl substitution on the cycloalkyl portion of a “cycloalkylalkyl moiety. The term “cycloalkylcycloalkyl” denotes cycloalkyl substitution on a cycloalkyl group. The term “cycloalkoxy” denotes cycloalkyl linked through an oxygen atom such as cyclopentyloxy and cyclohexyloxy. The term “cycloalkylthio” denotes cycloalkyl linked through a sulfur atom. The term “cycloalkylsulfonyl” denotes cycloalkyl linked through a sulfonyl group. The term “cycloalkylamino” denotes cycloalkyl linked through an amino group (e.g., (cyclopropyl)NH—). The term “cycloalkylcarbonyloxy” denotes cycloalkyl linked through a carbonyloxy moiety (e.g., (cyclobutyl)C(═O)O—). “Cycloalkylalkoxy” denotes cycloalkylalkyl linked through an oxygen atom attached to the alkyl chain. Examples of “cycloalkylalkoxy” include cyclopropylmethoxy, cyclopentylethoxy, and other cycloalkyl moieties bonded to straight-chain or branched alkoxy groups. “Cycloalkoxyalkyl” denotes a cycloalkoxy group bonded through an alkyl group. “Cycloalkenyl” includes groups such as cyclopentenyl and cyclohexenyl as well as groups with more than one double bond such as 1,3- and 1,4-cyclohexadienyl.

The term “halogen”, either alone or in compound words such as “haloalkyl”, “haloalkenyl”, “haloalkenyloxy”, “haloalkoxy”, “haloalkylamino”, “haloalkylcarbonylamino”, “haloalkylcarbonyloxy”, “haloalkylsulfinyl”, “haloalkylsulfonyl”, “haloalkylsulfonylamino”, “haloalkylthio”, “haloalkynyl”, “haloalkynyloxy”, “halocycloalkenyl”, “halocycloalkoxy”, “halocycloalkyl”, “halocycloalkylalkyl”, or “halodialkylamino”, or when used in descriptions such as “alkyl substituted with halogen” includes fluorine, chlorine, bromine or iodine. Further, when used in compound words such as “haloalkyl”, or when used in descriptions such as “alkyl substituted with halogen” said alkyl may be partially or fully substituted with halogen atoms which may be the same or different. Examples of “haloalkyl” or “alkyl substituted with halogen” include F₃C—, ClCH₂—, CF₃CH₂— and CF₃CCl₂—. The terms “halocycloalkyl”, “haloalkoxy”, “haloalkylthio”, “haloalkenyl”, “haloalkynyl”, and the like, are defined analogously to the term “haloalkyl”. Examples of “haloalkoxy” include CF₃O—, CCl₃CH₂O—, HCF₂CH₂CH₂O— and CF₃CH₂O—. Examples of “haloalkylthio” include CCl₃S—, CF₃S—, CCl₃CH₂S— and ClCH₂CH₂CH₂S—. Examples of “haloalkylsulfinyl” include CF₃S(O)—, CCl₃S(O)—, CF₃CH₂S(O)— and CF₃CF₂S(O)—. Examples of “haloalkylsulfonyl” include CF₃S(O)₂—, CCl₃S(O)₂—, CF₃CH₂S(O)₂— and CF₃CF₂S(O)₂—. Examples of “haloalkenyl” include (Cl)₂C═CHCH₂— and CF₃CH₂CH═CHCH₂—. Examples of “haloalkynyl” include HC≡CCHCl—, CF₃C≡C—, CCl₃C≡C— and FCH₂C≡CCH₂—. Examples of “haloalkoxyalkoxy” include CF₃OCH₂O—, ClCH₂CH₂OCH₂CH₂O—, Cl₃CCH₂OCH₂O— as well as branched alkyl derivatives. Examples of “alkoxyhaloalkyl” include CH₃OCHF—, CH₃CH₂OCHClCH₂— and CH₃OCH₂CHClCH₂O—.

“Alkylcarbonyl” denotes a straight-chain or branched alkyl moieties bonded to a C(═O) moiety. Examples of “alkylcarbonyl” include CH₃C(═O)—, CH₃CH₂CH₂C(═O)— and (CH₃)₂CHC(═O)—. Examples of “alkoxycarbonyl” include CH₃C(═O)—, CH₃CH₂C(═O)—, CH₃CH₂CH₂C(═O)—, (CH₃)₂CHOC(═O)— and the different butoxy- or pentoxycarbonyl isomers. The term “alkylcarbonyloxy” denotes alkylcarbonyl substitution bonded through oxygen. Examples of “alkylcarbonyloxy” include CH₃C(═O)O—, CH₃CH₂C(═O)O— and CH₃CH₂CH₂CH₂C(═O)O—. The term “alkylcarbonylalkoxy” denotes alkylcarbonyl substitution on an alkoxy moiety. Examples of “alkylcarbonylalkoxy” include CH₃C(═O)CH₂O—, CH₃CH₂C(═O)CH₂O— and CH₃CH₂C(═O)CH₂CH₂O—.

The term “oxiranyl(C₁-C₃ alkyl)” denotes oxirane substitution on a C₁-C₃ alkyl group. Examples of “oxiranyl(C₁-C₃ alkyl)” include:

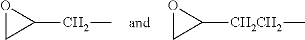

The term “oxetanyl(C₁-C₃ alkyl)” denotes oxetane substitution on a C₁-C₃ alkyl group. Examples of “oxetanyl(C₁-C₃ alkyl)” include:

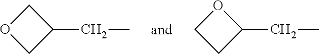

The term “tetrahydrofuranyl(C₁-C₃ alkyl)” denotes tetrahydrofuran substitution on a C₁-C₃ alkyl group. Examples of “tetrahydrofuranyl(C₁-C₃ alkyl)” include:

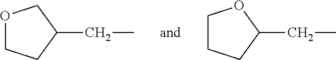

The term “tetrahydropyranyl(C₁-C₃ alkyl)” denotes tetrahydropyran substitution on a C₁-C₃ alkyl group. Examples of “tetrahydropyranyl(C₁-C₃ alkyl)” include:

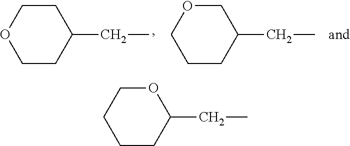

The total number of carbon atoms in a substituent group is indicated by the “Cᵢ-Cⱼ” prefix where i and j are numbers from 1 to 14. For example, C₁-C₄ alkylsulfonyl designates methylsulfonyl through butylsulfonyl; C₂ alkoxyalkyl designates CH₃OCH₂—; C₃ alkoxyalkyl designates, for example, CH₃CH(OCH₃)—, CH₃OCH₂CH₂— or CH₃CH₂OCH₂—; and C₄ alkoxyalkyl designates the various isomers of an alkyl group substituted with an alkoxy group containing a total of four carbon atoms, examples including CH₃CH₂CH₂OCH₂— and CH₃CH₂OCH₂CH₂—.

When a compound is substituted with a substituent bearing a subscript that indicates the number of said substituents can exceed 1, said substituents (when they exceed 1) are independently selected from the group of defined substituents, e.g., (CH₂)ₘ, m is 1, 2, 3, 4 or 5. When a group contains a substituent which can be hydrogen, for example R^{A}, R^{B}, R^{C}, R³, R⁴, R⁵, R⁶, R¹⁰, R¹¹, R¹², R¹³, R¹⁴, R¹⁵, R¹⁶ and R¹⁸, then when this substituent is taken as hydrogen, it is recognized that this is equivalent to said group being unsubstituted. When a variable group is shown to be optionally attached to a position, for example R¹⁹ substitution on R³, wherein “n” may be 0, then hydrogen may be at the position even if not recited in the variable group definition. When one or more positions on a group are said to be “not substituted” or “unsubstituted”, then hydrogen atoms are attached to take up any free valency.

The term “optionally substituted” in connection with the K ring refers to groups which are unsubstituted or have at least one non-hydrogen substituent that does not extinguish the biological activity possessed by the unsubstituted analog. As used herein, the following definitions shall apply unless otherwise indicated. The term “optionally substituted” is used interchangeably with the phrase “substituted or unsubstituted” or with the term “(un)substituted.” Unless otherwise indicated, an optionally substituted group may have a substituent at each substitutable position of the group, and each substitution is independent of the other.

A wide variety of synthetic methods are known in the art to enable preparation of aromatic and nonaromatic heterocyclic rings and ring systems; for extensive reviews see the eight volume set of Comprehensive Heterocyclic Chemistry, A. R. Katritzky and C. W. Rees editors-in-chief, Pergamon Press, Oxford, 1984 and the twelve volume set of Comprehensive Heterocyclic Chemistry II, A. R. Katritzky, C. W. Rees and E. F. V. Scriven editors-in-chief, Pergamon Press, Oxford, 1996.

The compounds of this invention can exist as one or more stereoisomers. The various stereoisomers include enantiomers, diastereomers, atropisomers and geometric isomers. One skilled in the art will appreciate that one stereoisomer may be more active and/or may exhibit beneficial effects when enriched relative to the other stereoisomer(s) or when separated from the other stereoisomer(s). Additionally, the skilled artisan knows how to separate, enrich, and/or to selectively prepare said stereoisomers. The compounds of the invention may be present as a mixture of stereoisomers, individual stereoisomers or as an optically active form. For example, when p is 0 and q is 1, then Formula 1 possesses a chiral sulfur atom. The lone pair of electrons which resides on the sulfur atom gives it a tetrahedral geometry as for an sp³ carbon. When the two organic residues R′ and R″ are dissimilar, the sulfur is a chiral center and the two enantiomers are depicted as Formula 1′ and 1″ as shown below.

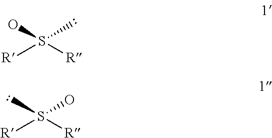

Molecular depictions drawn herein follow standard conventions for depicting stereochemistry. To indicate stereoconfiguration, bonds rising from the plane of the drawing and towards the viewer are denoted by solid wedges wherein the broad end of the wedge is attached to the atom rising from the plane of the drawing towards the viewer. Bonds going below the plane of the drawing and away from the viewer are denoted by dashed wedges wherein the narrow end of the wedge is attached to the atom further away from the viewer. Constant width lines indicate bonds with a direction opposite or neutral relative to bonds shown with solid or dashed wedges; constant width lines also depict bonds in molecules or parts of molecules in which no particular stereoconfiguration is intended to be specified.

This invention also comprises racemic mixtures, for example, equal amounts of the enantiomers of Formulae 1′ and 1″. In addition, this invention includes compounds that are enriched compared to the racemic mixture in an enantiomer of Formula 1. Also included are the essentially pure enantiomers of compounds of Formula 1, for example, Formula 1′ and Formula 1″.

When enantiomerically enriched, one enantiomer is present in greater amounts than the other, and the extent of enrichment can be defined by an expression of enantiomeric excess (“ee”), which is defined as (2x−1)·100%, where x is the mole fraction of the dominant enantiomer in the mixture (e.g., an ee of 20% corresponds to a 60:40 ratio of enantiomers).

Preferably the compositions of this invention have at least a 50% enantiomeric excess; more preferably at least a 75% enantiomeric excess; still more preferably at least a 90% enantiomeric excess; and the most preferably at least a 94% enantiomeric excess of the more active isomer. Of particular note are enantiomerically pure embodiments of the more active isomer.

Compounds of Formula 1 can comprise additional chiral centers. For example, substituents and other molecular constituents such as R² and R³ may themselves contain chiral centers. This invention comprises racemic mixtures as well as enriched and essentially pure stereoconfigurations at these additional chiral centers.

Compounds of Formula 1 typically exist in more than one form, and Formula 1 thus include all crystalline and non-crystalline forms of the compounds they represent. Non-crystalline forms include embodiments which are solids such as waxes and gums as well as embodiments which are liquids such as solutions and melts. Crystalline forms include embodiments which represent essentially a single crystal type and embodiments which represent a mixture of polymorphs (i.e. different crystalline types). The term “polymorph” refers to a particular crystalline form of a chemical compound that can crystallize in different crystalline forms, these forms having different arrangements and/or conformations of the molecules in the crystal lattice. Although polymorphs can have the same chemical composition, they can also differ in composition due the presence or absence of co-crystallized water or other molecules, which can be weakly or strongly bound in the lattice. Polymorphs can differ in such chemical, physical and biological properties as crystal shape, density, hardness, color, chemical stability, melting point, hygroscopicity, suspensibility, dissolution rate and biological availability. One skilled in the art will appreciate that a polymorph of a compound of Formula 1 can exhibit beneficial effects (e.g., suitability for preparation of useful formulations, improved biological performance) relative to another polymorph or a mixture of polymorphs of the same compound of Formula 1. Preparation and isolation of a particular polymorph of a compound of Formula 1 can be achieved by methods known to those skilled in the art including, for example, crystallization using selected solvents and temperatures.

One skilled in the art will appreciate that not all nitrogen-containing heterocycles can form N-oxides since the nitrogen requires an available lone pair for oxidation to the oxide; one skilled in the art will recognize those nitrogen-containing heterocycles which can form N-oxides. One skilled in the art will also recognize that tertiary amines can form N-oxides. Synthetic methods for the preparation of N-oxides of heterocycles and tertiary amines are very well known by one skilled in the art including the oxidation of heterocycles and tertiary amines with peroxy acids such as peracetic and m-chloroperbenzoic acid (MCPBA), hydrogen peroxide, alkyl hydroperoxides such as t-butyl hydroperoxide, sodium perborate, and dioxiranes such as dimethyldioxirane. These methods for the preparation of N-oxides have been extensively described and reviewed in the literature, see for example: T. L. Gilchrist in Comprehensive Organic Synthesis, vol. 7, pp 748-750, S. V. Ley, Ed., Pergamon Press; M. Tisler and B. Stanovnik in Comprehensive Heterocyclic Chemistry, vol. 3, pp 18-20, A. J. Boulton and A. McKillop, Eds., Pergamon Press; M. R. Grimmett and B. R. T. Keene in Advances in Heterocyclic Chemistry, vol. 43, pp 149-161, A. R. Katritzky, Ed., Academic Press; M. Tisler and B. Stanovnik in Advances in Heterocyclic Chemistry, vol. 9, pp 285-291, A. R. Katritzky and A. J. Boulton, Eds., Academic Press; and G. W. H. Cheeseman and E. S. G. Werstiuk in Advances in Heterocyclic Chemistry, vol. 22, pp 390-392, A. R. Katritzky and A. J. Boulton, Eds., Academic Press.

One skilled in the art recognizes that because in the environment and under physiological conditions salts of chemical compounds are in equilibrium with their corresponding nonsalt forms, salts share the biological utility of the nonsalt forms. Thus a wide variety of salts of a compound of Formula 1 are useful for control of undesired vegetation (i.e. are agriculturally suitable). The salts of a compound of Formula 1 include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids. When a compound of Formula 1 contains an acidic moiety such as a carboxylic acid or phenol (or, for example, when R³ is O⁻M⁺), salts also include those formed with organic or inorganic bases such as pyridine, triethylamine or ammonia, or amides, hydrides, hydroxides or carbonates of sodium, potassium, lithium, calcium, magnesium or barium. Accordingly, the present invention comprises compounds selected from Formula 1, N-oxides and agriculturally suitable salts thereof.

Embodiments of the present invention as described in the Summary of the Invention include (where Formula 1 as used in the following Embodiments includes N-oxides and salts thereof): Embodiments of the invention include the following:

### Embodiment 1

A compound of Formula 1 (including all stereoisomers), N-oxides, and salts thereof, agricultural compositions containing them and their use as herbicides as described in the Summary of the Invention.

### Embodiment 2

A compound of Embodiment 1 wherein A is A-1, A-3, A-5 or A-6.

### Embodiment 3

A compound of Embodiment 2 wherein A is A-1, A-3 or A-5.

### Embodiment 4

A compound of Embodiment 3 wherein A is A-1 or A-3.

### Embodiment 5

A compound of Embodiment 4 wherein A is A-1.

### Embodiment 6

A compound of Embodiment 4 wherein A is A-3.

### Embodiment 7

A compound of any one of Embodiments 1 through 5 wherein A is other than A-1.

### Embodiment 8

A compound of any one of Embodiments 1 through 7 wherein B¹ is C-1.

### Embodiment 9

A compound of any one of Embodiments 1 through 7 wherein B¹ is

C-2.

### Embodiment 10

A compound of any one of Embodiments 1 through 9 wherein B² is

C-3.

### Embodiment 11

A compound of any one of Embodiments 1 through 9 wherein B² is

C-4.

### Embodiment 12

A compound of any one of Embodiments 1 through 11 wherein B³ is C-1.

### Embodiment 13

A compound of any one of Embodiments 1 through 11 wherein B³ is C-2.

### Embodiment 14

A compound of any one of Embodiments 1 through 13 wherein R¹ is C₁-C₆ alkyl, C₃-C₆ alkenyl, C₃-C₆ alkynyl, C₂-C₆ alkoxyalkyl, C₄-C₈ alkoxyalkenyl, C₄-C₈ alkoxyalkynyl, C₃-C₈ alkoxyalkoxyalkyl, C₄-C₁₀ cycloalkylalkyl, C₄-C₁₀ cycloalkoxylalkyl, oxiranyl(C₁-C₃ alkyl), oxetanyl(C₁-C₃ alkyl) or tetrahydrofuranyl(C₁-C₃ alkyl).

### Embodiment 15

A compound of Embodiment 14 wherein R¹ is C₁-C₆ alkyl, C₃-C₆ alkenyl, C₃-C₆ alkynyl, C₂-C₆ alkoxyalkyl, C₄-C₈ alkoxyalkenyl, C₄-C₈ alkoxyalkynyl, C₃-C₈ alkoxyalkoxyalkyl, C₄-C₁₀ cycloalkylalkyl, C₄-C₁₀ cycloalkoxylalkyl, oxiranyl(C₁-C₃ alkyl) or oxetanyl(C₁-C₃ alkyl).

### Embodiment 16

A compound of Embodiment 15 wherein R¹ is C₁-C₆ alkyl, C₃-C₆ alkenyl, C₃-C₆ alkynyl, C₂-C₆ alkoxyalkyl, C₄-C₈ alkoxyalkenyl, C₄-C₈ alkoxyalkynyl, C₃-C₈ alkoxyalkoxyalkyl, C₄-C₁₀ cycloalkylalkyl or C₄-C₁₀ cycloalkoxylalkyl.

### Embodiment 17

A compound of Embodiment 16 wherein R¹ is C₁-C₆ alkyl or C₄-C₁₀ cycloalkylalkyl.

### Embodiment 18

A compound of Embodiment 17 wherein R¹ is C₁-C₆ alkyl.

### Embodiment 19

A compound of Embodiment 18 wherein R¹ is CH₃.

### Embodiment 20

A compound of Embodiment 17 wherein R¹ is C₄-C₁₀ cycloalkylalkyl.

### Embodiment 21

A compound of Embodiment 20 wherein R¹ is cyclopropylethyl.

### Embodiment 22

A compound of any one of Embodiments 1 through 21 wherein m is 1, 2, 3 or 4.

### Embodiment 23

A compound of Embodiment 22 wherein m is 1, 2 or 3.

### Embodiment 24

A compound of Embodiment 23 wherein m is 1.

### Embodiment 25

A compound of Embodiment 23 wherein m is 2.

### Embodiment 26

A compound of Embodiment 23 wherein m is 3.

### Embodiment 27

A compound of any one of Embodiments 1 through 26 wherein each W is independently O, N—CN, N—NO₂, N—S═O, N—R^{A} or N—OR^{B}.

### Embodiment 28

A compound of Embodiment 27 wherein each W is independently O, N—CN, N—NO₂ or N—S═O.

### Embodiment 28A

A compound of Embodiment 27 wherein each W is independently O or N—CN.

### Embodiment 28B

A compound of Embodiment 27 wherein each W is independently N—CN.

### Embodiment 29

A compound of Embodiment 27 wherein each W is independently O.

### Embodiment 30

A compound of any one of Embodiments 1 through 29 wherein R^{A} is H, C₁-C₄ alkyl or C₁-C₄ alkylcarbonyl.

### Embodiment 31

A compound of Embodiment 30 wherein R^{A} is H or C₁-C₄ alkyl.

### Embodiment 32

A compound of Embodiment 31 wherein R^{A} is H or CH₃.

### Embodiment 33

A compound of any one of Embodiments 1 through 27 wherein R^{B} is H or C₁-C₄ alkyl.

### Embodiment 34

A compound of Embodiment 33 wherein R^{B} is H, CH₃ or CH₂CH₃.

### Embodiment 35

A compound of Embodiment 34 wherein R^{B} is H or CH₃.

### Embodiment 36

A compound of any one of Embodiments 1 through 35 wherein p is 0.

### Embodiment 37

A compound of any one of Embodiments 1 through 35 wherein p is 1.

### Embodiment 38

A compound of any one of Embodiments 1 through 37 wherein q is 0.

### Embodiment 38A

A compound of any one of Embodiments 1 through 37 wherein q is 1

### Embodiment 39

A compound of any one of Embodiments 1 through 4, 6, 10, 11 and 14 through 38A wherein T is —CH₂CH₂— or —CH═CH—.

### Embodiment 40

A compound Embodiments 39 wherein T is —CH₂CH₂—.

### Embodiment 41

A compound of any one of Embodiments 1 through 40 wherein R² is C₁-C₄ alkyl, C₃-C₅ cycloalkyl, C₂-C₄ alkoxyalkyl or C₄-C₈ cycloalkylalkyl.

### Embodiment 42

A compound of Embodiment 41 wherein R² is C₁-C₄ alkyl or C₃-C₅ cycloalkyl.

### Embodiment 43

A compound of Embodiment 42 wherein R² is CH₃ or cyclopropyl.

### Embodiment 44

A compound of Embodiment 43 wherein R² is CH₃.

### Embodiment 45

A compound of any one of Embodiments 1 through 44 wherein R³ is hydroxy, —O⁻M⁺, C₂-C₈ alkylcarbonyloxy, C₂-C₈ haloalkylcarbonyloxy, C₄-C₁₀ cycloalkylcarbonyloxy or C₃-C₁₀ alkylcarbonylalkoxy; or benzyloxy, phenyloxy, benzylcarbonyloxy, phenylcarbonyloxy, phenylsulfonyloxy or benzylsulfonyloxy, each optionally substituted on ring members with up to two substituents selected from R¹⁹.

### Embodiment 46

A compound of Embodiment 45 wherein R³ is hydroxy, —O⁻M⁺ or C₂-C₈ alkylcarbonyloxy; or phenylsulfonyloxy optionally substituted with up to two substituents selected from R¹⁹.

### Embodiment 47

A compound of Embodiment 46 wherein R³ is hydroxy or C₂-C₈ alkylcarbonyloxy.

### Embodiment 48

A compound of Embodiment 47 wherein R³ is hydroxy or —OC(═O)CH₂CH(CH₃)₂.

### Embodiment 48A

A compound of Embodiment 47 wherein R³ is hydroxy.

### Embodiment 49

A compound of any one of Embodiments 45 or 46 wherein M⁺ is a sodium or potassium metal cation.

### Embodiment 50

A compound of Embodiment 1 wherein R⁴, R⁵, R⁶ and R⁷ are each independently H or C₁-C₆ alkyl.

### Embodiment 51

A compound of Embodiment 1 wherein R⁸ is C₁-C₆ alkyl or C₃-C₈ cycloalkyl.

### Embodiment 52

A compound of Embodiment 51 wherein R⁸ is CH₃, CH₂CH₃ or cyclopropyl.

### Embodiment 53

A compound of any one of Embodiments 1 through 3 or 14 through 49 wherein R⁹ is C₁-C₆ alkyl.

### Embodiment 54

A compound of Embodiment 53 wherein R⁹ is CH₂CH₃.

### Embodiment 55

A compound of any one of Embodiments 1 through 3, 14 through 49, 53 or 54 wherein R¹⁰ is H, halogen or C₁-C₆ alkyl.

### Embodiment 56

A compound of Embodiment 55 wherein R¹⁰ is H or CH₃.

### Embodiment 57

A compound of any one of Embodiments 1, 2 or 14 through 49 wherein R¹¹ is H or C₁-C₆ alkyl.

### Embodiment 58

A compound of Embodiment 57 wherein R¹¹ is H.

### Embodiment 59

A compound of any one of Embodiments 1, 2, 14 through 49, 57 or 58 wherein R¹² is H, halogen, cyano, hydroxy, amino or C₁-C₆ alkyl.

### Embodiment 60

A compound of Embodiment 59 wherein R¹² is H, halogen, cyano,

C₁-C₆ alkyl or C₃-C₈ cycloalkyl.

### Embodiment 61

A compound of Embodiment 60 wherein R¹² is CH₃, CH₂CH₃ or cyclopropyl.

### Embodiment 62

A compound of any one of Embodiments 1, 14 through 49, 60 or 61 wherein R¹³ is H, halogen, cyano or nitro.

### Embodiment 63

A compound of Embodiment 62 wherein R¹³ is cyano or nitro.

### Embodiment 64

A compound of any one of Embodiments 1 through 5, 8, 10, 12 or 14 through 49 wherein each R¹⁴, R¹⁵, R¹⁶ and R¹⁷ is independently H, Cl or CH₃.

### Embodiment 65

A compound of Embodiment 64 wherein R¹⁴ and R¹⁵ are both H.

### Embodiment 66

A compound of any one of Embodiments 1 through 5, 8, 10, 12 or 14 through 49 wherein when instances of R¹⁴ and R¹⁶ are taken alone (i.e. R¹⁴ and R¹⁶ are not taken together as alkylene or alkenylene), then independently said instances of R¹⁴ and R¹⁶ are H or C₁-C₆ alkyl.

### Embodiment 67

A compound of Embodiment 66 wherein when instances of R¹⁴ and R¹⁶ are taken alone, then independently said instances of R¹⁴ and R¹⁶ are H or CH₃.

### Embodiment 68

A compound of Embodiment 67 wherein when instances of R¹⁴ and R¹⁶ are taken alone, then independently said instances of R¹⁴ and R¹⁶ are H.

### Embodiment 69

A compound of any one of Embodiments 1 through 5, 8, 10, 12 or 14 through 49 wherein all instances of R¹⁴ and R¹⁶ are taken alone.

### Embodiment 70

A compound of any one of Embodiments 1 through 5, 8, 10, 12 or 14 through 49 wherein when instances of R¹⁴ and R¹⁶ are taken together, then said instances of R¹⁴ and R¹⁶ are taken together as —CH₂CH₂CH₂— or —CH═CHCH₂— wherein the bond pointing to the left represents the attachment point for R¹⁴ and the bond pointing to the right represents the attachment point for R¹⁶.

### Embodiment 71

A compound of any one of Embodiments 1 through 5, 8, 10, 12 or 14 through 49 wherein each R¹⁶ and R¹⁷ is independently H or CH₃.

### Embodiment 72

A compound of Embodiment 71 wherein R¹⁶ and R¹⁷ are both H.

### Embodiment 73

A compound of Embodiment 72 wherein R¹⁶ and R¹⁷ are both CH₃.

### Embodiment 74

A compound of any one of Embodiments 1 through 65 wherein each R¹⁹ is independently halogen, cyano, hydroxy, nitro, —CHO, —SH, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl, C₂-C₈ alkylthioalkyl, C₂-C₈ alkylsulfinylalkyl, C₂-C₈ alkoxyhaloalkyl, C₂-C₅ cyanoalkyl, C₁-C₆ hydroxyalkyl, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₂-C₈ alkoxyalkoxy, C₂-C₈ alkylcarbonyloxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl or C₃-C₈ cycloalkylsulfonyl.

### Embodiment 75

A compound of Embodiment 74 wherein each R¹⁹ is independently halogen, nitro, C₁-C₆ alkyl, C₁-C₆ haloalkyl, C₁-C₆ alkoxy, C₁-C₆ haloalkoxy or C₁-C₆ alkylthio.

### Embodiment 76

A compound of Embodiment 75 wherein each R¹⁹ is independently fluorine, chlorine, bromine, CH₃, CF₃, OCH₃, OCF₃ or SCH₃. Embodiments of the present invention as described in the Summary of the Invention and any of Embodiments 1 through 76 can be combined in any way. Combined Embodiments from above can be illustrated as:

### Embodiment A

A compound of Formula 1 (including all stereoisomers), N-oxides, and salts thereof, agricultural compositions containing them and their use as herbicides as described in the Summary of the Invention wherein
A is A-1, A-3, A-5 or A-6;
R¹ is C₁-C₆ alkyl, C₃-C₆ alkenyl, C₃-C₆ alkynyl, C₂-C₆ alkoxyalkyl, C₄-C₈ alkoxyalkenyl, C₄-C₈ alkoxyalkynyl, C₃-C₈ alkoxyalkoxyalkyl, C₄-C₁₀ cycloalkylalkyl, C₄-C₁₀ cycloalkoxylalkyl, oxiranyl(C₁-C₃ alkyl), oxetanyl(C₁-C₃ alkyl) or tetrahydrofuranyl(C₁-C₃ alkyl);
m is 1, 2, 3 or 4;
each W is independently O, N—CN, N—NO₂, N—S═O, N—R^{A} or N—OR^{B};
R^{A} is H, C₁-C₄ alkyl or C₁-C₄ alkylcarbonyl;
R^{B} is H or C₁-C₄ alkyl;
T is —CH₂CH₂— or —CH═CH—;
R² is C₁-C₄ alkyl, C₃-C₅ cycloalkyl, C₂-C₄ alkoxyalkyl or C₄-C₈ cycloalkylalkyl;
R³ is hydroxy, —O⁻M⁺, C₂-C₈ alkylcarbonyloxy, C₂-C₈ haloalkylcarbonyloxy, C₄-C₁₀ cycloalkylcarbonyloxy or C₃-C₁₀ alkylcarbonylalkoxy; or benzyloxy, phenyloxy, benzylcarbonyloxy, phenylcarbonyloxy, phenylsulfonyloxy or benzylsulfonyloxy, each optionally substituted on ring members with up to two substituents selected from R¹⁹;
R⁹ is C₁-C₆ alkyl;
R¹⁰ is H, halogen or C₁-C₆ alkyl;
R¹¹ is H or C₁-C₆ alkyl;
R¹² is H, halogen, cyano, C₁-C₆ alkyl or C₃-C₈ cycloalkyl;
R¹⁴ and R¹⁶ are taken alone and are H or C₁-C₆ alkyl; or
R¹⁴ and R¹⁶ are taken together as —CH₂CH₂CH₂— or —CH═CHCH₂—; and
R¹⁹ is independently halogen, cyano, hydroxy, nitro, —CHO, —SH, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl, C₂-C₈ alkylthioalkyl, C₂-C₈ alkylsulfinylalkyl, C₂-C₈ alkoxyhaloalkyl, C₂-C₅ cyanoalkyl, C₁-C₆ hydroxyalkyl, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₂-C₈ alkoxyalkoxy, C₂-C₈ alkylcarbonyloxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl or C₃-C₈ cycloalkylsulfonyl.

### Embodiment B

A compound of Embodiment A wherein
A is A-1, A-3 or A-5;
B¹ is C-1;
B² is C-3;
B³ is C-1;
R¹ is C₁-C₆ alkyl, C₃-C₆ alkenyl, C₃-C₆ alkynyl, C₂-C₆ alkoxyalkyl, C₄-C₈ alkoxyalkenyl, C₄-C₈ alkoxyalkynyl, C₃-C₈ alkoxyalkoxyalkyl, C₄-C₁₀ cycloalkylalkyl, C₄-C₁₀ cycloalkoxylalkyl, oxiranyl(C₁-C₃ alkyl) or oxetanyl(C₁-C₃ alkyl);
m is 1, 2 or 3;
each W is independently O, N—CN, N—NO₂ or N—S═O;
T is —CH₂CH₂—;
R² is C₁-C₄ alkyl, C₃-C₅ cycloalkyl, C₂-C₄ alkoxyalkyl or C₄-C₈ cycloalkylalkyl;
R³ is hydroxy, —O⁻M⁺ or C₂-C₈ alkylcarbonyloxy; or phenylsulfonyloxy optionally substituted with up to two substituents selected from R¹⁹;
R⁹ is CH₂CH₃;
R¹⁰ is H or CH₃;
R¹¹ is H;
R¹² is H, halogen, cyano, C₁-C₆ alkyl or C₃-C₈ cycloalkyl;
each R¹⁴, R¹⁵, R¹⁶ and R¹⁷ is independently H, Cl or CH₃; and
R¹⁹ is independently halogen, nitro, C₁-C₆ alkyl, C₁-C₆ haloalkyl, C₁-C₆ alkoxy, C₁-C₆ haloalkoxy or C₁-C₆ alkylthio.

### Embodiment C

A compound of Embodiment B wherein
A is A-1 or A-3;
R¹ is C₁-C₆ alkyl, C₃-C₆ alkenyl, C₃-C₆ alkynyl, C₂-C₆ alkoxyalkyl, C₄-C₈ alkoxyalkenyl, C₄-C₈ alkoxyalkynyl, C₃-C₈ alkoxyalkoxyalkyl, C₄-C₁₀ cycloalkylalkyl or C₄-C₁₀ cycloalkoxylalkyl;
R² is CH₃ or cyclopropyl:
m is 2;
each W is independently O;
each p and q is independently 1;
R³ is hydroxy or C₂-C₈ alkylcarbonyloxy;
R¹⁴ and R¹⁵ are both H; and
each R¹⁶ and R¹⁷ is independently H or CH₃.

### Embodiment D

A compound of Embodiment C wherein
A is A-1;
R¹ is C₁-C₆ alkyl or C₄-C₁₀ cycloalkylalkyl;
R² is CH₃; and
R³ is hydroxy or —OC(═O)CH₂CH(CH₃)₂.

### Embodiment E

A compound of Embodiment D wherein
R¹ is cyclopropylmethyl; and
R³ is hydroxy.

Embodiments of this invention, including Embodiments 1-76 and Embodiments A through E above as well as any other embodiments described herein, can be combined in any manner, and the descriptions of variables in the embodiments pertain not only to the compounds of Formula 1 but also to the starting compounds and intermediate compounds useful for preparing the compounds of Formula 1. In addition, embodiments of this invention, including Embodiments 1-76 above as well as any other embodiments described herein, and any combination thereof, pertain to the compositions and methods of the present invention.

This invention also relates to a method for controlling undesired vegetation comprising applying to the locus of the vegetation herbicidally effective amounts of the compounds of the invention (e.g., as a composition described herein). Of note as embodiments relating to methods of use are those involving the compounds of embodiments described above. Compounds of the invention are particularly useful for selective control of weeds in wheat, corn and rice.

Also noteworthy as embodiments are herbicidal compositions of the present invention comprising the compounds of Formula 1 as described in the embodiments above.

One or more of the following methods and variations as described in Schemes 1-19 can be used to prepare the compounds of Formula 1. The definitions of A, R¹, R², Q, B¹, B², B³, R³, R⁴, R⁵, R⁶, R¹⁰, R¹¹, R¹², R¹³, R¹⁴, R¹⁵, R¹⁶, R¹⁸, W, p and q in the compounds of Formulae 1-15 below are as defined above in the Summary of the Invention unless otherwise noted. Compounds of Formulae 1a, 1b, 1c, 1d, 1e, 1f, 1g, 1h and 1i are various subsets of the compounds of Formula 1 and all substituents for Formulae 1a, 1b, 1c, 1d, 1e 1f, 1g, 1h and 1i are as defined above for Formula 1 unless otherwise indicated. Compounds of Formulae 3a and 3b, are various subsets of the compounds of Formula 3, and all substituents for Formulae 3a and 3b are as defined above for Formula 3.

Compound of Formula 1 (i.e. the compounds of the invention, their N-oxides and their salts) can be prepared according to various methods and consistent with the procedures reported in WO 2012/002096. Representative examples are given below, but the processes for preparing a compound of Formula 1 are not limited to these examples.

Compounds of Formula 1a (i.e. Formula 1 in which A is A-1) wherein R³ is hydroxy can be produced according to the two-step method shown below in Scheme 1 (wherein R¹, R², B¹, B², B³ W, q, p, and m are as defined in the Summary of the Invention, and X represents a leaving group such as a halogen atom; or an alkylcarbonyloxy, alkoxycarbonyloxy, haloalkylcarbonyloxy, haloalkoxycarbonyloxy, benzoyloxy, pyridyl or imidazolyl group). Intermediate compounds of Formulae 4a and 4b are prepared by reacting a compound of Formula 2a with a compound of Formula 3 in the presence of a base such as triethylamine. In the presence of an appropriate source of cyanide ion (e.g., acetone cyanohydrin, potassium cyanide, sodium cyanide) and a base such as triethylamine or pyridine, the intermediate compounds of Formulae 4a and 4b are then rearranged to the corresponding compounds of Formula 1a. Alternatively a fluoride anion source such as potassium fluoride or cesium fluoride, optionally in the presence of a phase transfer catalyst (e.g., tetrabutylammonium bromide), can be used to cause this rearrangement. Typically the reaction is conducted in a solvent such as dimethylsulfoxide, N,N-dimethylformamide, acetonitrile or dichloromethane at temperatures ranging from ambient temperature to the reflux temperature of the solvent. For reaction conditions for this general coupling methodology, see Edmunds, A. in Modern Crop Protection Compounds; Kramer, W. and Schirmer, U., Eds.; Wiley, Weinheim, 2007; Chapters 4.3 and 4.4, and references cited therein.

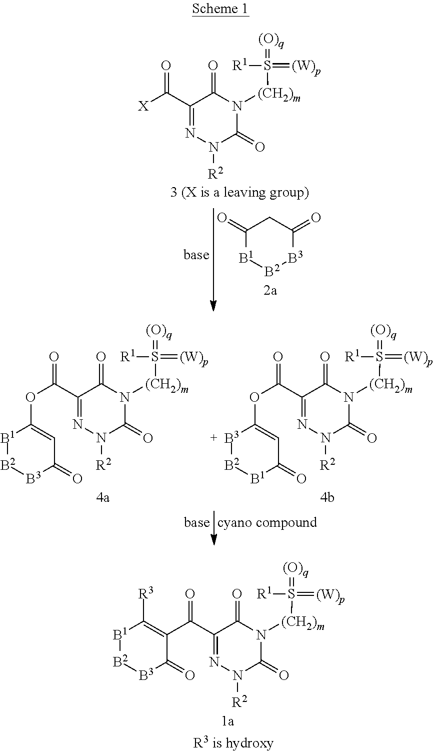

Compounds of Formula 1a wherein R³ is hydroxy can also be prepared as shown in Scheme 2, by reacting dione 2a with intermediate 3a (i.e. Formula 3 in which X is —CN) in the presence of a base or Lewis acid. For reaction conditions for this general coupling methodology, see Edmunds, A. in Modern Crop Protection Compounds; Kramer, W. and Schirmer, U., Eds.; Wiley, Weinheim, 2007; Chapter 4.3 and references cited therein.

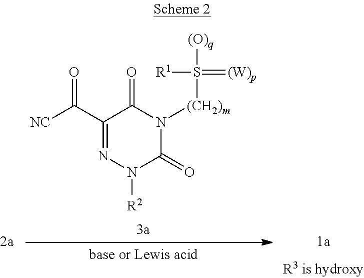

As shown in Scheme 3, compounds of Formulae 4a or 4b, useful as intermediates in the method of Scheme 1, can also be prepared by reacting compounds of Formula 2a with carboxylic acids of Formula 5 in the presence of a dehydrating condensation agent such as 2-chloro-1-pyridinium iodide (known as the Mukaiyama coupling agent), dicyclohexyl carbodiimide (DCC) or the like and optionally in the presence of a base. For additional reaction conditions for this general enol ester coupling methodology, see Edmunds, A. in Modern Crop Protection Compounds; Kramer, W. and Schirmer, U., Eds.; Wiley, Weinheim, 2007; Chapter 4.3 and references cited therein.

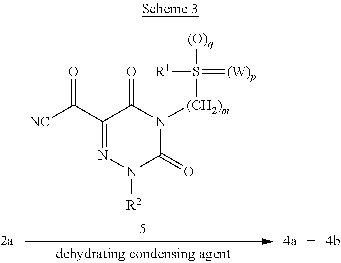

As shown in Scheme 4, compounds of Formula 1a wherein R³ is a substituent group bonded to the remainder of Formula 1a through an oxygen atom are prepared by reacting corresponding compounds of Formula 1a wherein R³ is hydroxy with a compound of formula L-R^{a} wherein R^{a} is the part of R³ not including the oxygen atom and L is anucleophilic leaving group such as Cl, Br or I in the presence of a base. As also shown in Scheme 4, compounds of Formula 1a wherein R³ is bonded to the remainder of Formula 1a through a nitrogen, sulfur or carbon atom can be prepared by reacting a compound of Formula 1a wherein R³ is hydroxy with an appropriate halogenating agent to prepare a corresponding halo compound of Formula 1a wherein R³ is halogen, followed by reacting the halo compound with an appropriate nucleophilic compound to replace the halogen with R³ through displacement. For reaction conditions for this general functionalization method, see Edmunds, A. or Van Almsick A. in Modern Crop Protection Compounds; Kramer, W. and Schirmer, U., Eds.; Wiley, Weinheim, 2007; Chapter 4.3 or Chapter 4.4, and references cited therein.

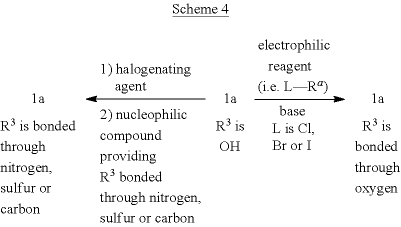

As shown in Scheme 5, compounds of Formula 1b (i.e. Formula 1 in which A is A-4) can be prepared by reacting compounds of Formula 2b with compounds of Formula 3 in the presence of a strong base such n-butyllithium or lithium diisopropylamide in an appropriate solvent such as tetrahydrofuran or diethyl ether. Reaction conditions for this type of transformation can be found in JP 2003327580.

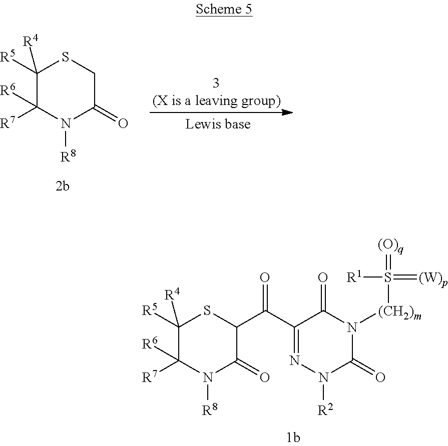

As shown in Scheme 6, compounds of Formula 1c (i.e. Formula 1 in which A is A-5) wherein R³ is hydroxy can be prepared by reacting a compound of Formula 2c and a compound of Formula 3 in a solvent and in the presence of a base to form an intermediate of Formula 4c, followed by reacting intermediate 4c with a cyano compound in the presence of a base using the conditions described for Scheme 1.

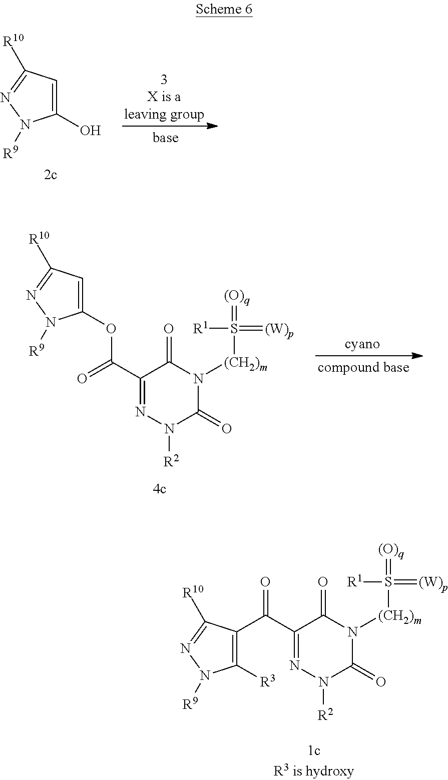

A compound of Formula 1c wherein R³ is a substituent group bonded to the remainder of Formula 1c through an oxygen, nitrogen, sulfur or carbon atom can be produced from a compound of Formula 1c wherein R³ is hydroxy as shown in Scheme 7 using the methods described in Scheme 4.

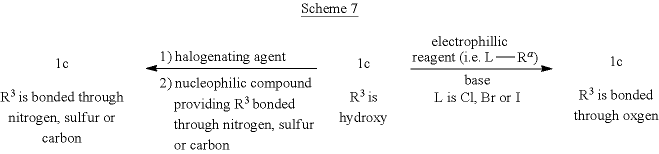

As shown in Scheme 8, compounds of Formula 1d (i.e. Formula 1 wherein A is A-7) can be prepared from corresponding compounds of Formulae 2d and 3. In this method, compounds of Formula 3 are reacted with compounds of Formula 2d in the presence of a base that promotes carbon-centered acylation. Magnesium enolates, which can be formed by reaction of compounds of Formula 2d with magnesium metal or magnesium alcoholates such as magnesium ethoxide, are preferred for carbon-centered acylation. This type of acylation is well known in the literature and typical conditions which result in acylation on carbon can be found in U.S. Pat. Nos. 4,741,769 and 4,781,750, and Van Almsick A. in Modern Crop Protection Compounds; Kramer, W. and Schirmer, U., Eds.; Wiley, Weinheim, 2007; Chapter 4.4, and references cited therein.

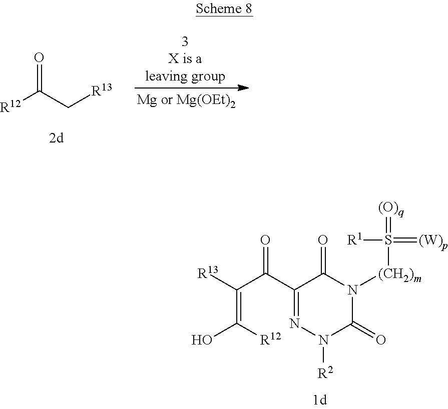

As shown in Scheme 9, compounds of Formula 1e (i.e. Formula 1 in which A is A-6 and R¹¹ is H) can be prepared from diketones of Formula 6. Compounds of Formula 6 can be prepared by acylation of compounds of Formula 5 with compounds of Formula 3. Acylation on carbon can be achieved using a magnesium enolate of compounds of Formula 5 produced using conditions previously described in Scheme 8. Removal of the ester can be conveniently carried out by heating the reaction product with a source of acid which cleaves the tert-butyl group and results in decarboxylation producing the compound of Formula 6. Acid sources such as hydrochloric acid, hydrobromic acid, sulfuric acid, trifluoroacetic acid and p-toluenesulfonic acid as well as many others may be employed. The compound of Formula 6 is then reacted with an orthoformate ester or N,N-dimethylformamide dimethylacetal (DMF-DMA) to provide an intermediate compound of Formula 7. Reaction of the compound of Formula 7 with hydroxylamine hydrochloride salt in a solvent such as ethanol, acetonitrile, water or acetic acid provides the isoxazole compound of Formula 1e. For reaction conditions for synthesis of 4-acyl isoxazoles, see European Patent Application EP 527036 and World Patent Application WO 99/02489 as well as Van Almsick A. in Modern Crop Protection Compounds; Kramer, W. and Schirmer, U., Eds.; Wiley, Weinheim, 2007; Chapter 4.4, and references cited therein.

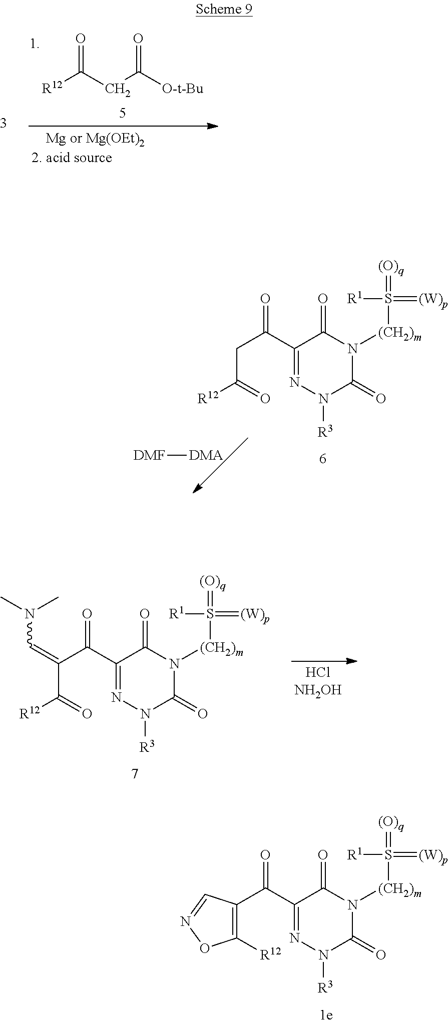

As shown in Scheme 10, compounds of Formula 3b (i.e. Formula 3 wherein X is Cl) can be prepared by reacting a compound of Formula 5 and an appropriate halogenating agent with or without a solvent. Examples of the halogenating agent that can be used include oxalyl chloride and thionyl chloride. Examples of the solvent include halogenated hydrocarbons such as dichloromethane and chloroform, ethers such as diethyl ether and tetrahydrofuran and aromatic hydrocarbons such as benzene and toluene. The reaction temperature is selected from the range of from −20° C. to the boiling point of the inert solvent used. Typically, the reaction is carried out in the range of from 0° C. to 100° C.

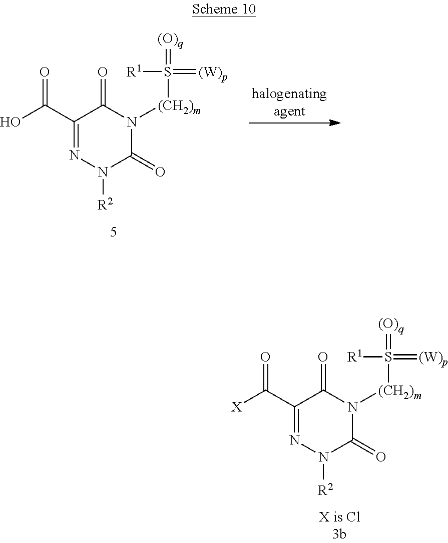

As shown in Scheme 11, carboxylic acids of Formula 5 can be prepared by de-esterification of esters of Formula 8 where RE is Me, Et, i-Pr or benzyl. Compounds of Formula 8 are particularly useful intermediates to prepare a compound of Formula 1. The de-esterification can be accomplished by many well-known methods, for example, saponification procedures using alkali hydroxides such as lithium hydroxide, sodium hydroxide or potassium hydroxide in a lower alkanol such methanol or ethanol or in mixtures of alkanols and water. Alternatively, a dealkylating agent such as lithium iodide or trimethylsilyl iodide can be used in the presence of a base in a solvent such as pyridine or ethyl acetate. Alternatively, boron tribromide (BBr₃) can be used to prepare compounds of Formula 5 from compounds of Formula 8 in a solvent such as dichloromethane, hexanes or toluene. A typical procedure using boron tribromide is disclosed in Bioorgic & Medicinal Chemistry Letters 2009, 19(16), 4733-4739. Additional procedures for de-esterification can be found in PCT Patent Publication WO 2006/133242.

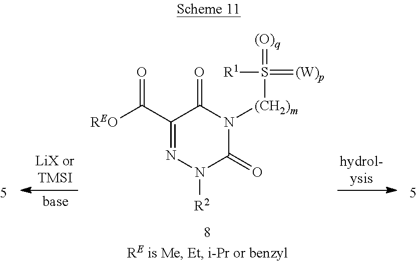

As illustrated in Scheme 12, preparation of compounds of Formula 8b (i.e. Formula 8 wherein W is O and p is 0 or 1) can be accomplished by oxidation of compounds of Formula 8a. In a typical procedure, an oxidizing agent in an amount from 1 to 4 equivalents depending on the oxidation state of the starting material is added to a solution of the compound of Formula 8a in a solvent. Useful oxidizing agents include Oxone® (potassium peroxymonosulfate), hydrogen peroxide, sodium periodate, peracetic acid and 3-chloroperbenzoic acid. The solvent is selected with regard to the oxidizing agent employed. Aqueous ethanol or aqueous acetone is preferably used with potassium peroxymonosulfate, and dichloromethane is generally preferable with 3-chloroperbenzoic acid. Useful reaction temperatures typically range from 0 to 90° C. Particular procedures useful for oxidizing sulfides or sulfoxides to sulfones are described in Journal of Agricultrual & Food Chemistry 1984, 32, 221-226 and references cited therein.

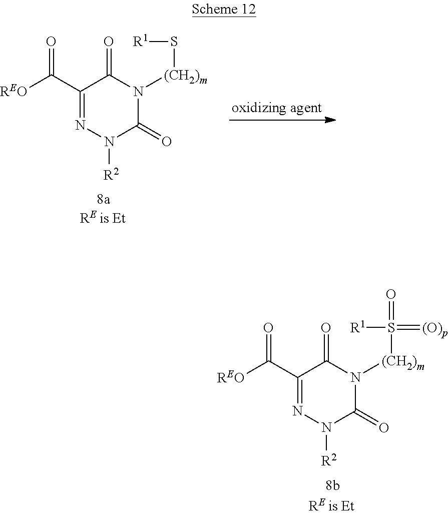

As illustrated in Scheme 13, preparation of compounds of Formula 8c (i.e., Formula 8 wherein W is N—CN, N—S═O, N—R^{A}, N—OR^{B} or N—N(R^{C})₂, p is 1 and RE is Et) can be accomplished by oxidation of compounds of Formula 8a. In a typical procedure, an oxidizing agent in an amount from 1 to 4 equivalents is added to a solution of the compound of Formula 8a, 1 to 4 equivalents of a nitrogen nucleophile and if necessary 0-1 equivalents of a catalyst in a solvent. Useful oxidizing agents include iodobenzenediacetate, magnesium oxide, N-bromosuccinimide and N-chlorosuccinimide. Nitrogen nucleophiles can include cyanamide and primary amides. Useful catalysts include dirhodium tetraacetate. Potential solvents include dichloromethane, methanol or acetonitrile. Useful reaction temperatures typically range from 0 to 90° C. Procedures useful for oxidizing sulfides to sulfilimines are described in Organic Letters 2004, 6, 1305-1307; Organic Letters 2007, 9, 2951-2954; Advanced Synthesis & Catalysis 2010, 352, 309-316 and references cited there therein.

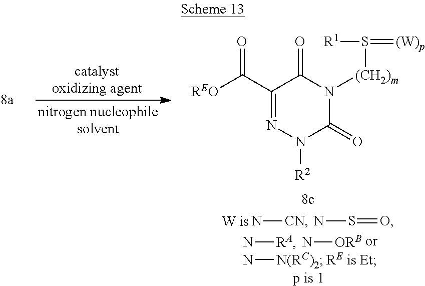

As illustrated in Scheme 14, preparation of compounds of Formula 8d (i.e. Formula 8 wherein W is N—CN, N—NO₂, N—S═O, N—R^{A}, N—OR^{B} or N—N(R^{C})₂, p and q are both 1, and R^{E} is Et) can be accomplished by oxidation of a compound of Formula 8a. In a typical procedure, an oxidizing agent in an amount from 1 to 4 equivalents is added to a solution of the compound of Formula 8a followed by 0-1 equivalents of a catalyst if necessary. Useful oxidizing agents include 3-chlorobenzoic acid, sodium periodate, peracetic acid and potassium permanganate. Useful catalysts include ruthenium trichloride hydrate and ruthenium oxide hydrate. Useful solvents include dichloromethane, acetone, ethanol, acetonitrile or water and mixtures thereof. Useful reaction temperatures typically range from 0 to 90° C. Particular procedures useful for oxidizing sulfilimines to sulfoximines are described Advanced Synthesis & Catalysis 2010, 352, 309-316 and references cited therein and PCT Patent Publication WO 2009/014891.

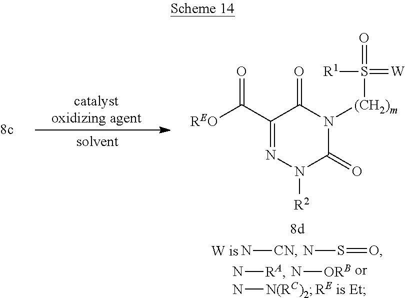

As shown in Scheme 15 compounds of Formula 8a can be obtained by reacting compounds of Formula 9 with diethyl ketomalonate 10 to produce an intermediate of Formula 11, followed by treatment of intermediate 11 with isocyanate 12. Conditions for carrying out this sequence can be found in PCT Patent Publication WO 2010/002096.

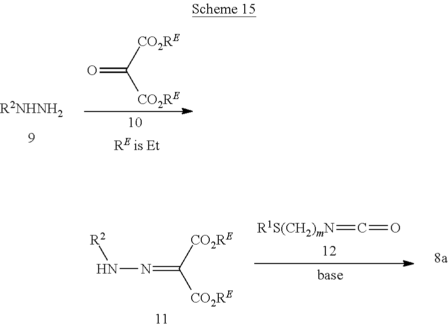

Compounds of Formula 8a can also as be prepared shown in Scheme 16. Reaction of hydrazines 9 with isocyanates 12 affords an intermediate of Formula 13, which, on treatment with diethyl ketomalonate 10 affords a compound of Formula 8a. Conditions for carrying out this sequence can be found in PCT Patent Publication WO 2010/002096.

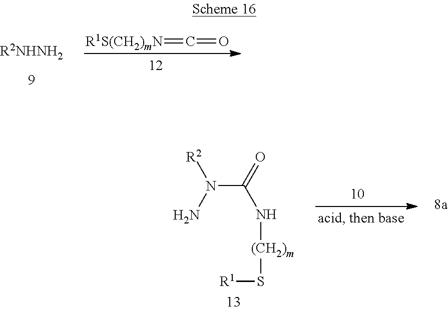

As shown in Scheme 17, isocyanates of Formula 12 can be prepared by reaction of compounds of Formula 14 with phosgene. The amount of phosgene for the process of producing a compound of Formula 13 from a compound of Formula 14 can be appropriately selected from the range of 0.33 to 8.0 mol (typically from 0.33 to 2.0 mol) per 1 mol of a compound of Formula 14. Examples of phosgene sources that can be used include phosgene, diphosgene and triphosgene. A typical solvent for use in this reaction is toluene. The reaction temperature is selected from the range of from −20° C. to the boiling point of an inert solvent used. Typically, the reaction is carried out in the range of from 0° C. to 100° C. Alternatively, as also shown in Scheme 17, compounds of Formula 13 can be prepared by reaction of compounds of Formula 15 with diphenylphosphoryl azide (dppa) in an organic solvent in the presence of a base. The amount of diphenylphosphoryl azide for the process of producing a compound of Formula 13 from a compound of Formula 15 can be appropriately selected from the range of about 1.0 to about 8.0 mol (typically from 1.0 to 2.0 mol) per 1 mol of a compound of Formula 15. The amount of base for the process of producing a compound of Formula 13 from a compound of Formula 14 can be appropriately selected from the range of about 1.0 to about 8.0 mol (typically from 1.0 to 2.0 mol) per 1 mol of a compound of Formula 15. Examples of the base include organic bases such as triethylamine and 1,8-diazabicyclo[5.4.0]undec-7-ene and inorganic bases such as sodium hydride, sodium methoxide and sodium ethoxide. Typically the base is triethylamine. Examples of the solvent that can be used include those described above for Scheme 1. Typically the solvent is toluene. The reaction temperature is selected from the range of from −20° C. to the boiling point of an inert solvent used. Typically, the reaction is carried out in the range of from 0° C. to 100° C.

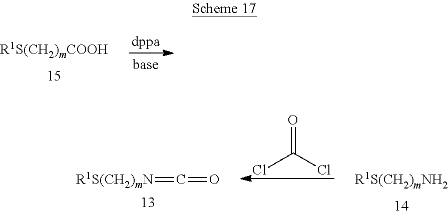

As illustrated in Scheme 18, preparation of compounds of Formula 14 can be accomplished by alkylation of compounds of Formula 16. In a typical procedure, the compound of Formula 16 is added to a solution of the base agent, in an amount from 1 to 4 equivalents, followed by the addition of 1 to 4 equivalents of an alkylating agent in a solvent. Useful alkylating agents include alkyl triflates, alkyl halides and alkylate sulfates. Bases include inorganic bases such as: lithium hydroxide, sodium hydroxide or potassium carbonate and amine bases such as triethylamine. Suitable solvents include dichloromethane, ethanol, acetonitrile, N,N-dimethylformamide, water or mixtures thereof. Useful reaction temperatures typically range from 0 to 90° C.

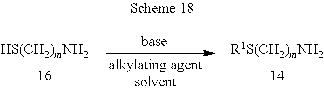

As illustrated in Scheme 19, compounds of Formula if (i.e. Formula 1 in which A is A-1, A-2, A-3, A-5, A-6 or A-7 and p and q are 0 can be oxidized by the methods of Schemes 12, 13 and 14 to give compounds of Formula 1g, 1h and 1i respectively.

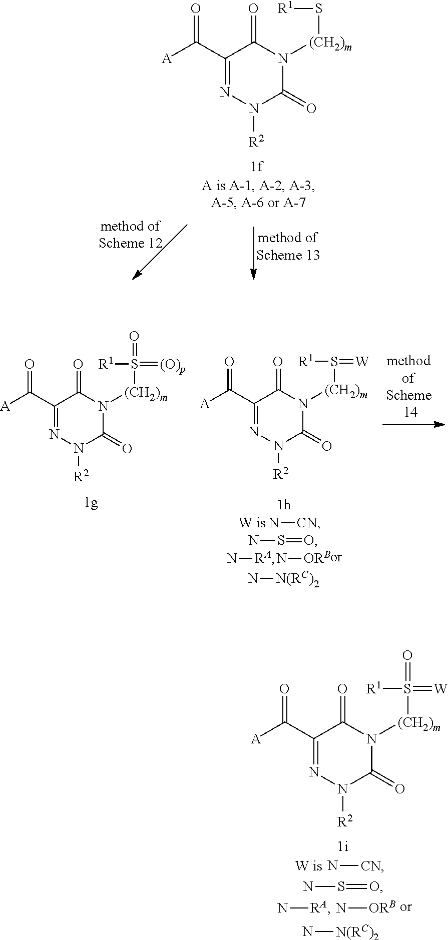

It is recognized that some reagents and reaction conditions described above for preparing compounds of Formula 1 may not be compatible with certain functionalities present in the intermediates. In these, the incorporation of protection/deprotection sequences or functional group interconversions into the synthesis will aid in obtaining the desired products. The use and choice of the protecting groups will be apparent to one skilled in chemical synthesis (see, for example, Greene, T. W.; Wuts, P. G. M. Protective Groups in Organic Synthesis, 2nd ed.; Wiley: New York, 1991). One skilled in the art will recognize that, in some cases, after the introduction of a given reagent as it is depicted in any individual scheme, it may be necessary to perform additional routine synthetic steps not described in detail to complete the synthesis of compounds of Formula 1. One skilled in the art will also recognize that it may be necessary to perform a combination of the steps illustrated in the above schemes in an order other than that implied by the particular sequence presented to prepare the compounds of Formula 1.

One skilled in the art will also recognize that compounds of Formula 1 and the intermediates described herein can be subjected to various electrophilic, nucleophilic, radical, organometallic, oxidation, and reduction reactions to add substituents or modify existing substituents.

Without further elaboration, it is believed that one skilled in the art using the preceding description can utilize the present invention to its fullest extent. The following Synthesis Examples are, therefore, to be construed as merely illustrative, and not limiting of the disclosure in any way whatsoever. Steps in the following Synthesis Examples illustrate a procedure for each step in an overall synthetic transformation, and the starting material for each step may not have necessarily been prepared by a particular preparative run whose procedure is described in other Examples or Steps. Percentages are by weight except for chromatographic solvent mixtures or where otherwise indicated. Parts and percentages for chromatographic solvent mixtures are by volume unless otherwise indicated. ¹H NMR spectra are reported in ppm downfield from tetramethylsilane in CDCl₃ unless otherwise noted; “s” means singlet, “d” means doublet, “t” means triplet, “m” means multiplet, “qr” means quartet, “qn” means quintet, “br s” means broad singlet.

### SYNTHESIS EXAMPLE 1

### Preparation of 4-[2-[(cyclopropylmethyl)thio]ethyl]-6-[(2-hydroxy-6-oxo-1-cyclohexen-1-yl)carbonyl]-2-methyl-1,2,4-triazine-3,5(2H,4H)-dione (Compound 4)

### Step A: Preparation of 2-[(cyclopropylmethyl)thio]ethanamine

Lithium hydroxide (0.43 g, 18.0 mmol) in water (10 mL) was diluted with ethanol (10 mL) and treated with cystineamine hydrochloride (1.02 g, 9.0 mmol). Cyclopropylmethyl bromide (1.28 g, 9.5 mmol) was added dropwise and the reaction was stirred at ambient temperature for 16 h. The reaction mixture was diluted with water (20 mL) and the volatiles were removed under reduced pressure. The residue was taken up in dichloromethane and washed with water (2×20 mL). The organic layer was separated, dried (MgSO₄) and the solvent removed under reduced pressure to yield the title compound (730 mg) as an oil.

¹H NMR δ 2.89 (t, 2H), 2.69 (t, 2H), 2.46 (d, 2H), 0.98 (m, 1H), 0.58 (m, 2H), 0.21 (m, 2H).

### Step B: Preparation of [[(2-isocyanatoethyl)thio]methyl]cyclopropane

To 2-[(cyclopropylmethyl)thio]ethanamine (i.e. the product of Step A, 730 mg, 5.6 mmol) dissolved in an ice-cooled biphasic solution of chloroform (15 mL) and aqueous sodium bicarbonate (15 mL) was added phosgene (20% solution in toluene, 8.3 mmol) dropwise. The resulting mixture was stirred at 0° C. for 1 h. The reaction mixture was extracted with chloroform (15 mL), washed with brine, dried (MgSO₄) and the solvent removed under reduced pressure to provide the title compound (875 mg) as an oil.

¹H NMR δ 3.46 (t, 2H), 2.82 (t, 2H), 2.50 (d, 2H), 0.98 (m, 1H), 0.60 (m, 2H), 0.22 (m, 2H).

### Step C: Preparation of ethyl 4-[2-[(cyclopropylmethyl)thio]ethyl]-2,3,4,5-tetrahydro-2-methyl-3,5-dioxo-1,2,4-triazine-6-carboxylate

To [[(2-isocyanatoethyl)thio]methyl]cyclopropane (i.e. the product of Step B, 0.88 g, 5.6 mmol) in toluene (10 mL) at 0° C. was added methyl hydrazine (0.28 g, 6.1 mmol). The reaction mixture was warmed to room temperature and stirred for 16 h. Diethylketomalonate (0.97 g, 5.3 mmol) was added followed by p-toluenesulfonic acid (0.6 mmol) and the resulting mixture heated to reflux for 4 h. The reaction mixture was cooled to ambient temperature and 1,8 diazabicyclo[5.4.0]undec-7-ene (1.3 g, 8.3 mmol) added and allowed to stir at room temperature for 16 h. Water was added and the aqueous layer was extracted with dichloromethane. The organic layer was dried (MgSO₄) filtered, and the solvent removed under reduced pressure. The resulting residue was chromatographed on silica gel (40 g) eluting with 0 to 45% ethyl acetate in hexanes to provide the title compound (720 mg) as an oil.

¹H NMR δ 4.42 (qr, 2H), 4.17 (m, 2H), 3.73 (s, 3H), 2.85 (m, 2H), 2.54 (d, 2H), 1.40 (t, 3H), 1.00 (m, 1H), 0.58 (m, 2H), 0.25 (m, 2H).

### Step D: Preparation of 4-[2-[(cyclopropylmethyl)thio]ethyl]-2,3,4,5-tetrahydro-2-methyl-3,5-dioxo-1,2,4-triazine-6-carboxylic acid

Ethyl 4-[2-[(cyclopropylmethyl)thio]ethyl]-2,3,4,5-tetrahydro-2-methyl-3,5-dioxo-1,2,4-triazine-6-carboxylate (i.e. the product of Step C, 0.72 g, 2.3 mmol), lithium bromide (powder, 1.2 g, 14 mmol) and triethylamine (0.71 g, 6.9 mmol) were combined in acetonitrile (10 mL) and water (0.5 mL) and stirred at room temperature for 16 h. The reaction mixture was diluted with water, acidified with 1 N hydrochloric acid and extracted with ethyl acetate. The organic layer was separated, dried (MgSO₄) and concentrated under reduced pressure to provide the title compound (570 mg) as a white solid.

¹H NMR δ 4.25 (m, 2H), 3.87 (s, 3H), 2.91 (m, 2H), 2.54 (d, 2H), 0.99 (m, 1H), 0.60 (m, 2H), 0.25 (m, 2H).

### Step E: Preparation of 4-[2-[(cyclopropylmethyl)thio]ethyl]-6-[(2-hydroxy-6-oxo-1-cyclohexen-1-yl)carbonyl]-2-methyl-1,2,4-triazine-3,5(2H,4H)-dione

4-[2-[(cyclopropylmethyl)thio]ethyl]-2,3,4,5-tetrahydro-2-methyl-3,5-dioxo-1,2,4-triazine-6-carboxylic acid (i.e. the product of Step D, 0.5 g, 1.8 mmol) in dichloromethane (10 mL) was treated with oxalyl chloride (0.34 g, 2.6 mmol) and 1 drop of N,N-dimethylformamide. The resulting mixture was stirred for 1 h, and then concentrated under reduced pressure. The resulting residue was dissolved in dichloromethane (10 mL) and treated with 1,3-cyclohexanedione (0.22 g, 1.9 mmol) and triethylamine (0.36 g, 3.5 mmol). The reaction mixture was stirred at ambient temperature for 1 h. The volatile components were removed under reduced pressure and acetonitrile (10 mL) was added followed by triethylamine (0.36 g, 93.5 mmol) and acetone cyanohydrin (0.20 mmol). The reaction mixture was stirred at ambient temperature for 16 h, concentrated onto silica gel, and chromatographed on silica gel (40 g) eluting with 0 to 3% methanol in chloroform to provide the title compound (220 mg) as a solid.

¹H NMR δ 16.03 (s, 1H), 4.13 (m, 2H), 3.64 (s, 3H), 2.83 (m, 2H), 2.77 (t, 2H), 2.54 (d, 2H), 2.46 (t, 2H), 2.07 (qn, 2H), 1.01 (m, 1H), 0.57 (m, 2H), 0.24 (m, 2H).

### SYNTHESIS EXAMPLE 2

### Preparation of 4-[2-[(cyclopropylmethyl)sulfonyl]ethyl]-6-[(2-hydroxy-6-oxo-1-cyclohexen-1-yl)carbonyl]-2-methyl-1,2,4-triazine-3,5(2H,4H)-dione (Compound 3)

### Step A: Preparation of 4-[2-(cyclopropylmethyl)sulfonyl]ethyl]-6-[(2-hydroxy-6-oxo-1-cyclohex-1-yl)carbonyl]-2-methyl-1,2,4-triazine-3,5(2H,4H)-dione

To 4-[2-[(cyclopropylmethyl)thio]ethyl]-6-[(2-hydroxy-6-oxo-1-cyclohexen-1-yl)carbonyl]-2-methyl-1,2,4-triazine-3,5(2H,4H)-dione (i.e. the product of Example 1, Step E, 0.2 g, 0.5 mmol) in dichloromethane (20 mL) was added m-chloroperoxybenzoic acid (77%, 0.24 g, 1.1 mmol) (Caution: exothermic!). The resulting mixture was stirred at ambient temperature for 16 h. Silica gel was added and the volatiles were removed under reduced pressure. Column chromatography on silica gel (40 g) eluting with 0 to 4% methanol in chloroform provided the title compound (80 mg) as a solid.

¹H NMR δ 15.99 (br s., 1H), 4.39 (m, 2H), 3.65 (m, 3H), 3.40 (m, 2H), 3.02 (d, 2H), 2.78 (t, 2H), 2.46 (t, 2H), 2.08 (m, 2H), 1.22 (m, 1H), 0.76 (m, 2H), 0.46 (m, 2H).

By the procedures described herein together with methods known in the art, the following compounds of TABLE 1 through TABLE 200 can be prepared. The following abbreviations are used in the Tables which follow: n means normal, i means iso, s means secondary, t means tertiary, c means cyclo, Me means methyl, Et means ethyl, Pr means propyl, Bu means butyl, MeO means methoxy, EtO means ethoxy, CN means cyano and Ph means phenyl. In TABLE 1 through TABLE 200, the variable A is defined for A-1a, A-1b, A-3a, A-5a and A-5b according to the following chart:

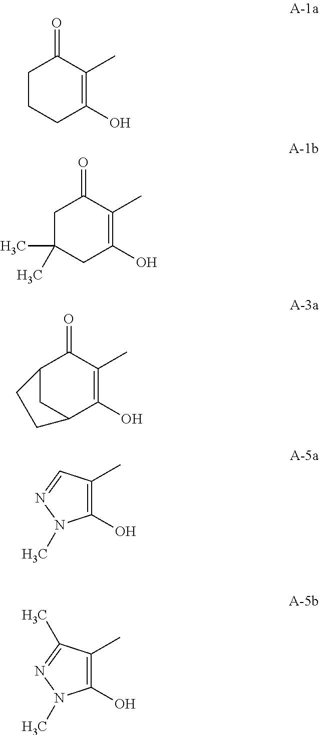

TABLE 1 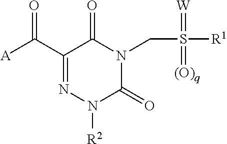
A is A-1a; R² is CH₃; q is 0; W is N—CN; and R¹ is
Me
Et
n-Pr
i-Pr
n-Bu
s-Bu
t-Bu
CH₂CH═CH₂
CH₂CH₂CH═CH₂
CH₂CH═CHCH₃
CH₂C≡CH
CH₂C≡CCH₃
CH₂OCH₃
CH₂OCH₂CH₃
CH₂O—c-Pr
CH₂O—c-Bu
CH₂O-c-pentyl
CH₂O-c-hexyl
CH₂CH₂OCH₃
CH₂CH₂OCH₂CH₃
CH₂CH₂O—c-Pr
CH₂CH₂O—c-Bu
CH₂CH₂O-c-pentyl
CH₂CH₂O-c-hexyl
CH₂OCH₂OCH₃
CH₂OCH₂OCH₂CH₃
CH₂OCH₂CH₂OCH₃
CH₂OCH₂CH₂OCH₂CH₃
CH₂CH₂OCH₂OCH₃
CH₂CH₂OCH₂OCH₂CH₃
CH₂CH₂OCH₂CH₂OCH₃
CH₂CH₂OCH₂CH₂OCH₂CH₃
CH₂—c-Pr
CH₂—c-Bu
CH₂-c-pentyl
CH₂-c-hexyl
CH₂-(oxiran-2-yl)
CH₂CH₂-(oxiran-2-yl)
CH₂-(oxetan-2-yl)
CH₂CH₂-(oxetan-3-yl)
CH₂-(tetrahydrofuran-2-yl)
CH₂CH₂-(tetrahydrofuran-3-yl)
CH₂-(tetrahydropyran-2-yl)
CH₂CH₂-(tetrahydropyran-3-yl)

The following TABLE is constructed the same as TABLE 1 above except that the Row Heading in TABLE 1 (i.e. “A is A-1a; R² is CH₃; q is 0; W is N—CN; and R¹ is”) is replaced with the Row Heading listed in TABLE 2 (i.e. “A is A-1a; R² is Et; q is 0; W is N—CN; and R¹ is”). For example, the first entry in TABLE 2 explicitly names a compound of Formula 1 wherein A is A-1a, R¹ is Me; R² is Et; q is 0; and W is N—CN. TABLE 3 through TABLE 200 is constructed similarly

| TABLE | Row Heading |
|---|---|
| 2 | A is A-1a; R² is Et; q is 0; W is N—CN; and R¹ is |
| 3 | A is A-1a; R² is c-Pr; q is 0; W is N—CN; and R¹ is |
| 4 | A is A-1a; R² is i-PrCH₂; q is 0; W is N—CN; and R¹ is |
| 5 | A is A-1a; R² is c-PrCH₂; q is 0; W is N—CN; and R¹ is |
| 6 | A is A-1a; R² is MeO; q is 0; W is N—CN; and R¹ is |
| 7 | A is A-1a; R² is MeOCH₂; q is 0; W is N—CN; and R¹ is |
| 8 | A is A-1a; R² is CH₂═CHCH₂; q is 0; W is N—CN; and R¹ is |
| 9 | A is A-1a; R² is CNCH₂; q is 0; W is N—CN; and R¹ is |
| 10 | A is A-1a; R² is i-Pr; q is 0; W is N—CN; and R¹ is |
| 11 | A is A-1b; R² is Me; q is 0; W is N—CN; and R¹ is |
| 12 | A is A-1b; R² is Et; q is 0; W is N—CN; and R¹ is |
| 13 | A is A-1b; R² is c-Pr; q is 0; W is N—CN; and R¹ is |
| 14 | A is A-1b; R² is i-PrCH₂; q is 0; W is N—CN; and R¹ is |
| 15 | A is A-1b; R² is c-PrCH₂; q is 0; W is N—CN; and R¹ is |
| 16 | A is A-1b; R² is MeO; q is 0; W is N—CN; and R¹ is |
| 17 | A is A-1b; R² is MeOCH₂; q is 0; W is N—CN; and R¹ is |
| 18 | A is A-1b; R² is CH₂═CHCH₂; q is 0; W is N—CN; and R¹ is |
| 19 | A is A-1b; R² is CNCH₂; q is 0; W is N—CN; and R¹ is |
| 20 | A is A-1b; R² is i-Pr; q is 0; W is N—CN; and R¹ is |
| 21 | A is A-3a; R² is Me; q is 0; W is N—CN; and R¹ is |
| 22 | A is A-3a; R² is Et; q is 0; W is N—CN; and R¹ is |
| 23 | A is A-3a; R² is c-Pr; q is 0; W is N—CN; and R¹ is |
| 24 | A is A-3a; R² is i-PrCH₂; q is 0; W is N—CN; and R¹ is |
| 25 | A is A-3a; R² is c-PrCH₂; q is 0; W is N—CN; and R¹ is |
| 26 | A is A-3a; R² is MeO; q is 0; W is N—CN; and R¹ is |
| 27 | A is A-3a; R² is MeOCH₂; q is 0; W is N—CN; and R¹ is |
| 28 | A is A-3a; R² is CH₂═CHCH₂; q is 0; W is N—CN; and R¹ is |
| 29 | A is A-3a; R² is CNCH₂; q is 0; W is N—CN; and R¹ is |
| 30 | A is A-3a; R² is i-Pr; q is 0; W is N—CN; and R¹ is |
| 31 | A is A-5a; R² is Me; q is 0; W is N—CN; and R¹ is |
| 32 | A is A-5a; R² is Et; q is 0; W is N—CN; and R¹ is |
| 33 | A is A-5a; R² is c-Pr; q is 0; W is N—CN; and R¹ is |
| 34 | A is A-5a; R² is i-PrCH₂; q is 0; W is N—CN; and R¹ is |
| 35 | A is A-5a; R² is c-PrCH₂; q is 0; W is N—CN; and R¹ is |
| 36 | A is A-5a; R² is MeO; q is 0; W is N—CN; and R¹ is |
| 37 | A is A-5a; R² is MeOCH₂; q is 0; W is N—CN; and R¹ is |
| 38 | A is A-5a; R² is CH₂═CHCH₂; q is 0; W is N—CN; and R¹ is |
| 39 | A is A-5a; R² is CNCH₂; q is 0; W is N—CN; and R¹ is |
| 40 | A is A-5a; R² is i-Pr; q is 0; W is N—CN; and R¹ is |
| 41 | A is A-5b; R² is Me; q is 0; W is N—CN; and R¹ is |
| 42 | A is A-5b; R² is Et; q is 0; W is N—CN; and R¹ is |
| 43 | A is A-5b; R² is c-Pr; q is 0; W is N—CN; and R¹ is |
| 44 | A is A-5b; R² is i-PrCH₂; q is 0; W is N—CN; and R¹ is |
| 45 | A is A-5b; R² is c-PrCH₂; q is 0; W is N—CN; and R¹ is |
| 46 | A is A-5b; R² is MeO; q is 0; W is N—CN; and R¹ is |
| 47 | A is A-5b; R² is MeOCH₂; q is 0; W is N—CN; and R¹ is |
| 48 | A is A-5b; R² is CH₂═CHCH₂; q is 0; W is N—CN; and R¹ is |
| 49 | A is A-5b; R² is CNCH₂; q is 0; W is N—CN; and R¹ is |
| 50 | A is A-5b; R² is i-Pr; q is 0; W is N—CN; and R¹ is |
| 51 | A is A-1a; R² is Me; q is 1; W is N—CN; and R¹ is |
| 52 | A is A-1a; R² is Et; q is 1; W is N—CN; and R¹ is |
| 53 | A is A-1a; R² is c-Pr; q is 1; W is N—CN; and R¹ is |
| 54 | A is A-1a; R² is i-PrCH₂; q is 1; W is N—CN; and R¹ is |
| 55 | A is A-1a; R² is c-PrCH₂; q is 1; W is N—CN; and R¹ is |
| 56 | A is A-1a; R² is MeO; q is 1; W is N—CN; and R¹ is |
| 57 | A is A-1a; R² is MeOCH₂; q is 1; W is N—CN; and R¹ is |
| 58 | A is A-1a; R² is CH₂═CHCH₂; q is 1; W is N—CN; and R¹ is |
| 59 | A is A-1a; R² is CNCH₂; q is 1; W is N—CN; and R¹ is |
| 60 | A is A-1a; R² is i-Pr; q is 1; W is N—CN; and R¹ is |
| 61 | A is A-1b; R² is Me; q is 1; W is N—CN; and R¹ is |
| 62 | A is A-1b; R² is Et; q is 1; W is N—CN; and R¹ is |
| 63 | A is A-1b; R² is c-Pr; q is 1; W is N—CN; and R¹ is |
| 64 | A is A-1b; R² is i-PrCH₂; q is 1; W is N—CN; and R¹ is |
| 65 | A is A-1b; R² is c-PrCH₂; q is 1; W is N—CN; and R¹ is |
| 66 | A is A-1b; R² is MeO; q is 1; W is N—CN; and R¹ is |
| 67 | A is A-1b; R² is MeOCH₂; q is 1; W is N—CN; and R¹ is |
| 68 | A is A-1b; R² is CH₂═CHCH₂; q is 1; W is N—CN; and R¹ is |
| 69 | A is A-1b; R² is CNCH₂; q is 1; W is N—CN; and R¹ is |
| 70 | A is A-1b; R² is i-Pr; q is 1; W is N—CN; and R¹ is |
| 71 | A is A-1b; R² is Me; q is 1; W is N—CN; and R¹ is |
| 72 | A is A-3a; R² is Et; q is 1; W is N—CN; and R¹ is |
| 73 | A is A-3a; R² is c-Pr; q is 1; W is N—CN; and R¹ is |
| 74 | A is A-3a; R² is i-PrCH₂; q is 1; W is N—CN; and R¹ is |
| 75 | A is A-3a; R² is c-PrCH₂; q is 1; W is N—CN; and R¹ is |
| 76 | A is A-3a; R² is MeO; q is 1; W is N—CN; and R¹ is |
| 77 | A is A-3a; R² is MeOCH₂; q is 1; W is N—CN; and R¹ is |
| 78 | A is A-3a; R² is CH₂═CHCH₂; q is 1; W is N—CN; and R¹ is |
| 79 | A is A-3a; R² is CNCH₂; q is 1; W is N—CN; and R¹ is |
| 80 | A is A-3a; R² is i-Pr; q is 1; W is N—CN; and R¹ is |
| 81 | A is A-5a; R² is Me; q is 1; W is N—CN; and R¹ is |
| 82 | A is A-5a; R² is Et; q is 1; W is N—CN; and R¹ is |
| 83 | A is A-5a; R² is c-Pr; q is 1; W is N—CN; and R¹ is |
| 84 | A is A-5a; R² is i-PrCH₂; q is 1; W is N—CN; and R¹ is |
| 85 | A is A-5a; R² is c-PrCH₂; q is 1; W is N—CN; and R¹ is |
| 86 | A is A-5a; R² is MeO; q is 1; W is N—CN; and R¹ is |
| 87 | A is A-5a; R² is MeOCH₂; q is 1; W is N—CN; and R¹ is |
| 88 | A is A-5a; R² is CH₂═CHCH₂; q is 1; W is N—CN; and R¹ is |
| 89 | A is A-5a; R² is CNCH₂; q is 1; W is N—CN; and R¹ is |
| 90 | A is A-5a; R² is i-Pr; q is 1; W is N—CN; and R¹ is |
| 91 | A is A-5b; R² is Me; q is 1; W is N—CN; and R¹ is |
| 92 | A is A-5b; R² is Et; q is 1; W is N—CN; and R¹ is |
| 93 | A is A-5b; R² is c-Pr; q is 1; W is N—CN; and R¹ is |
| 94 | A is A-5b; R² is i-PrCH₂; q is 1; W is N—CN; and R¹ is |
| 95 | A is A-5b; R² is c-PrCH₂; q is 1; W is N—CN; and R¹ is |
| 96 | A is A-5b; R² is MeO; q is 1; W is N—CN; and R¹ is |
| 97 | A is A-5b; R² is MeOCH₂; q is 1; W is N—CN; and R¹ is |
| 98 | A is A-5b; R² is CH₂═CHCH₂; q is 1; W is N—CN; and R¹ is |
| 99 | A is A-5b; R² is CNCH₂; q is 1; W is N—CN; and R¹ is |
| 100 | A is A-5b; R² is i-Pr; q is 1; W is N—CN; and R¹ is |
| 101 | A is A-1a; R² is Me; q is 1; W is N—CN; and R¹ is |
| 102 | A is A-1a; R² is Et; q is 1; W is N—CN; and R¹ is |
| 103 | A is A-1a; R² is c-Pr; q is 0; W is NH; and R¹ is |
| 104 | A is A-1a; R² is i-PrCH₂; q is 0; W is NH; and R¹ is |
| 105 | A is A-1a; R² is c-PrCH₂; q is 0; W is NH; and R¹ is |
| 106 | A is A-1a; R² is MeO; q is 0; W is NH; and R¹ is |
| 107 | A is A-1a; R² is MeOCH₂; q is 0; W is NH; and R¹ is |
| 108 | A is A-1a; R² is CH₂═CHCH₂; q is 0; W is NH; and R¹ is |
| 109 | A is A-1a; R² is CNCH₂; q is 0; W is NH; and R¹ is |
| 110 | A is A-1a; R² is i-Pr; q is 0; W is NH; and R¹ is |
| 111 | A is A-1b; R² is Me; q is 0; W is NH; and R¹ is |
| 112 | A is A-1b; R² is Et; q is 0; W is NH; and R¹ is |
| 113 | A is A-1b; R² is c-Pr; q is 0; W is NH; and R¹ is |
| 114 | A is A-1b; R² is i-PrCH₂; q is 0; W is NH; and R¹ is |
| 115 | A is A-1b; R² is c-PrCH₂; q is 0; W is NH; and R¹ is |
| 116 | A is A-1b; R² is MeO; q is 0; W is NH; and R¹ is |
| 117 | A is A-1b; R² is MeOCH₂; q is 0; W is NH; and R¹ is |
| 118 | A is A-1b; R² is CH₂═CHCH₂; q is 0; W is NH; and R¹ is |
| 119 | A is A-1b; R² is CNCH₂; q is 0; W is NH; and R¹ is |
| 120 | A is A-1b; R² is i-Pr; q is 0; W is NH; and R¹ is |
| 121 | A is A-3a; R² is Me; q is 0; W is NH; and R¹ is |
| 122 | A is A-3a; R² is Et; q is 0; W is NH; and R¹ is |
| 123 | A is A-3a; R² is c-Pr; q is 0; W is NH; and R¹ is |
| 124 | A is A-3a; R² is i-PrCH₂; q is 0; W is NH; and R¹ is |
| 125 | A is A-3a; R² is c-PrCH₂; q is 0; W is NH; and R¹ is |
| 126 | A is A-3a; R² is MeO; q is 0; W is NH; and R¹ is |
| 127 | A is A-3a; R² is MeOCH₂; q is 0; W is NH; and R¹ is |
| 128 | A is A-3a; R² is CH₂═CHCH₂; q is 0; W is NH; and R¹ is |
| 129 | A is A-3a; R² is CNCH₂; q is 0; W is NH; and R¹ is |
| 130 | A is A-3a; R² is i-Pr; q is 0; W is NH; and R¹ is |
| 131 | A is A-5a; R² is Me; q is 0; W is NH; and R¹ is |
| 132 | A is A-5a; R² is Et; q is 0; W is NH; and R¹ is |
| 133 | A is A-5a; R² is c-Pr; q is 0; W is NH; and R¹ is |
| 134 | A is A-5a; R² is i-PrCH₂; q is 0; W is NH; and R¹ is |
| 135 | A is A-5a; R² is c-PrCH₂; q is 0; W is NH; and R¹ is |
| 136 | A is A-5a; R² is MeO; q is 0; W is NH; and R¹ is |
| 137 | A is A-5a; R² is MeOCH₂; q is 0; W is NH; and R¹ is |
| 138 | A is A-5a; R² is CH₂═CHCH₂; q is 0; W is NH; and R¹ is |
| 139 | A is A-5a; R² is CNCH₂; q is 0; W is NH; and R¹ is |
| 140 | A is A-5a; R² is i-Pr; q is 0; W is NH; and R¹ is |
| 141 | A is A-5b; R² is Me; q is 0; W is NH; and R¹ is |
| 142 | A is A-5b; R² is Et; q is 0; W is NH; and R¹ is |
| 143 | A is A-5b; R² is c-Pr; q is 0; W is NH; and R¹ is |
| 144 | A is A-5b; R² is i-PrCH₂; q is 0; W is NH; and R¹ is |
| 145 | A is A-5b; R² is c-PrCH₂; q is 0; W is NH; and R¹ is |
| 146 | A is A-5b; R² is MeO; q is 0; W is NH; and R¹ is |
| 147 | A is A-5b; R² is MeOCH₂; q is 0; W is NH; and R¹ is |
| 148 | A is A-5b; R² is CH₂═CHCH₂; q is 0; W is NH; and R¹ is |
| 149 | A is A-5b; R² is CNCH₂; q is 0; W is NH; and R¹ is |
| 150 | A is A-5b; R² is i-Pr; q is 0; W is NH; and R¹ is |
| 151 | A is A-1a; R² is Me; q is 0; W is NH; and R¹ is |
| 152 | A is A-1a; R² is Et; q is 0; W is NH; and R¹ is |
| 153 | A is A-1a; R² is c -Pr; q is 1; W is NH; and R¹ is |
| 154 | A is A-1a; R² is i-PrCH₂; q is 1; W is NH; and R¹ is |
| 155 | A is A-1a; R² is c-PrCH₂; q is 1; W is NH; and R¹ is |
| 156 | A is A-1a; R² is MeO; q is 1; W is NH; and R¹ is |
| 157 | A is A-1a; R² is MeOCH₂; q is 1; W is NH; and R¹ is |
| 158 | A is A-1a; R² is CH₂═CHCH₂; q is 1; W is NH; and R¹ is |
| 159 | A is A-1a; R² is CNCH₂; q is 1; W is NH; and R¹ is |
| 160 | A is A-1a; R² is i-Pr; q is 1; W is NH; and R¹ is |
| 161 | A is A-1b; R² is Me; q is 1; W is NH; and R¹ is |
| 162 | A is A-1b; R² is Et; q is 1; W is NH; and R¹ is |
| 163 | A is A-1b; R² is c-Pr; q is 1; W is NH; and R¹ is |
| 164 | A is A-1b; R² is i-PrCH₂; q is 1; W is NH; and R¹ is |
| 165 | A is A-1b; R² is c-PrCH₂; q is 1; W is NH; and R¹ is |
| 166 | A is A-1b; R² is MeO; q is 1; W is NH; and R¹ is |
| 167 | A is A-1b; R² is MeOCH₂; q is 1; W is NH; and R¹ is |
| 168 | A is A-1b; R² is CH₂═CHCH₂; q is 1; W is NH; and R¹ is |
| 169 | A is A-1b; R² is CNCH₂; q is 1; W is NH; and R¹ is |
| 170 | A is A-1b; R² is i-Pr; q is 1; W is NH; and R¹ is |
| 171 | A is A-3a; R² is Me; q is 1; W is NH; and R¹ is |
| 172 | A is A-3a; R² is Et; q is 1; W is NH; and R¹ is |
| 173 | A is A-3a; R² is c-Pr; q is 1; W is NH; and R¹ is |
| 174 | A is A-3a; R² is i-PrCH₂; q is 1; W is NH; and R¹ is |
| 175 | A is A-3a; R² is c-PrCH₂; q is 1; W is NH; and R¹ is |
| 176 | A is A-3a; R² is MeO; q is 1; W is NH; and R¹ is |
| 177 | A is A-3a; R² is MeOCH₂; q is 1; W is NH; and R¹ is |
| 178 | A is A-3a; R² is CH₂═CHCH₂; q is 1; W is NH; and R¹ is |
| 179 | A is A-3a; R² is CNCH₂; q is 1; W is NH; and R¹ is |
| 180 | A is A-3a; R² is i-Pr; q is 1; W is NH; and R¹ is |
| 181 | A is A-5a; R² is Me; q is 1; W is NH; and R¹ is |
| 182 | A is A-5a; R² is Et; q is 1; W is NH; and R¹ is |
| 183 | A is A-5a; R² is c-Pr; q is 1; W is NH; and R¹ is |
| 184 | A is A-5a; R² is i-PrCH₂; q is 1; W is NH; and R¹ is |
| 185 | A is A-5a; R² is c-PrCH₂; q is 1; W is NH; and R¹ is |
| 186 | A is A-5a; R² is MeO; q is 1; W is NH; and R¹ is |
| 187 | A is A-5a; R² is MeOCH₂; q is 1; W is NH; and R¹ is |
| 188 | A is A-5a; R² is CH₂═CHCH₂; q is 1; W is NH; and R¹ is |
| 189 | A is A-5a; R² is CNCH₂; q is 1; W is NH; and R¹ is |
| 190 | A is A-5a; R² is i-Pr; q is 1; W is NH; and R¹ is |
| 191 | A is A-5b; R² is Me; q is 1; W is NH; and R¹ is |
| 192 | A is A-5b; R² is Et; q is 1; W is NH; and R¹ is |
| 193 | A is A-5b; R² is c-Pr; q is 1; W is NH; and R¹ is |
| 194 | A is A-5b; R² is i-PrCH₂; q is 1; W is NH; and R¹ is |
| 195 | A is A-5b; R² is c-PrCH₂; q is 1; W is NH; and R¹ is |
| 196 | A is A-5b; R² is MeO; q is 1; W is NH; and R¹ is |
| 197 | A is A-5b; R² is MeOCH₂; q is 1; W is NH; and R¹ is |
| 198 | A is A-5b; R² is CH₂═CHCH₂; q is 1; W is NH; and R¹ is |
| 199 | A is A-5b; R² is CNCH₂; q is 1; W is NH; and R¹ is |
| 200 | A is A-5b; R² is i-Pr; q is 1; W is NH; and R¹ is |

Tables 201 through 400 are constructed the same as Tables 1 through 200 except that the structure is replaced with:

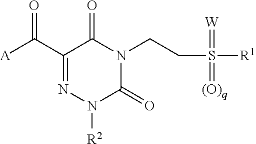

Tables 401 through 600 are constructed the same as Tables 1 through 200 except that the structure is replaced with replaced with:

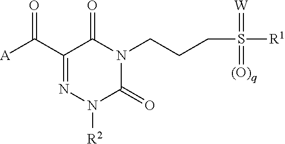

Tables 601 through 800 are constructed the same as Tables 1 through 200 except that the structure is replaced with replaced with:

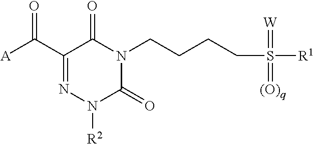

Tables 801 through 1000 are constructed the same as Tables 1 through 200 except that the structure is replaced with replaced with:

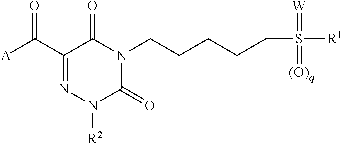

TABLE 1001 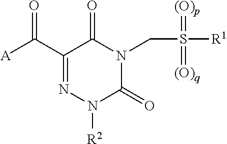
A is A-1a; R² is CH₃; q is 0; p is 0; and R¹ is
CH₂CH═CH₂
CH₂CH₂CH═CH₂
CH₂CH═CHCH₃
CH₂C≡CH
CH₂C≡CCH₃
CH₂OCH₃
CH₂OCH₂CH₃
CH₂O-c-Pr
CH₂O-c-Bu
CH₂O—c-pentyl
CH₂O—c-hexyl
CH₂CH₂OCH₃
CH₂CH₂OCH₂CH₃
CH₂CH₂O—c-Pr
CH₂CH₂O—c-Bu
CH₂CH₂O-c-pentyl
CH₂CH₂O-c-hexyl
CH₂OCH₂OCH₃
CH₂OCH₂OCH₂CH₃
CH₂OCH₂CH₂OCH₃
CH₂OCH₂CH₂OCH₂CH₃
CH₂CH₂OCH₂OCH₃
CH₂CH₂OCH₂OCH₂CH₃
CH₂CH₂OCH₂CH₂OCH₃
CH₂CH₂OCH₂CH₂OCH₂CH₃
CH₂—c-Pr
CH₂—c-Bu
CH₂-c-pentyl
CH₂-c-hexyl
CH₂-(oxiran-2-yl)
CH₂CH₂-(oxiran-2-yl)
CH₂-(oxetan-2-yl)
CH₂CH₂-(oxetan-3-yl)
CH₂-(tetrahydrofuran-2-yl)
CH₂CH₂-(tetrahydrofuran-3-yl)
CH₂-(tetrahydropyran-2-yl)
CH₂CH₂-(tetrahydropyran-3-yl)

The following Tables are constructed the same as TABLE 1001 above except that the Row Heading in TABLE 1001 (i.e. “A is A-1a; R² is CH₃; q is 0; p is 0; and R¹ is”) is replaced with the Row Heading listed in TABLE 1002 (i.e. “A is A-1a; R² is Et; q is 0; p is 0; and R¹ is”). For example, the first entry in TABLE 1002 explicitly names a compound of Formula 1 wherein A is A-1a, R¹ is CH₂CH═CH₂; R² is Et; q is 0; and p is 0. TABLE 1003 through TABLE 1150 is constructed similarly

| TABLE | Row Heading |
|---|---|
| 1002 | A is A-1a; R² is Et; q is 0; p is 0; and R¹ is |
| 1003 | A is A-1a; R² is c-Pr; q is 0; p is 0; and R¹ is |
| 1004 | A is A-1a; R² is i-PrCH₂; q is 0; p is 0; and R¹ is |
| 1005 | A is A-1a; R² is c-PrCH₂; q is 0; p is 0; and R¹ is |
| 1006 | A is A-1a; R² is MeO; q is 0; p is 0; and R¹ is |
| 1007 | A is A-1a; R² is MeOCH₂; q is 0; p is 0; and R¹ is |
| 1008 | A is A-1a; R² is CH₂═CHCH₂; q is 0; p is 0; and R¹ is |
| 1009 | A is A-1a; R² is CNCH₂; q is 0; p is 0; and R¹ is |
| 1010 | A is A-1a; R² is i-Pr; q is 0; p is 0; and R¹ is |
| 1011 | A is A-1b; R² is Me; q is 0; p is 0; and R¹ is |
| 1012 | A is A-1b; R² is Et; q is 0; p is 0; and R¹ is |
| 1013 | A is A-1b; R² is c-Pr; q is 0; p is 0; and R¹ is |
| 1014 | A is A-1b; R² is i-PrCH₂; q is 0; p is 0; and R¹ is |
| 1015 | A is A-1b; R² is c-PrCH₂; q is 0; p is 0; and R¹ is |
| 1016 | A is A-1b; R² is MeO; q is 0; p is 0; and R¹ is |
| 1017 | A is A-1b; R² is MeOCH₂; q is 0; p is 0; and R¹ is |
| 1018 | A is A-1b; R² is CH₂═CHCH₂; q is 0; p is 0; and R¹ is |
| 1019 | A is A-1b; R² is CNCH₂; q is 0; p is 0; and R¹ is |
| 1020 | A is A-1b; R² is i-Pr; q is 0; p is 0; and R¹ is |
| 1021 | A is A-3a; R² is Me; q is 0; p is 0; and R¹ is |
| 1022 | A is A-3a; R² is Et; q is 0; p is 0; and R¹ is |
| 1023 | A is A-3a; R² is c-Pr; q is 0; p is 0; and R¹ is |
| 1024 | A is A-3a; R² is i-PrCH₂; q is 0; p is 0; and R¹ is |
| 1025 | A is A-3a; R² is c-PrCH₂; q is 0; p is 0; and R¹ is |
| 1026 | A is A-3a; R² is MeO; q is 0; p is 0; and R¹ is |
| 1027 | A is A-3a; R² is MeOCH₂; q is 0; p is 0; and R¹ is |
| 1028 | A is A-3a; R² is CH₂═CHCH₂; q is 0; p is 0; and R¹ is |
| 1029 | A is A-3a; R² is CNCH₂; q is 0; p is 0; and R¹ is |
| 1030 | A is A-3a; R² is i-Pr; q is 0; p is 0; and R¹ is |
| 1031 | A is A-5a; R² is Me; q is 0; p is 0; and R¹ is |
| 1032 | A is A-5a; R² is Et; q is 0; p is 0; and R¹ is |
| 1033 | A is A-5a; R² is c-Pr; q is 0; p is 0; and R¹ is |
| 1034 | A is A-5a; R² is i-PrCH₂; q is 0; p is 0; and R¹ is |
| 1035 | A is A-5a; R² is c-PrCH₂; q is 0; p is 0; and R¹ is |
| 1036 | A is A-5a; R² is MeO; q is 0; p is 0; and R¹ is |
| 1037 | A is A-5a; R² is MeOCH₂; q is 0; p is 0; and R¹ is |
| 1038 | A is A-5a; R² is CH₂═CHCH₂; q is 0; p is 0; and R¹ is |
| 1039 | A is A-5a; R² is CNCH₂; q is 0; p is 0; and R¹ is |
| 1040 | A is A-5a; R² is i-Pr; q is 0; p is 0; and R¹ is |
| 1041 | A is A-5b; R² is Me; q is 0; p is 0; and R¹ is |
| 1042 | A is A-5b; R² is Et; q is 0; p is 0; and R¹ is |
| 1043 | A is A-5b; R² is c-Pr; q is 0; p is 0; and R¹ is |
| 1044 | A is A-5b; R² is i-PrCH₂; q is 0; p is 0; and R¹ is |
| 1045 | A is A-5b; R² is c-PrCH₂; q is 0; p is 0; and R¹ is |
| 1046 | A is A-5b; R² is MeO; q is 0; p is 0; and R¹ is |
| 1047 | A is A-5b; R² is MeOCH₂; q is 0; p is 0; and R¹ is |
| 1048 | A is A-5b; R² is CH₂═CHCH₂; q is 0; p is 0; and R¹ is |
| 1049 | A is A-5b; R² is CNCH₂; q is 0; p is 0; and R¹ is |
| 1050 | A is A-5b; R² is i-Pr; q is 0; p is 0; and R¹ is |
| 1051 | A is A-1a; R² is Me; q is 1; p is 0; and R¹ is |
| 1052 | A is A-1a; R² is Et; q is 1; p is 0; and R¹ is |
| 1053 | A is A-1a; R² is c-Pr; q is 1; p is 0; and R¹ is |
| 1054 | A is A-1a; R² is i-PrCH₂; q is 1; p is 0; and R¹ is |
| 1055 | A is A-1a; R² is c-PrCH₂; q is 1; p is 0; and R¹ is |
| 1056 | A is A-1a; R² is MeO; q is 1; p is 0; and R¹ is |
| 1057 | A is A-1a; R² is MeOCH₂; q is 1; p is 0; and R¹ is |
| 1058 | A is A-1a; R² is CH₂═CHCH₂; q is 1; p is 0; and R¹ is |
| 1059 | A is A-1a; R² is CNCH₂; q is 1; p is 0; and R¹ is |
| 1060 | A is A-1a; R² is i-Pr; q is 1; p is 0; and R¹ is |
| 1061 | A is A-1b; R² is Me; q is 1; p is 0; and R¹ is |
| 1062 | A is A-1b; R² is Et; q is 1; p is 0; and R¹ is |
| 1063 | A is A-1b; R² is c-Pr; q is 1; p is 0; and R¹ is |
| 1064 | A is A-1b; R² is i-PrCH₂; q is 1; p is 0; and R¹ is |
| 1065 | A is A-1b; R² is c-PrCH₂; q is 1; p is 0; and R¹ is |
| 1066 | A is A-1b; R² is MeO; q is 1; p is 0; and R¹ is |
| 1067 | A is A-1b; R² is MeOCH₂; q is 1; p is 0; and R¹ is |
| 1068 | A is A-1b; R² is CH₂═CHCH₂; q is 1; p is 0; and R¹ is |
| 1069 | A is A-1b; R² is CNCH₂; q is 1; p is 0; and R¹ is |
| 1070 | A is A-1b; R² is i-Pr; q is 1; p is 0; and R¹ is |
| 1071 | A is A-3a; R² is Me; q is 1; p is 0; and R¹ is |
| 1072 | A is A-3a; R² is Et; q is 1; p is 0; and R¹ is |
| 1073 | A is A-3a; R² is c-Pr; q is 1; p is 0; and R¹ is |
| 1074 | A is A-3a; R² is i-PrCH₂; q is 1; p is 0; and R¹ is |
| 1075 | A is A-3a; R² is c-PrCH₂; q is 1; p is 0; and R¹ is |
| 1076 | A is A-3a; R² is MeO; q is 1; p is 0; and R¹ is |
| 1077 | A is A-3a; R² is MeOCH₂; q is 1; p is 0; and R¹ is |
| 1078 | A is A-3a; R² is CH₂═CHCH₂; q is 1; p is 0; and R¹ is |
| 1079 | A is A-3a; R² is CNCH₂; q is 1; p is 0; and R¹ is |
| 1080 | A is A-3a; R² is i-Pr; q is 1; p is 0; and R¹ is |
| 1081 | A is A-5a; R² is Me; q is 1; p is 0; and R¹ is |
| 1082 | A is A-5a; R² is Et; q is 1; p is 0; and R¹ is |
| 1083 | A is A-5a; R² is c-Pr; q is 1; p is 0; and R¹ is |
| 1084 | A is A-5a; R² is i-PrCH₂; q is 1; p is 0; and R¹ is |
| 1085 | A is A-5a; R² is c-PrCH₂; q is 1; p is 0; and R¹ is |
| 1086 | A is A-5a; R² is MeO; q is 1; p is 0; and R¹ is |
| 1087 | A is A-5a; R² is MeOCH₂; q is 1; p is 0; and R¹ is |
| 1088 | A is A-5a; R² is CH₂═CHCH₂; q is 1; p is 0; and R¹ is |
| 1089 | A is A-5a; R² is CNCH₂; q is 1; p is 0; and R¹ is |
| 1090 | A is A-5a; R² is i-Pr; q is 1; p is 0; and R¹ is |
| 1091 | A is A-5b; R² is Me; q is 1; p is 0; and R¹ is |
| 1092 | A is A-5b; R² is Et; q is 1; p is 0; and R¹ is |
| 1093 | A is A-5b; R² is c-Pr; q is 1; p is 0; and R¹ is |
| 1094 | A is A-5b; R² is i-PrCH₂; q is 1; p is 0; and R¹ is |
| 1095 | A is A-5b; R² is c-PrCH₂; q is 1; p is 0; and R¹ is |
| 1096 | A is A-5b; R² is MeO; q is 1; p is 0; and R¹ is |
| 1097 | A is A-5b; R² is MeOCH₂; q is 1; p is 0; and R¹ is |
| 1098 | A is A-5b; R² is CH₂═CHCH₂; q is 1; p is 0; and R¹ is |
| 1099 | A is A-5b; R² is CNCH₂; q is 1; p is 0; and R¹ is |
| 1100 | A is A-5b; R² is i-Pr; q is 1; p is 0; and R¹ is |
| 1001 | A is A-1a; R² is Me; q is 1; p is 1; and R¹ is |
| 1002 | A is A-1a; R² is Et; q is 1; p is 1; and R¹ is |
| 1003 | A is A-1a; R² is c-Pr; q is 1; p is 1; and R¹ is |
| 1004 | A is A-1a; R² is i-PrCH₂; q is 1; p is 1; and R¹ is |
| 1005 | A is A-1a; R² is c-PrCH₂; q is 1; p is 1; and R¹ is |
| 1006 | A is A-1a; R² is MeO; q is 1; p is 1; and R¹ is |
| 1007 | A is A-1a; R² is MeOCH₂; q is 1; p is 1; and R¹ is |
| 1008 | A is A-1a; R² is CH₂═CHCH₂; q is 1; p is 1; and R¹ is |
| 1009 | A is A-1a; R² is CNCH₂; q is 1; p is 1; and R¹ is |
| 1010 | A is A-1a; R² is i-Pr; q is 1; p is 1; and R¹ is |
| 1111 | A is A-1b; R² is Me; q is 1; p is 1; and R¹ is |
| 1112 | A is A-1b; R² is Et; q is 1; p is 1; and R¹ is |
| 1113 | A is A-1b; R² is c-Pr; q is 1; p is 1; and R¹ is |
| 1114 | A is A-1b; R² is i-PrCH₂; q is 1; p is 1; and R¹ is |
| 1115 | A is A-1b; R² is c-PrCH₂; q is 1; p is 1; and R¹ is |
| 1116 | A is A-1b; R² is MeO; q is 1; p is 1; and R¹ is |
| 1117 | A is A-1b; R² is MeOCH₂; q is 1; p is 1; and R¹ is |
| 1118 | A is A-1b; R² is CH₂═CHCH₂; q is 1; p is 1; and R¹ is |
| 1119 | A is A-1b; R² is CNCH₂; q is 1; p is 1; and R¹ is |
| 1120 | A is A-1b; R² is i-Pr; q is 1; p is 1; and R¹ is |
| 1121 | A is A-3a; R² is Me; q is 1; p is 1; and R¹ is |
| 1122 | A is A-3a; R² is Et; q is 1; p is 1; and R¹ is |
| 1123 | A is A-3a; R² is c-Pr; q is 1; p is 1; and R¹ is |
| 1124 | A is A-3a; R² is i-PrCH₂; q is 1; p is 1; and R¹ is |
| 1125 | A is A-3a; R² is c-PrCH₂; q is 1; p is 1; and R¹ is |
| 1126 | A is A-3a; R² is MeO; q is 1; p is 1; and R¹ is |
| 1127 | A is A-3a; R² is MeOCH₂; q is 1; p is 1; and R¹ is |
| 1128 | A is A-3a; R² is CH₂═CHCH₂; q is 1; p is 1; and R¹ is |
| 1129 | A is A-3a; R² is CNCH₂; q is 1; p is 1; and R¹ is |
| 1130 | A is A-3a; R² is i-Pr; q is 1; p is 1; and R¹ is |
| 1131 | A is A-5a; R² is Me; q is 1; p is 1; and R¹ is |
| 1132 | A is A-5a; R² is Et; q is 1; p is 1; and R¹ is |
| 1133 | A is A-5a; R² is c-Pr; q is 1; p is 1; and R¹ is |
| 1134 | A is A-5a; R² is i-PrCH₂; q is 1; p is 1; and R¹ is |
| 1135 | A is A-5a; R² is c-PrCH₂; q is 1; p is 1; and R¹ is |
| 1136 | A is A-5a; R² is MeO; q is 1; p is 1; and R¹ is |
| 1137 | A is A-5a; R² is MeOCH₂; q is 1; p is 1; and R¹ is |
| 1138 | A is A-5a; R² is CH₂═CHCH₂; q is 1; p is 1; and R¹ is |
| 1139 | A is A-5a; R² is CNCH₂; q is 1; p is 1; and R¹ is |
| 1140 | A is A-5a; R² is i-Pr; q is 1; p is 1; and R¹ is |
| 1141 | A is A-5b; R² is Me; q is 1; p is 1; and R¹ is |
| 1142 | A is A-5b; R² is Et; q is 1; p is 1; and R¹ is |
| 1143 | A is A-5b; R² is c-Pr; q is 1; p is 1; and R¹ is |
| 1144 | A is A-5b; R² is i-PrCH₂; q is 1; p is 1; and R¹ is |
| 1145 | A is A-5b; R² is c-PrCH₂; q is 1; p is 1; and R¹ is |
| 1146 | A is A-5b; R² is MeO; q is 1; p is 1; and R¹ is |
| 1147 | A is A-5b; R² is MeOCH₂; q is 1; p is 1; and R¹ is |
| 1148 | A is A-5b; R² is CH₂═CHCH₂; q is 1; p is 1; and R¹ is |
| 1149 | A is A-5b; R² is CNCH₂; q is 1; p is 1; and R¹ is |
| 1150 | A is A-5b; R² is i-Pr; q is 1; p is 1; and R¹ is |

Tables 1151 through 1300 are constructed the same as Tables 1001 through 1150 except that the structure is replaced with:

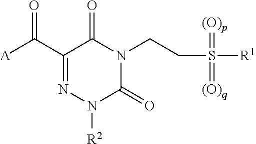

Tables 1301 through 1450 are constructed the same as Tables 1001 through 1150 except that the structure is replaced with:

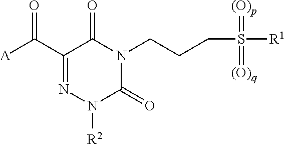

Tables 1451 through 1600 are constructed the same as Tables 1001 through 1150 except that the structure is replaced with:

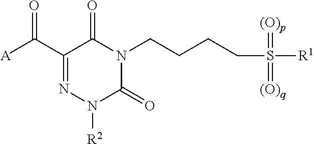

Tables 1601 through 1750 are constructed the same as Tables 1001 through 1150 except that the structure is replaced with:

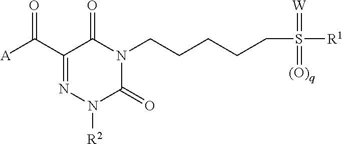

A compound of this invention will generally be used as a herbicidal active ingredient in a composition, i.e. formulation, with at least one additional component selected from the group consisting of surfactants, solid diluents and liquid diluents, which serves as a carrier. The formulation or composition ingredients are selected to be consistent with the physical properties of the active ingredient, mode of application and environmental factors such as soil type, moisture and temperature.

Useful formulations include both liquid and solid compositions. Liquid compositions include solutions (including emulsifiable concentrates), suspensions, emulsions (including microemulsions and/or suspoemulsions) and the like, which optionally can be thickened into gels. The general types of aqueous liquid compositions are soluble concentrate, suspension concentrate, capsule suspension, concentrated emulsion, microemulsion and suspo-emulsion. The general types of nonaqueous liquid compositions are emulsifiable concentrate, microemulsifiable concentrate, dispersible concentrate and oil dispersion.

The general types of solid compositions are dusts, powders, granules, pellets, prills, pastilles, tablets, filled films (including seed coatings) and the like, which can be water-dispersible (“wettable”) or water-soluble. Films and coatings formed from film-forming solutions or flowable suspensions are particularly useful for seed treatment. Active ingredient can be (micro)encapsulated and further formed into a suspension or solid formulation; alternatively the entire formulation of active ingredient can be encapsulated (or “overcoated”). Encapsulation can control or delay release of the active ingredient. An emulsifiable granule combines the advantages of both an emulsifiable concentrate formulation and a dry granular formulation. High-strength compositions are primarily used as intermediates for further formulation.

Sprayable formulations are typically extended in a suitable medium before spraying. Such liquid and solid formulations are formulated to be readily diluted in the spray medium, usually water. Spray volumes can range from about from about one to several thousand liters per hectare, but more typically are in the range from about ten to several hundred liters per hectare. Sprayable formulations can be tank mixed with water or another suitable medium for foliar treatment by aerial or ground application, or for application to the growing medium of the plant. Liquid and dry formulations can be metered directly into drip irrigation systems or metered into the furrow during planting.

The formulations will typically contain effective amounts of active ingredient, diluent and surfactant within the following approximate ranges which add up to 100 percent by weight.

| | Weight Percent | | |
|---|---|---|---|
| | Active | | |
| | Ingredient | Diluent | Surfactant |
| Water-Dispersible and Water-soluble | 0.001-90 | 0-99.999 | 0-15 |
| Granules, Tablets and Powders | | | |
| Oil Dispersions, Suspensions, | 1-50 | 40-99 | 0-50 |
| Emulsions, Solutions (including | | | |
| Emulsifiable Concentrates) | | | |
| Dusts | 1-25 | 70-99 | 0-5 |
| Granules and Pellets | 0.001-99 | 5-99.999 | 0-15 |
| High Strength Compositions | 90-99 | 0-10 | 0-2 |

Solid diluents include, for example, clays such as bentonite, montmorillonite, attapulgite and kaolin, gypsum, cellulose, titanium dioxide, zinc oxide, starch, dextrin, sugars (e.g., lactose, sucrose), silica, talc, mica, diatomaceous earth, urea, calcium carbonate, sodium carbonate and bicarbonate, and sodium sulfate. Typical solid diluents are described in Watkins et al., Handbook of Insecticide Dust Diluents and Carriers, 2nd Ed., Dorland Books, Caldwell, N.J.

Liquid diluents include, for example, water, N,N-dimethylalkanamides (e.g., N,N-dimethylformamide), limonene, dimethyl sulfoxide, N-alkylpyrrolidones (e.g., N-methylpyrrolidinone), ethylene glycol, triethylene glycol, propylene glycol, dipropylene glycol, polypropylene glycol, propylene carbonate, butylene carbonate, paraffins (e.g., white mineral oils, normal paraffins, isoparaffins), alkylbenzenes, alkylnaphthalenes, glycerine, glycerol triacetate, sorbitol, aromatic hydrocarbons, dearomatized aliphatics, alkylbenzenes, alkylnaphthalenes, ketones such as cyclohexanone, 2-heptanone, isophorone and 4-hydroxy-4-methyl-2-pentanone, acetates such as isoamyl acetate, hexyl acetate, heptyl acetate, octyl acetate, nonyl acetate, tridecyl acetate and isobornyl acetate, other esters such as alkylated lactate esters, dibasic esters and γ-butyrolactone, and alcohols, which can be linear, branched, saturated or unsaturated, such as methanol, ethanol, n-propanol, isopropyl alcohol, n-butanol, isobutyl alcohol, n-hexanol, 2-ethylhexanol, n-octanol, decanol, isodecyl alcohol, isooctadecanol, cetyl alcohol, lauryl alcohol, tridecyl alcohol, oleyl alcohol, cyclohexanol, tetrahydrofurfuryl alcohol, diacetone alcohol and benzyl alcohol. Liquid diluents also include glycerol esters of saturated and unsaturated fatty acids (typically C₆-C₂₂), such as plant seed and fruit oils (e.g., oils of olive, castor, linseed, sesame, corn (maize), peanut, sunflower, grapeseed, safflower, cottonseed, soybean, rapeseed, coconut and palm kernel), animal-sourced fats (e.g., beef tallow, pork tallow, lard, cod liver oil, fish oil), and mixtures thereof. Liquid diluents also include alkylated fatty acids (e.g., methylated, ethylated, butylated) wherein the fatty acids may be obtained by hydrolysis of glycerol esters from plant and animal sources, and can be purified by distillation. Typical liquid diluents are described in Marsden, Solvents Guide, 2nd Ed., Interscience, New York, 1950.

The solid and liquid compositions of the present invention often include one or more surfactants. When added to a liquid, surfactants (also known as “surface-active agents”) generally modify, most often reduce, the surface tension of the liquid. Depending on the nature of the hydrophilic and lipophilic groups in a surfactant molecule, surfactants can be useful as wetting agents, dispersants, emulsifiers or defoaming agents.

Surfactants can be classified as nonionic, anionic or cationic. Nonionic surfactants useful for the present compositions include, but are not limited to: alcohol alkoxylates such as alcohol alkoxylates based on natural and synthetic alcohols (which may be branched or linear) and prepared from the alcohols and ethylene oxide, propylene oxide, butylene oxide or mixtures thereof; amine ethoxylates, alkanolamides and ethoxylated alkanolamides; alkoxylated triglycerides such as ethoxylated soybean, castor and rapeseed oils; alkylphenol alkoxylates such as octylphenol ethoxylates, nonylphenol ethoxylates, dinonyl phenol ethoxylates and dodecyl phenol ethoxylates (prepared from the phenols and ethylene oxide, propylene oxide, butylene oxide or mixtures thereof); block polymers prepared from ethylene oxide or propylene oxide and reverse block polymers where the terminal blocks are prepared from propylene oxide; ethoxylated fatty acids; ethoxylated fatty esters and oils; ethoxylated methyl esters; ethoxylated tristyrylphenol (including those prepared from ethylene oxide, propylene oxide, butylene oxide or mixtures thereof); fatty acid esters, glycerol esters, lanolin-based derivatives, polyethoxylate esters such as polyethoxylated sorbitan fatty acid esters, polyethoxylated sorbitol fatty acid esters and polyethoxylated glycerol fatty acid esters; other sorbitan derivatives such as sorbitan esters; polymeric surfactants such as random copolymers, block copolymers, alkyd peg (polyethylene glycol) resins, graft or comb polymers and star polymers; polyethylene glycols (pegs); polyethylene glycol fatty acid esters; silicone-based surfactants; and sugar-derivatives such as sucrose esters, alkyl polyglycosides and alkyl polysaccharides.

Useful anionic surfactants include, but are not limited to: alkylaryl sulfonic acids and their salts; carboxylated alcohol or alkylphenol ethoxylates; diphenyl sulfonate derivatives; lignin and lignin derivatives such as lignosulfonates; maleic or succinic acids or their anhydrides; olefin sulfonates; phosphate esters such as phosphate esters of alcohol alkoxylates, phosphate esters of alkylphenol alkoxylates and phosphate esters of styryl phenol ethoxylates; protein-based surfactants; sarcosine derivatives; styryl phenol ether sulfate; sulfates and sulfonates of oils and fatty acids; sulfates and sulfonates of ethoxylated alkylphenols; sulfates of alcohols; sulfates of ethoxylated alcohols; sulfonates of amines and amides such as N,N-alkyltaurates; sulfonates of benzene, cumene, toluene, xylene, and dodecyl and tridecylbenzenes; sulfonates of condensed naphthalenes; sulfonates of naphthalene and alkyl naphthalene; sulfonates of fractionated petroleum; sulfosuccinamates; and sulfosuccinates and their derivatives such as dialkyl sulfosuccinate salts.

Useful cationic surfactants include, but are not limited to: amides and ethoxylated amides; amines such as N-alkyl propanediamines, tripropylenetriamines and dipropylenetetramines, and ethoxylated amines, ethoxylated diamines and propoxylated amines (prepared from the amines and ethylene oxide, propylene oxide, butylene oxide or mixtures thereof); amine salts such as amine acetates and diamine salts; quaternary ammonium salts such as quaternary salts, ethoxylated quaternary salts and diquaternary salts; and amine oxides such as alkyldimethylamine oxides and bis-(2-hydroxyethyl)-alkylamine oxides.

Also useful for the present compositions are mixtures of nonionic and anionic surfactants or mixtures of nonionic and cationic surfactants. Nonionic, anionic and cationic surfactants and their recommended uses are disclosed in a variety of published references including McCutcheon's Emulsifiers and Detergents, annual American and International Editions published by McCutcheon's Division, The Manufacturing Confectioner Publishing Co.; Sisely and Wood, Encyclopedia of Surface Active Agents, Chemical Publ. Co., Inc., New York, 1964; and A. S. Davidson and B. Milwidsky, Synthetic Detergents, Seventh Edition, John Wiley and Sons, New York, 1987.

Compositions of this invention may also contain formulation auxiliaries and additives, known to those skilled in the art as formulation aids (some of which may be considered to also function as solid diluents, liquid diluents or surfactants). Such formulation auxiliaries and additives may control: pH (buffers), foaming during processing (antifoams such polyorganosiloxanes), sedimentation of active ingredients (suspending agents), viscosity (thixotropic thickeners), in-container microbial growth (antimicrobials), product freezing (antifreezes), color (dyes/pigment dispersions), wash-off (film formers or stickers), evaporation (evaporation retardants), and other formulation attributes. Film formers include, for example, polyvinyl acetates, polyvinyl acetate copolymers, polyvinylpyrrolidone-vinyl acetate copolymer, polyvinyl alcohols, polyvinyl alcohol copolymers and waxes. Examples of formulation auxiliaries and additives include those listed in McCutcheon's Volume 2: Functional Materials, annual International and North American editions published by McCutcheon's Division, The Manufacturing Confectioner Publishing Co.; and PCT Publication WO 03/024222.

The compound of Formula 1 and any other active ingredients are typically incorporated into the present compositions by dissolving the active ingredient in a solvent or by grinding in a liquid or dry diluent. Solutions, including emulsifiable concentrates, can be prepared by simply mixing the ingredients. If the solvent of a liquid composition intended for use as an emulsifiable concentrate is water-immiscible, an emulsifier is typically added to emulsify the active-containing solvent upon dilution with water. Active ingredient slurries, with particle diameters of up to 2,000 μm can be wet milled using media mills to obtain particles with average diameters below 3 μm. Aqueous slurries can be made into finished suspension concentrates (see, for example, U.S. Pat. No. 3,060,084) or further processed by spray drying to form water-dispersible granules. Dry formulations usually require dry milling processes, which produce average particle diameters in the 2 to 10 μm range. Dusts and powders can be prepared by blending and usually grinding (such as with a hammer mill or fluid-energy mill). Granules and pellets can be prepared by spraying the active material upon preformed granular carriers or by agglomeration techniques. See Browning, “Agglomeration”, Chemical Engineering, Dec. 4, 1967, pp 147-48, Perry's Chemical Engineer's Handbook, 4th Ed., McGraw-Hill, New York, 1963, pages 8-57 and following, and WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE 3,246,493. Tablets can be prepared as taught in U.S. Pat. No. 5,180,587, U.S. Pat. No. 5,232,701 and U.S. Pat. No. 5,208,030. Films can be prepared as taught in GB 2,095,558 and U.S. Pat. No. 3,299,566.

For further information regarding the art of formulation, see T. S. Woods, “The Formulator's Toolbox—Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; Hance et al., Weed Control Handbook, 8th Ed., Blackwell Scientific Publications, Oxford, 1989; and Developments in formulation technology, PJB Publications, Richmond, UK, 2000.

In the following Examples, all percentages are by weight and all formulations are prepared in conventional ways. Compound numbers refer to compounds in Index Table A. Without further elaboration, it is believed that one skilled in the art using the preceding description can utilize the present invention to its fullest extent. The following Examples are, therefore, to be construed as merely illustrative, and not limiting of the disclosure in any way whatsoever. Percentages are by weight except where otherwise indicated.

### Example A

| High Strength Concentrate | |
|---|---|
| Compound 1, 2, 3, 4, 5 or 6 | 98.5% |
| silica aerogel | 0.5% |
| synthetic amorphous fine silica | 1.0% |

### Example B

| Wettable Powder | |
|---|---|
| Compound 1, 2, 3, 4, 5 or 6 | 65.0% |
| dodecylphenol polyethylene glycol ether | 2.0% |
| sodium ligninsulfonate | 4.0% |
| sodium silicoaluminate | 6.0% |
| montmorillonite (calcined) | 23.0% |

### Example C

| Granule | |
|---|---|
| Compound 1, 2, 3, 4, 5 or 6 | 10.0% |
| attapulgite granules (low volatile matter, | 90.0% |
| 0.71/0.30 mm; U.S.S. No. 25-50 sieves) | |

### Example D

| Extruded Pellet | |
|---|---|
| Compound 1, 2, 3, 4, 5 or 6 | 25.0% |
| anhydrous sodium sulfate | 10.0% |
| crude calcium ligninsulfonate | 5.0% |
| sodium alkylnaphthalenesulfonate | 1.0% |
| calcium/magnesium bentonite | 59.0% |

### Example E

| Emulsifiable Concentrate | |
|---|---|
| Compound 1, 2, 3, 4, 5 or 6 | 10.0% |
| polyoxyethylene sorbitol hexoleate | 20.0% |
| C₆-C₁₀ fatty acid methyl ester | 70.0% |

### Example F

| Microemulsion | |
|---|---|
| Compound 1, 2, 3, 4, 5 or 6 | 5.0% |
| polyvinylpyrrolidone-vinyl acetate copolymer | 30.0% |
| alkylpolyglycoside | 30.0% |
| glyceryl monooleate | 15.0% |
| water | 20.0% |

Test results indicate that the compounds of the present invention are highly active preemergent and/or postemergent herbicides and/or plant growth regulants. Many of them have utility for broad-spectrum pre- and/or postemergence weed control in areas where complete control of all vegetation is desired such as around fuel storage tanks, industrial storage areas, parking lots, drive-in theaters, air fields, river banks, irrigation and other waterways, around billboards and highway and railroad structures. Many of the compounds of this invention, by virtue of selective metabolism in crops versus weeds, or by selective activity at the locus of physiological inhibition in crops and weeds, or by selective placement on or within the environment of a mixture of crops and weeds, are useful for the selective control of grass and broadleaf weeds within a crop/weed mixture. One skilled in the art will recognize that the preferred combination of these selectivity factors within a compound or group of compounds can readily be determined by performing routine biological and/or biochemical assays. Compounds of this invention may show tolerance to important agronomic crops including, but is not limited to, alfalfa, barley, cotton, wheat, rape, sugar beets, corn (maize), sorghum, soybeans, rice, oats, peanuts, vegetables, tomato, potato, perennial plantation crops including coffee, cocoa, oil palm, rubber, sugarcane, citrus, grapes, fruit trees, nut trees, banana, plantain, pineapple, hops, tea and forests such as eucalyptus and conifers (e.g., loblolly pine), and turf species (e.g., Kentucky bluegrass, St. Augustine grass, Kentucky fescue and Bermuda grass). Compounds of this invention can be used in crops genetically transformed or bred to incorporate resistance to herbicides, express proteins toxic to invertebrate pests (such as Bacillus thuringiensis toxin), and/or express other useful traits. Those skilled in the art will appreciate that not all compounds are equally effective against all weeds. Alternatively, the subject compounds are useful to modify plant growth.

As the compounds of the invention have both preemergent and postemergent herbicidal activity, to control undesired vegetation by killing or injuring the vegetation or reducing its growth, the compounds can be usefully applied by a variety of methods involving contacting a herbicidally effective amount of a compound of the invention, or a composition comprising said compound and at least one of a surfactant, a solid diluent or a liquid diluent, to the foliage or other part of the undesired vegetation or to the environment of the undesired vegetation such as the soil or water in which the undesired vegetation is growing or which surrounds the seed or other propagule of the undesired vegetation.

A herbicidally effective amount of the compounds of this invention is determined by a number of factors. These factors include: formulation selected, method of application, amount and type of vegetation present, growing conditions, etc. In general, a herbicidally effective amount of compounds of this invention is about 0.001 to 20 kg/ha with a preferred range of about 0.004 to 1 kg/ha. One skilled in the art can easily determine the herbicidally effective amount necessary for the desired level of weed control.

Compounds of this invention can also be mixed with one or more other biologically active compounds or agents including herbicides, herbicide safeners, fungicides, insecticides, nematocides, bactericides, acaricides, growth regulators such as insect molting inhibitors and rooting stimulants, chemosterilants, semiochemicals, repellents, attractants, pheromones, feeding stimulants, plant nutrients, other biologically active compounds or entomopathogenic bacteria, virus or fungi to form a multi-component pesticide giving an even broader spectrum of agricultural protection. Mixtures of the compounds of the invention with other herbicides can broaden the spectrum of activity against additional weed species, and suppress the proliferation of any resistant biotypes. Thus the present invention also pertains to a composition comprising a compound of Formula 1 (in a herbicidally effective amount) and at least one additional biologically active compound or agent (in a biologically effective amount) and can further comprise at least one of a surfactant, a solid diluent or a liquid diluent. The other biologically active compounds or agents can be formulated in compositions comprising at least one of a surfactant, solid or liquid diluent. For mixtures of the present invention, one or more other biologically active compounds or agents can be formulated together with a compound of Formula 1, to form a premix, or one or more other biologically active compounds or agents can be formulated separately from the compound of Formula 1, and the formulations combined together before application (e.g., in a spray tank) or, alternatively, applied in succession.

A mixture of one or more of the following herbicides with a compound of this invention may be particularly useful for weed control: acetochlor, acifluorfen and its sodium salt, aclonifen, acrolein (2-propenal), alachlor, alloxydim, ametryn, amicarbazone, amidosulfuron, aminocyclopyrachlor and its esters (e.g., methyl, ethyl) and salts (e.g., sodium, potassium), aminopyralid, amitrole, ammonium sulfamate, anilofos, asulam, atrazine, azimsulfuron, beflubutamid, benazolin, benazolin-ethyl, bencarbazone, benfluralin, benfuresate, bensulfuron-methyl, bensulide, bentazone, benzobicyclon, benzofenap, bicyclopyrone, bifenox, bilanafos, bispyribac and its sodium salt, bromacil, bromobutide, bromofenoxim, bromoxynil, bromoxynil octanoate, butachlor, butafenacil, butamifos, butralin, butroxydim, butylate, cafenstrole, carbetamide, carfentrazone-ethyl, catechin, chlomethoxyfen, chloramben, chlorbromuron, chlorflurenol-methyl, chloridazon, chlorimuron-ethyl, chlorotoluron, chlorpropham, chlorsulfuron, chlorthal-dimethyl, chlorthiamid, cinidon-ethyl, cinmethylin, cinosulfuron, clefoxydim, clethodim, clodinafop-propargyl, clomazone, clomeprop, clopyralid, clopyralid-olamine, cloransulam-methyl, cumyluron, cyanazine, cycloate, cyclosulfamuron, cycloxydim, cyhalofop-butyl, 2,4-D and its butotyl, butyl, isoctyl and isopropyl esters and its dimethylammonium, diolamine and trolamine salts, daimuron, dalapon, dalapon-sodium, dazomet, 2,4-DB and its dimethylammonium, potassium and sodium salts, desmedipham, desmetryn, dicamba and its diglycolammonium, dimethylammonium, potassium and sodium salts, dichlobenil, dichlorprop, diclofop-methyl, diclosulam, difenzoquat metilsulfate, diflufenican, diflufenzopyr, dimefuron, dimepiperate, dimethachlor, dimethametryn, dimethenamid, dimethenamid-P, dimethipin, dimethylarsinic acid and its sodium salt, dinitramine, dinoterb, diphenamid, diquat dibromide, dithiopyr, diuron, DNOC, endothal, EPTC, esprocarb, ethalfluralin, ethametsulfuron-methyl, ethiozin, ethofumesate, ethoxyfen, ethoxysulfuron, etobenzanid, fenoxaprop-ethyl, fenoxaprop-P-ethyl, fenoxasulfone, fentrazamide, fenuron, fenuron-TCA, flamprop-methyl, flamprop-M-isopropyl, flamprop-M-methyl, flazasulfuron, florasulam, fluazifop-butyl, fluazifop-P-butyl, fluazolate, flucarbazone, flucetosulfuron, fluchloralin, flufenacet, flufenpyr, flufenpyr-ethyl, flumetsulam, flumiclorac-pentyl, flumioxazin, fluometuron, fluoroglycofen-ethyl, flupoxam, flupyrsulfuron-methyl and its sodium salt, flurenol, flurenol-butyl, fluridone, fluorochloridone, fluoroxypyr, flurtamone, fluthiacet-methyl, fomesafen, foramsulfuron, fosamine-ammonium, glufosinate, glufosinate-ammonium, glyphosate and its salts such as ammonium, isopropylammonium, potassium, sodium (including sesquisodium) and trimesium (alternatively named sulfosate), halosulfuron-methyl, haloxydine, haloxyfop-etotyl, haloxyfop-methyl, hexazinone, imazamethabenz-methyl, imazamox, imazapic, imazapyr, imazaquin, imazaquin-ammonium, imazethapyr, imazethapyr-ammonium, imazosulfuron, indanofan, indaziflam, iofensulfuron, iodosulfuron-methyl, ioxynil, ioxynil octanoate, ioxynil-sodium, ipfencarbazone, isoproturon, isouron, isoxaben, isoxaflutole, isoxachlortole, lactofen, lenacil, linuron, maleic hydrazide, MCPA and its salts (e.g., MCPA-dimethylammonium, MCPA-potassium and MCPA-sodium, esters (e.g., MCPA-2-ethylhexyl, MCPA-butotyl) and thioesters (e.g., MCPA-thioethyl), MCPB and its salts (e.g., MCPB-sodium) and esters (e.g., MCPB-ethyl), mecoprop, mecoprop-P, mefenacet, mefluidide, mesosulfuron-methyl, mesotrione, metam-sodium, metamifop, metamitron, metazachlor, metazosulfuron, methabenzthiazuron, methiozolin, methylarsonic acid and its calcium, monoammonium, monosodium and disodium salts, methyldymron, metobenzuron, metobromuron, metolachlor, S-metolachlor, metosulam, metoxuron, metribuzin, metsulfuron-methyl, molinate, monolinuron, naproanilide, napropamide, naptalam, neburon, nicosulfuron, norflurazon, orbencarb, orthosulfamuron, oryzalin, oxadiargyl, oxadiazon, oxasulfuron, oxaziclomefone, oxyfluorfen, paraquat dichloride, pebulate, pelargonic acid, pendimethalin, penoxsulam, pentanochlor, pentoxazone, perfluidone, pethoxamid, pethoxyamid, phenmedipham, picloram, picloram-potassium, picolinafen, pinoxaden, piperophos, pretilachlor, primisulfuron-methyl, prodiamine, profoxydim, prometon, prometryn, propachlor, propanil, propaquizafop, propazine, propham, propisochlor, propoxycarbazone, propyzamide, prosulfocarb, prosulfuron, pyrachlor, pyraclonil, pyraflufen-ethyl, pyrasulfotole, pyrazogyl, pyrazolynate, pyrazoxyfen, pyrazosulfuron-ethyl, pyribenzoxim, pyributicarb, pyridate, pyriftalid, pyriminobac-methyl, pyrimisulfan, pyrithiobac, pyrithiobac-sodium, pyroxasulfone, pyroxsulam, quinclorac, quinmerac, quinoclamine, quizalofop-ethyl, quizalofop-P-ethyl, quizalofop-P-tefuryl, rimsulfuron, saflufenacil, sethoxydim, siduron, simazine, simetryn, sulcotrione, sulfentrazone, sulfometuron-methyl, sulfosulfuron, 2,3,6-TBA, TCA, TCA-sodium, tebutam, tebuthiuron, tefuryltrione, tembotrione, tepraloxydim, terbacil, terbumeton, terbuthylazine, terbutryn, thenylchlor, thiazopyr, thiencarbazone, thifensulfuron-methyl, thiobencarb, tiocarbazil, topramezone, tralkoxydim, tri-allate, triafamone, triasulfuron, triaziflam, tribenuron-methyl, triclopyr, triclopyr-butotyl, triclopyr-triethylammonium, tridiphane, trietazine, trifloxysulfuron, trifluralin, triflusulfuron-methyl, tritosulfuron and vernolate. Other herbicides also include bioherbicides such as Alternaria destruens Simmons, Colletotrichum gloeosporiodes (Penz.) Penz. & Sacc., Drechsiera monoceras (MTB-951), Myrothecium verrucaria (Albertini & Schweinitz) Ditmar: Fries, Phytophthora palmivora (Butyl.) Butyl. and Puccinia thlaspeos Schub.

Compounds of this invention can also be used in combination with plant growth regulators such as aviglycine, N-(phenylmethyl)-1H-purin-6-amine, epocholeone, gibberellic acid, gibberellin A₄ and A₇, harpin protein, mepiquat chloride, prohexadione calcium, prohydrojasmon, sodium nitrophenolate and trinexapac-methyl, and plant growth modifying organisms such as Bacillus cereus strain BP01.

General references for agricultural protectants (i.e. herbicides, herbicide safeners, insecticides, fungicides, nematocides, acaricides and biological agents) include The Pesticide Manual, 13th Edition, C. D. S. Tomlin, Ed., British Crop Protection Council, Farnham, Surrey, U.K., 2003 and The BioPesticide Manual, 2nd Edition, L. G. Copping, Ed., British Crop Protection Council, Farnham, Surrey, U.K., 2001.

For embodiments where one or more of these various mixing partners are used, the weight ratio of these various mixing partners (in total) to the compound of Formula 1 is typically between about 1:3000 and about 3000:1. Of note are weight ratios between about 1:300 and about 300:1 (for example ratios between about 1:30 and about 30:1). One skilled in the art can easily determine through simple experimentation the biologically effective amounts of active ingredients necessary for the desired spectrum of biological activity. It will be evident that including these additional components may expand the spectrum of weeds controlled beyond the spectrum controlled by the compound of Formula 1 alone.

In certain instances, combinations of a compound of this invention with other biologically active (particularly herbicidal) compounds or agents (i.e. active ingredients) can result in a greater-than-additive (i.e. synergistic) effect on weeds and/or a less-than-additive effect (i.e. safening) on crops or other desirable plants. Reducing the quantity of active ingredients released in the environment while ensuring effective pest control is always desirable. Ability to use greater amounts of active ingredients to provide more effective weed control without excessive crop injury is also desirable. When synergism of herbicidal active ingredients occurs on weeds at application rates giving agronomically satisfactory levels of weed control, such combinations can be advantageous for reducing crop production cost and decreasing environmental load. When safening of herbicidal active ingredients occurs on crops, such combinations can be advantageous for increasing crop protection by reducing weed competition.

Of note is a combination of a compound of the invention with at least one other herbicidal active ingredient. Of particular note is such a combination where the other herbicidal active ingredient has different site of action from the compound of the invention. In certain instances, a combination with at least one other herbicidal active ingredient having a similar spectrum of control but a different site of action will be particularly advantageous for resistance management. Thus, a composition of the present invention can further comprise (in a herbicidally effective amount) at least one additional herbicidal active ingredient having a similar spectrum of control but a different site of action.

Compounds of this invention can also be used in combination with herbicide safeners such as allidochlor, benoxacor, BCS (1-bromo-4-[(chloromethyl)sulfonyl]benzene), cloquintocet-mexyl, cyometrinil, cyprosulfonamide, dichlormid, 4-(dichloroacetyl)-1-oxa-4-azospiro[4.5]decane (MON 4660), 2-(dichloromethyl)-2-methyl-1,3-dioxolane (MG 191), dicyclonon, dietholate, fenchlorazole-ethyl, fenclorim, flurazole, fluxofenim, furilazole, 2-hydroxy-N,N-dimethyl-6-(trifluoromethyl)pyridine-3-carboxamide, isoxadifen-ethyl, mefenpyr-diethyl, mephenate, methoxyphenone ((4-methoxy-3-methylphenyl)(3-methyl-phenyl)methanone), naphthalic anhydride (1,8-naphthalic anhydride) and oxabetrinil to increase safety to certain crops. Antidotally effective amounts of the herbicide safeners can be applied at the same time as the compounds of this invention, or applied as seed treatments. Therefore an aspect of the present invention relates to a herbicidal mixture comprising a compound of this invention and an antidotally effective amount of a herbicide safener. Seed treatment is particularly useful for selective weed control, because it physically restricts antidoting to the crop plants. Therefore a particularly useful embodiment of the present invention is a method for selectively controlling the growth of undesired vegetation in a crop comprising contacting the locus of the crop with a herbicidally effective amount of a compound of this invention wherein seed from which the crop is grown is treated with an antidotally effective amount of safener. Antidotally effective amounts of safeners can be easily determined by one skilled in the art through simple experimentation.

Of note is a composition comprising a compound of the invention (in a herbicidally effective amount), at least one additional active ingredient selected from the group consisting of other herbicides and herbicide safeners (in an effective amount), and at least one component selected from the group consisting of surfactants, solid diluents and liquid diluents.

Preferred for better control of undesired vegetation (e.g., lower use rate such as from synergism, broader spectrum of weeds controlled, or enhanced crop safety) or for preventing the development of resistant weeds are mixtures of a compound of this invention with another herbicide. Table A1 lists specific combinations of a Component (a) with Component (b) illustrative of the mixtures, compositions and methods of the present invention. Compound 1 in the Component (a) column is identified in Index Table A. The second column of Table A1 lists the specific Component (b) compound (e.g., “2,4-D” in the first line). The third, fourth and fifth columns of Table A1 lists ranges of weight ratios for rates at which the Component (a) compound is typically applied to a field-grown crop relative to Component (b) (i.e. (a):(b)). Thus, for example, the first line of Table A1 specifically discloses the combination of Component (a) (i.e. Compound 1 in Index Table A) with 2,4-D is typically applied in a weight ratio between 1:192 to 6:1. The remaining lines of Table A1 are to be construed similarly.

TABLE A1

| | | Typical | | More Typical | | Most Typical | |
|---|---|---|---|---|---|---|---|
| Component (a) | Component (b) | Weight Ratio | | Weight Ratio | | Weight Ratio | |
| Compound 1 | 2,4-D | 1:192 to | 6:1 | 1:64 to | 2:1 | 1:24 to | 1:3 |
| Compound 1 | 4-amino-3-chloro-6-(4-chloro- | 1:20 to | 56:1 | 1:6 to | 19:1 | 1:2 to | 4:1 |
| | 2-fluoro-3-methoxyphenyl)- | | | | | | |
| | 2-pyridinecarboxylic acid | | | | | | |
| Compound 1 | 4-amino-3-chloro-6-(4-chloro- | 1:20 to | 56:1 | 1:6 to | 19:1 | 1:2 to | 4:1 |
| | 2-fluoro-3-methoxyphenyl)-2- | | | | | | |
| | pyridinecarboxylic acid methyl | | | | | | |
| | ester | | | | | | |
| Compound 1 | Acetochlor | 1:768 to | 2:1 | 1:256 to | 1:2 | 1:96 to | 1:11 |
| Compound 1 | Acifluorfen | 1:96 to | 12:1 | 1:32 to | 4:1 | 1:12 to | 1:2 |
| Compound 1 | Aclonifen | 1:857 to | 2:1 | 1:285 to | 1:3 | 1:107 to | 1:12 |
| Compound 1 | Alachlor | 1:768 to | 2:1 | 1:256 to | 1:2 | 1:96 to | 1:11 |
| Compound 1 | Ametryn | 1:384 to | 3:1 | 1:128 to | 1:1 | 1:48 to | 1:6 |
| Compound 1 | Amicarbazone | 1:192 to | 6:1 | 1:64 to | 2:1 | 1:24 to | 1:3 |
| Compound 1 | Amidosulfuron | 1:6 to | 168:1 | 1:2 to | 56:1 | 1:1 to | 11:1 |
| Compound 1 | Aminocyclopyrachlor | 1:48 to | 24:1 | 1:16 to | 8:1 | 1:6 to | 2:1 |
| Compound 1 | Aminopyralid | 1:20 to | 56:1 | 1:6 to | 19:1 | 1:2 to | 4:1 |
| Compound 1 | Amitrole | 1:768 to | 2:1 | 1:256 to | 1:2 | 1:96 to | 1:11 |
| Compound 1 | Anilofos | 1:96 to | 12:1 | 1:32 to | 4:1 | 1:12 to | 1:2 |
| Compound 1 | Asulam | 1:960 to | 2:1 | 1:320 to | 1:3 | 1:120 to | 1:14 |
| Compound 1 | Atrazine | 1:192 to | 6:1 | 1:64 to | 2:1 | 1:24 to | 1:3 |
| Compound 1 | Azimsulfuron | 1:6 to | 168:1 | 1:2 to | 56:1 | 1:1 to | 11:1 |
| Compound 1 | Beflubutamid | 1:342 to | 4:1 | 1:114 to | 2:1 | 1:42 to | 1:5 |
| Compound 1 | Benfuresate | 1:617 to | 2:1 | 1:205 to | 1:2 | 1:77 to | 1:9 |
| Compound 1 | Bensulfuron-methyl | 1:25 to | 45:1 | 1:8 to | 15:1 | 1:3 to | 3:1 |
| Compound 1 | Bentazone | 1:192 to | 6:1 | 1:64 to | 2:1 | 1:24 to | 1:3 |
| Compound 1 | Benzobicyclon | 1:85 to | 14:1 | 1:28 to | 5:1 | 1:10 to | 1:2 |
| Compound 1 | Benzofenap | 1:257 to | 5:1 | 1:85 to | 2:1 | 1:32 to | 1:4 |
| Compound 1 | Bicyclopyrone | 1:42 to | 27:1 | 1:14 to | 9:1 | 1:5 to | 2:1 |
| Compound 1 | Bifenox | 1:257 to | 5:1 | 1:85 to | 2:1 | 1:32 to | 1:4 |
| Compound 1 | Bispyribac-sodium | 1:10 to | 112:1 | 1:3 to | 38:1 | 1:1 to | 7:1 |
| Compound 1 | Bromacil | 1:384 to | 3:1 | 1:128 to | 1:1 | 1:48 to | 1:6 |
| Compound 1 | Bromobutide | 1:384 to | 3:1 | 1:128 to | 1:1 | 1:48 to | 1:6 |
| Compound 1 | Bromoxynil | 1:96 to | 12:1 | 1:32 to | 4:1 | 1:12 to | 1:2 |
| Compound 1 | Butachlor | 1:768 to | 2:1 | 1:256 to | 1:2 | 1:96 to | 1:11 |
| Compound 1 | Butafenacil | 1:42 to | 27:1 | 1:14 to | 9:1 | 1:5 to | 2:1 |
| Compound 1 | Butylate | 1:1542 to | 1:2 | 1:514 to | 1:51:1 | 92 to | 1:22 |
| Compound 1 | Carfenstrole | 1:192 to | 6:1 | 1:64 to | 2:1 | 1:24 to | 1:3 |
| Compound 1 | Carfentrazone-ethyl | 1:128 to | 9:1 | 1:42 to | 3:1 | 1:16 to | 1:2 |
| Compound 1 | Chlorimuron-ethyl | 1:8 to | 135:1 | 1:2 to | 45:1 | 1:1 to | 9:1 |
| Compound 1 | Chlorotoluron | 1:768 to | 2:1 | 1:256 to | 1:2 | 1:96 to | 1:11 |
| Compound 1 | Chlorsulfuron | 1:6 to | 168:1 | 1:2 to | 56:1 | 1:1 to | 11:1 |
| Compound 1 | Cincosulfuron | 1:17 to | 68:1 | 1:5 to | 23:1 | 1:2 to | 5:1 |
| Compound 1 | Cinidon-ethyl | 1:384 to | 3:1 | 1:128 to | 1:1 | 1:48 to | 1:6 |
| Compound 1 | Cinmethylin | 1:34 to | 34:1 | 1:11 to | 12:1 | 1:4 to | 3:1 |
| Compound 1 | Clethodim | 1:48 to | 24:1 | 1:16 to | 8:1 | 1:6 to | 2:1 |
| Compound 1 | Clodinafop-propargyl | 1:20 to | 56:1 | 1:6 to | 19:1 | 1:2 to | 4:1 |
| Compound 1 | Clomazone | 1:384 to | 3:1 | 1:128 to | 1:1 | 1:48 to | 1:6 |
| Compound 1 | Clomeprop | 1:171 to | 7:1 | 1:57 to | 3:1 | 1:21 to | 1:3 |
| Compound 1 | Clopyralid | 1:192 to | 6:1 | 1:64 to | 2:1 | 1:24 to | 1:3 |
| Compound 1 | Cloransulam-methyl | 1:12 to | 96:1 | 1:4 to | 32:1 | 1:1 to | 6:1 |
| Compound 1 | Cumyluron | 1:384 to | 3:1 | 1:128 to | 1:1 | 1:48 to | 1:6 |
| Compound 1 | Cyanazine | 1:384 to | 3:1 | 1:128 to | 1:1 | 1:48 to | 1:6 |
| Compound 1 | Cyclosulfamuron | 1:17 to | 68:1 | 1:5 to | 23:1 | 1:2 to | 5:1 |
| Compound 1 | Cycloxydim | 1:96 to | 12:1 | 1:32 to | 4:1 | 1:12 to | 1:2 |
| Compound 1 | Cyhalofop | 1:25 to | 45:1 | 1:8 to | 15:1 | 1:3 to | 3:1 |
| Compound 1 | Daimuron | 1:192 to | 6:1 | 1:64 to | 2:1 | 1:24 to | 1:3 |
| Compound 1 | Desmedipham | 1:322 to | 4:1 | 1:107 to | 2:1 | 1:40 to | 1:5 |
| Compound 1 | Dicamba | 1:192 to | 6:1 | 1:64 to | 2:1 | 1:24 to | 1:3 |
| Compound 1 | Dichlobenil | 1:1371 to | 1:2 | 1:457 to | 1:4 | 1:171 to | 1:20 |
| Compound 1 | Dichlorprop | 1:925 to | 2:1 | 1:308 to | 1:3 | 1:115 to | 1:13 |
| Compound 1 | Diclofop-methyl | 1:384 to | 3:1 | 1:128 to | 1:1 | 1:48 to | 1:6 |
| Compound 1 | Diclosulam | 1:10 to | 112:1 | 1:3 to | 38:1 | 1:1 to | 7:1 |
| Compound 1 | Difenzoquat | 1:288 to | 4:1 | 1:96 to | 2:1 | 1:36 to | 1:4 |
| Compound 1 | Diflufenican | 1:857 to | 2:1 | 1:285 to | 1:3 | 1:107 to | 1:12 |
| Compound 1 | Diflufenzopyr | 1:12 to | 96:1 | 1:4 to | 32:1 | 1:1 to | 6:1 |
| Compound 1 | Dimethachlor | 1:768 to | 2:1 | 1:256 to | 1:2 | 1:96 to | 1:11 |
| Compound 1 | Dimethametryn | 1:192 to | 6:1 | 1:64 to | 2:1 | 1:24 to | 1:3 |
| Compound 1 | Dimethenamid-P | 1:384 to | 3:1 | 1:128 to | 1:1 | 1:48 to | 1:6 |
| Compound 1 | Dithiopyr | 1:192 to | 6:1 | 1:64 to | 2:1 | 1:24 to | 1:3 |
| Compound 1 | Diuron | 1:384 to | 3:1 | 1:128 to | 1:1 | 1:48 to | 1:6 |
| Compound 1 | EPTC | 1:768 to | 2:1 | 1:256 to | 1:2 | 1:96 to | 1:11 |
| Compound 1 | Esprocarb | 1:1371 to | 1:2 | 1:457 to | 1:4 | 1:171 to | 1:20 |
| Compound 1 | Ethalfluralin | 1:384 to | 3:1 | 1:128 to | 1:1 | 1:48 to | 1:6 |
| Compound 1 | Ethametsulfuron-methyl | 1:17 to | 68:1 | 1:5 to | 23:1 | 1:2 to | 5:1 |
| Compound 1 | Ethoxyfen | 1:8 to | 135:1 | 1:2 to | 45:1 | 1:1 to | 9:1 |
| Compound 1 | Ethoxysulfuron | 1:20 to | 56:1 | 1:6 to | 19:1 | 1:2 to | 4:1 |
| Compound 1 | Etobenzanid | 1:257 to | 5:1 | 1:85 to | 2:1 | 1:32 to | 1:4 |
| Compound 1 | Fenoxaprop-ethyl | 1:120 to | 10:1 | 1:40 to | 4:1 | 1:15 to | 1:2 |
| Compound 1 | Fenoxasulfone | 1:85 to | 14:1 | 1:28 to | 5:1 | 1:10 to | 1:2 |
| Compound 1 | Fentrazamide | 1:17 to | 68:1 | 1:5 to | 23:1 | 1:2 to | 5:1 |
| Compound 1 | Flazasulfuron | 1:17 to | 68:1 | 1:5 to | 23:1 | 1:2 to | 5:1 |
| Compound 1 | Florasulam | 1:2 to | 420:1 | 1:1 to | 140:1 | 2:1 to | 27:1 |
| Compound 1 | Fluazifop-butyl | 1:192 to | 6:1 | 1:64 to | 2:1 | 1:24 to | 1:3 |
| Compound 1 | Flucarbazone | 1:8 to | 135:1 | 1:2 to | 45:1 | 1:1 to | 9:1 |
| Compound 1 | Flucetosulfuron | 1:8 to | 135:1 | 1:2 to | 45:1 | 1:1 to | 9:1 |
| Compound 1 | Flufenacet | 1:257 to | 5:1 | 1:85 to | 2:1 | 1:32 to | 1:4 |
| Compound 1 | Flumetsulam | 1:24 to | 48:1 | 1:8 to | 16:1 | 1:3 to | 3:1 |
| Compound 1 | Flumiclorac-pentyl | 1:10 to | 112:1 | 1:3 to | 38:1 | 1:1 to | 7:1 |
| Compound 1 | Flumioxazin | 1:25 to | 45:1 | 1:8 to | 15:1 | 1:3 to | 3:1 |
| Compound 1 | Fluometuron | 1:384 to | 3:1 | 1:128 to | 1:1 | 1:48 to | 1:6 |
| Compound 1 | Flupyrsulfuron-methyl | 1:3 to | 336:1 | 1:1 to | 112:1 | 2:1 to | 21:1 |
| Compound 1 | Fluridone | 1:384 to | 3:1 | 1:128 to | 1:1 | 1:48 to | 1:6 |
| Compound 1 | Fluroxypyr | 1:96 to | 12:1 | 1:32 to | 4:1 | 1:12 to | 1:2 |
| Compound 1 | Flurtamone | 1:857 to | 2:1 | 1:285 to | 1:3 | 1:107 to | 1:12 |
| Compound 1 | Fluthiacet-methyl | 1:48 to | 42:1 | 1:16 to | 14:1 | 1:3 to | 3:1 |
| Compound 1 | Fomesafen | 1:96 to | 12:1 | 1:32 to | 4:1 | 1:12 to | 1:2 |
| Compound 1 | Foramsulfuron | 1:13 to | 84:1 | 1:4 to | 28:1 | 1:1 to | 6:1 |
| Compound 1 | Glufosinate | 1:288 to | 4:1 | 1:96 to | 2:1 | 1:36 to | 1:4 |
| Compound 1 | Glyphosate | 1:288 to | 4:1 | 1:96 to | 2:1 | 1:36 to | 1:4 |
| Compound 1 | Halosulfuron-methyl | 1:17 to | 68:1 | 1:5 to | 23:1 | 1:2 to | 5:1 |
| Compound 1 | Haloxyfop-methyl | 1:34 to | 34:1 | 1:11 to | 12:1 | 1:4 to | 3:1 |
| Compound 1 | Hexazinone | 1:192 to | 6:1 | 1:64 to | 2:1 | 1:24 to | 1:3 |
| Compound 1 | Imazamox | 1:13 to | 84:1 | 1:4 to | 28:1 | 1:1 to | 6:1 |
| Compound 1 | Imazapic | 1:20 to | 56:1 | 1:6 to | 19:1 | 1:2 to | 4:1 |
| Compound 1 | Imazapyr | 1:85 to | 14:1 | 1:28 to | 5:1 | 1:10 to | 1:2 |
| Compound 1 | Imazaquin | 1:34 to | 34:1 | 1:11 to | 12:1 | 1:4 to | 3:1 |
| Compound 1 | Imazethabenz-methyl | 1:171 to | 7:1 | 1:57 to | 3:1 | 1:21 to | 1:3 |
| Compound 1 | Imazethapyr | 1:24 to | 48:1 | 1:8 to | 16:1 | 1:3 to | 3:1 |
| Compound 1 | Imazosulfuron | 1:27 to | 42:1 | 1:9 to | 14:1 | 1:3 to | 3:1 |
| Compound 1 | Indanofan | 1:342 to | 4:1 | 1:114 to | 2:1 | 1:42 to | 1:5 |
| Compound 1 | Indaziflam | 1:25 to | 45:1 | 1:8 to | 15:1 | 1:3 to | 3:1 |
| Compound 1 | Iodosulfuron-methyl | 1:3 to | 336:1 | 1:1 to | 112:1 | 2:1 to | 21:1 |
| Compound 1 | Ioxynil | 1:192 to | 6:1 | 1:64 to | 2:1 | 1:24 to | 1:3 |
| Compound 1 | Ipfencarbazone | 1:85 to | 14:1 | 1:28 to | 5:1 | 1:10 to | 1:2 |
| Compound 1 | Isoproturon | 1:384 to | 3:1 | 1:128 to | 1:1 | 1:48 to | 1:6 |
| Compound 1 | Isoxaben | 1:288 to | 4:1 | 1:96 to | 2:1 | 1:36 to | 1:4 |
| Compound 1 | Isoxaflutole | 1:60 to | 20:1 | 1:20 to | 7:1 | 1:7 to | 2:1 |
| Compound 1 | lactofen | 1:42 to | 27:1 | 1:14 to | 9:1 | 1:5 to | 2:1 |
| Compound 1 | Lenacil | 1:384 to | 3:1 | 1:128 to | 1:1 | 1:48 to | 1:6 |
| Compound 1 | Linuron | 1:384 to | 3:1 | 1:128 to | 1:1 | 1:48 to | 1:6 |
| Compound 1 | MCPA | 1:192 to | 6:1 | 1:64 to | 2:1 | 1:24 to | 1:3 |
| Compound 1 | MCPB | 1:288 to | 4:1 | 1:96 to | 2:1 | 1:36 to | 1:4 |
| Compound 1 | Mecoprop | 1:768 to | 2:1 | 1:256 to | 1:2 | 1:96 to | 1:11 |
| Compound 1 | Mefenacet | 1:384 to | 3:1 | 1:128 to | 1:1 | 1:48 to | 1:6 |
| Compound 1 | Mefluidide | 1:192 to | 6:1 | 1:64 to | 2:1 | 1:24 to | 1:3 |
| Compound 1 | Mesosulfuron-methyl | 1:5 to | 224:1 | 1:1 to | 75:1 | 1:1 to | 14:1 |
| Compound 1 | Mesotrione | 1:42 to | 27:1 | 1:14 to | 9:1 | 1:5 to | 2:1 |
| Compound 1 | Metamifop | 1:42 to | 27:1 | 1:14 to | 9:1 | 1:5 to | 2:1 |
| Compound 1 | Metazachlor | 1:384 to | 3:1 | 1:128 to | 1:1 | 1:48 to | 1:6 |
| Compound 1 | Metazosulfuron | 1:25 to | 45:1 | 1:8 to | 15:1 | 1:3 to | 3:1 |
| Compound 1 | Methabenzthiazuron | 1:768 to | 2:1 | 1:256 to | 1:2 | 1:96 to | 1:11 |
| Compound 1 | Metolachlor | 1:768 to | 2:1 | 1:256 to | 1:2 | 1:96 to | 1:11 |
| Compound 1 | Metosulam | 1:8 to | 135:1 | 1:2 to | 45:1 | 1:1 to | 9:1 |
| Compound 1 | Metribuzin | 1:192 to | 6:1 | 1:64 to | 2:1 | 1:24 to | 1:3 |
| Compound 1 | Metasulfuron-methyl | 1:2 to | 560:1 | 1:1 to | 187:1 | 3:1 to | 35:1 |
| Compound 1 | Molinate | 1:1028 to | 2:1 | 1:342 to | 1:3 | 1:128 to | 1:15 |
| Compound 1 | Napropamide | 1:384 to | 3:1 | 1:128 to | 1:1 | 1:48 to | 1:6 |
| Compound 1 | Naptalam | 1:192 to | 6:1 | 1:64 to | 2:1 | 1:24 to | 1:3 |
| Compound 1 | Nicosulfuron | 1:12 to | 96:1 | 1:4 to | 32:1 | 1:1 to | 6:1 |
| Compound 1 | Norflurazon | 1:1152 to | 1:1 | 1:384 to | 1:3 | 1:144 to | 1:16 |
| Compound 1 | Orbencarb | 1:1371 to | 1:2 | 1:457 to | 1:4 | 1:171 to | 1:20 |
| Compound 1 | Orthosulfamuron | 1:20 to | 56:1 | 1:6 to | 19:1 | 1:2 to | 4:1 |
| Compound 1 | Oryzalin | 1:514 to | 3:1 | 1:171 to | 1:2 | 1:64 to | 1:8 |
| Compound 1 | Oxadiargyl | 1:384 to | 3:1 | 1:128 to | 1:1 | 1:48 to | 1:6 |
| Compound 1 | Oxadiazon | 1:548 to | 3:1 | 1:182 to | 1:2 | 1:68 to | 1:8 |
| Compound 1 | Oxasulfuron | 1:27 to | 42:1 | 1:9 to | 14:1 | 1:3 to | 3:1 |
| Compound 1 | Oxaziclomefone | 1:42 to | 27:1 | 1:14 to | 9:1 | 1:5 to | 2:1 |
| Compound 1 | Oxyfluorfen | 1:384 to | 3:1 | 1:128 to | 1:1 | 1:48 to | 1:6 |
| Compound 1 | Paraquat | 1:192 to | 6:1 | 1:64 to | 2:1 | 1:24 to | 1:3 |
| Compound 1 | Pendimethalin | 1:384 to | 3:1 | 1:128 to | 1:1 | 1:48 to | 1:6 |
| Compound 1 | Penoxsulam | 1:10 to | 112:1 | 1:3 to | 38:1 | 1:1 to | 7:1 |
| Compound 1 | Penthoxamid | 1:384 to | 3:1 | 1:128 to | 1:1 | 1:48 to | 1:6 |
| Compound 1 | Pentoxazone | 1:102 to | 12:1 | 1:34 to | 4:1 | 1:12 to | 1:2 |
| Compound 1 | Phenmedipham | 1:102 to | 12:1 | 1:34 to | 4:1 | 1:12 to | 1:2 |
| Compound 1 | Picloram | 1:96 to | 12:1 | 1:32 to | 4:1 | 1:12 to | 1:2 |
| Compound 1 | Picolinafen | 1:34 to | 34:1 | 1:11 to | 12:1 | 1:4 to | 3:1 |
| Compound 1 | Pinoxaden | 1:25 to | 45:1 | 1:8 to | 15:1 | 1:3 to | 3:1 |
| Compound 1 | Pretilachlor | 1:192 to | 6:1 | 1:64 to | 2:1 | 1:24 to | 1:3 |
| Compound 1 | Primisulfuron-methyl | 1:8 to | 135:1 | 1:2 to | 45:1 | 1:1 to | 9:1 |
| Compound 1 | Prodiamine | 1:384 to | 3:1 | 1:128 to | 1:1 | 1:48 to | 1:6 |
| Compound 1 | Profoxydim | 1:42 to | 27:1 | 1:14 to | 9:1 | 1:5 to | 2:1 |
| Compound 1 | Prometryn | 1:384 to | 3:1 | 1:128 to | 1:1 | 1:48 to | 1:6 |
| Compound 1 | Propachlor | 1:1152 to | 1:1 | 1:384 to | 1:3 | 1:144 to | 1:16 |
| Compound 1 | Propanil | 1:384 to | 3:1 | 1:128 to | 1:1 | 1:48 to | 1:6 |
| Compound 1 | Propaquizafop | 1:48 to | 24:1 | 1:16 to | 8:1 | 1:6 to | 2:1 |
| Compound 1 | Propoxycarbazone | 1:17 to | 68:1 | 1:5 to | 23:1 | 1:2 to | 5:1 |
| Compound 1 | Propyrisulfuron | 1:17 to | 68:1 | 1:5 to | 23:1 | 1:2 to | 5:1 |
| Compound 1 | Propyzamide | 1:384 to | 3:1 | 1:128 to | 1:1 | 1:48 to | 1:6 |
| Compound 1 | Prosulfocarb | 1:1200 to | 1:2 | 1:400 to | 1:41:1 | 50 to | 1:17 |
| Compound 1 | Prosulfuron | 1:6 to | 168:1 | 1:2 to | 56:1 | 1:1 to | 11:1 |
| Compound 1 | Pyraclonil | 1:42 to | 27:1 | 1:14 to | 9:1 | 1:5 to | 2:1 |
| Compound 1 | Pyraflufen-ethyl | 1:5 to | 224:1 | 1:1 to | 75:1 | 1:1 to | 14:1 |
| Compound 1 | Pyrasulfotole | 1:13 to | 84:1 | 1:4 to | 28:1 | 1:1 to | 6:1 |
| Compound 1 | Pyrazolynate | 1:857 to | 2:1 | 1:285 to | 1:3 | 1:107 to | 1:12 |
| Compound 1 | Pyrazosulfuron-ethyl | 1:10 to | 112:1 | 1:3 to | 38:1 | 1:1 to | 7:1 |
| Compound 1 | Pyrazoxyfen | 1:5 to | 224:1 | 1:1 to | 75:1 | 1:1 to | 14:1 |
| Compound 1 | Pyribenzoxim | 1:10 to | 112:1 | 1:3 to | 38:1 | 1:1 to | 7:1 |
| Compound 1 | Pyributicarb | 1:384 to | 3:1 | 1:128 to | 1:1 | 1:48 to | 1:6 |
| Compound 1 | Pyridate | 1:288 to | 4:1 | 1:96 to | 2:1 | 1:36 to | 1:4 |
| Compound 1 | Pyriftalid | 1:10 to | 112:1 | 1:3 to | 38:1 | 11:1 to | 7:1 |
| Compound 1 | Pyriminobac-methyl | 1:20 to | 56:1 | 1:6 to | 19:1 | 1:2 to | 4:1 |
| Compound 1 | Pyrimisulfan | 1:17 to | 68:1 | 1:5 to | 23:1 | 1:2 to | 5:1 |
| Compound 1 | Pyrithiobac | 1:24 to | 48:1 | 1:8 to | 16:1 | 1:3 to | 3:1 |
| Compound 1 | Pyroxasulfone | 1:85 to | 14:1 | 1:28 to | 5:1 | 1:10 to | 1:2 |
| Compound 1 | Pyroxsulam | 1:5 to | 224:1 | 1:1 to | 75:1 | 1:1 to | 14:1 |
| Compound 1 | Quinclorac | 1:192 to | 6:1 | 1:64 to | 2:1 | 1:24 to | 1:3 |
| Compound 1 | Quizalofop-ethyl | 1:42 to | 27:1 | 1:14 to | 9:1 | 1:5 to | 2:1 |
| Compound 1 | Rimsulfuron | 1:13 to | 84:1 | 1:4 to | 28:1 | 1:1 to | 6:1 |
| Compound 1 | Saflufenacil | 1:25 to | 45:1 | 1:8 to | 15:1 | 1:3 to | 3:1 |
| Compound 1 | Sethoxydim | 1:96 to | 12:1 | 1:32 to | 4:1 | 1:12 to | 1:2 |
| Compound 1 | Simazine | 1:384 to | 3:1 | 1:128 to | 1:1 | 1:48 to | 1:6 |
| Compound 1 | Sulcotrione | 1:120 to | 10:1 | 1:40 to | 4:1 | 1:15 to | 1:2 |
| Compound 1 | Sulfentrazone | 1:147 to | 8:1 | 1:49 to | 3:1 | 1:18 to | 1:3 |
| Compound 1 | Sulfometuron-methyl | 1:34 to | 34:1 | 1:11 to | 12:1 | 1:4 to | 3:1 |
| Compound 1 | Sulfosulfuron | 1:8 to | 135:1 | 1:2 to | 45:1 | 1:1 to | 9:1 |
| Compound 1 | Tebuthiuron | 1:384 to | 3:1 | 1:128 to | 1:1 | 1:48 to | 1:6 |
| Compound 1 | Tefuryltrione | 1:42 to | 27:1 | 1:14 to | 9:1 | 1:5 to | 2:1 |
| Compound 1 | Tembotrione | 1:31 to | 37:1 | 1:10 to | 13:1 | 1:3 to | 3:1 |
| Compound 1 | Tepraloxydim | 1:25 to | 45:1 | 1:8 to | 15:1 | 1:3 to | 3:1 |
| Compound 1 | Terbacil | 1:288 to | 4:1 | 1:96 to | 2:1 | 1:36 to | 1:4 |
| Compound 1 | Terbuthylatrazine | 1:857 to | 2:1 | 1:285 to | 1:3 | 1:107 to | 1:12 |
| Compound 1 | Terbutryn | 1:192 to | 6:1 | 1:64 to | 2:1 | 1:24 to | 1:3 |
| Compound 1 | Thenylchlor | 1:85 to | 14:1 | 1:28 to | 5:1 | 1:10 to | 1:2 |
| Compound 1 | Thiazopyr | 1:384 to | 3:1 | 1:128 to | 1:1 | 1:48 to | 1:6 |
| Compound 1 | Thiencarbazone | 1:3 to | 336:1 | 1:1 to | 112:1 | 2:1 to | 21:1 |
| Compound 1 | Thifensulfuron-methyl | 1:5 to | 224:1 | 1:1 to | 75:1 | 1:1 to | 14:1 |
| Compound 1 | Thiobencarb | 1:768 to | 2:1 | 1:256 to | 1:2 | 1:96 to | 1:11 |
| Compound 1 | Topramazone | 1:6 to | 168:1 | 1:2 to | 56:1 | 1:1 to | 11:1 |
| Compound 1 | Tralkoxydim | 1:68 to | 17:1 | 1:22 to | 6:1 | 1:8 to | 2:1 |
| Compound 1 | Triallate | 1:768 to | 2:1 | 1:256 to | 1:2 | 1:96 to | 1:11 |
| Compound 1 | Triasulfuron | 1:5 to | 224:1 | 1:1 to | 75:1 | 1:1 to | 14:1 |
| Compound 1 | Triaziflam | 1:171 to | 7:1 | 1:57 to | 3:1 | 1:21 to | 1:3 |
| Compound 1 | Tribenuron-methyl | 1:3 to | 336:1 | 1:1 to | 112:1 | 2:1 to | 21:1 |
| Compound 1 | Triclopyr | 1:192 to | 6:1 | 1:64 to | 2:1 | 1:24 to | 1:3 |
| Compound 1 | Trifloxysulfuron | 1:2 to | 420:1 | 1:1 to | 140:1 | 2:1 to | 27:1 |
| Compound 1 | Trifluralin | 1:288 to | 4:1 | 1:96 to | 2:1 | 1:36 to | 1:4 |
| Compound 1 | Triflusulfuron-methyl | 1:17 to | 68:1 | 1:5 to | 23:1 | 1:2 to | 5:1 |
| Compound 1 | Tritosulfuron | 1:13 to | 84:1 | 1:4 to | 28:1 | 1:1 to | 6:1 |

Table A2 is constructed the same as Table A1 above except that entries below the “Component (a)” column heading are replaced with the respective Component (a) Column Entry shown below. Compound 2 in the Component (a) column is identified in Index Table A. Thus, for example, in Table A2 the entries below the “Component (a)” column heading all recite “Compound 2” (i.e. Compound 2 identified in Index Table A), and the first line below the column headings in Table A2 specifically discloses a mixture of Compound 2 with 2,4-D. Tables A3 and A4 are constructed similarly.

| | Component (a) |
|---|---|
| Table Number | Column Entries |
| A2 | Compound 2 |
| A3 | Compound 3 |
| A4 | Compound 4 |
| A5 | Compound 5 |
| A6 | Compound 6 |

The following Tests (i.e. Biological Examples of the Invention) demonstrate the control efficacy of the compounds of this invention against specific weeds. The weed control afforded by the compounds is not limited, however, to these species. See Index Tables A for compound descriptions. The following abbreviations are used in the Index Table which follow: c is cyclo. The abbreviation “Ex.” stands for “Example” and is followed by a number indicating in which example the compound is prepared. Mass spectra (MS) are reported as the molecular weight of the highest isotopic abundance parent ion (M+1) formed by addition of H⁺ (molecular weight of 1) to the molecule, observed by mass spectrometry using atmospheric pressure chemical ionization (AP⁺).

INDEX TABLE A

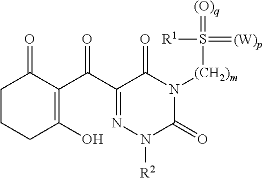

| Com- | | | | | | | |
|---|---|---|---|---|---|---|---|
| pound | m | p | q | W | R¹ | R² | MS (AP⁺) |
| 1 | 2 | 1 | 1 | N—CN | CH₃ | CH₃ | 396 |
| 2 | 2 | 1 | 0 | N—CN | CH₃ | CH3 | 380 |
| 3 (Ex. 2) | 2 | 1 | 1 | O | CH₂c-Pr | CH₃ | ** 412 |
| 4 (Ex. 1) | 2 | 0 | 0 | — | CH₂c-Pr | CH₃ | ** 380 |
| 5 | 2 | 0 | 0 | — | CH₂CH═CH₂ | CH₃ | 366 |
| 6 | 2 | 0 | 0 | — | CH₂CH₂OCH₃ | CH₃ | 384 |

** See synthesis Example for ¹H NMR data.

### BIOLOGICAL EXAMPLES OF THE INVENTION

### Test A

Seeds of plant species selected from barnyardgrass (Echinochloa crus-galli), large (Lg) crabgrass (Digitaria sanguinalis), giant foxtail (Setaria faberii), morningglory (Ipomoea spp.), pigweed (redroot pigweed, Amaranthus retroflexus), velvetleaf (Abutilon theophrasti), winter wheat (Triticum aestivum), and corn (Zea mays) were planted into a blend of loam soil and sand and treated preemergence with a directed soil spray using test chemicals formulated in a non-phytotoxic solvent mixture which included a surfactant. At the same time these species were also treated with postemergence applications of test compounds formulated in the same manner. Plants ranged in height from 2 to 10 cm and were in the one- to two-leaf stage for the postemergence treatment.

Treated plants and untreated controls were maintained in a greenhouse for approximately 10 days, after which time all treated plants were visually compared to untreated controls and visually evaluated for injury. Plant response ratings, summarized in Table A, are based on a 0 to 100 scale where 0 is no effect and 100 is complete control. A dash (-) response means no test result.

TABLE A

Compounds

| | | | |
|---|---|---|---|
| 1 | 2 | 3 | 4 |

125 g ai/ha Postemergence

| | | | | |
|---|---|---|---|---|
| Barnyardgrass | 0 | 10 | 90 | 10 |
| Corn | 0 | 0 | 0 | 0 |
| Crabgrass, Large | 0 | 10 | 90 | 10 |
| Foxtail, Giant | 0 | 20 | 40 | 0 |
| Morningglory | 0 | 30 | 60 | 100 |
| Pigweed | 20 | 80 | 100 | 50 |
| Velvetleaf | 0 | 100 | 100 | 90 |
| Wheat | 0 | 0 | 30 | 10 |

125 g ai/ha Preemergence

| | | | | |
|---|---|---|---|---|
| Barnyardgrass | 0 | 0 | 40 | 0 |
| Corn | 0 | 0 | 0 | 0 |
| Crabgrass, Large | 0 | 0 | 40 | 0 |
| Foxtail, Giant | 0 | 0 | 0 | 0 |
| Morningglory | 0 | 0 | 10 | 0 |
| Pigweed | 0 | 0 | 100 | 0 |
| Velvetleaf | 0 | 50 | 30 | 0 |
| Wheat | 0 | 0 | 10 | 0 |

31 g ai/ha Postemergence

| | | | | |
|---|---|---|---|---|
| Barnyardgrass | 0 | 0 | 20 | 0 |
| Corn | 0 | 0 | 0 | 0 |
| Crabgrass, Large | 0 | 0 | 30 | 0 |
| Foxtail, Giant | 0 | 0 | 0 | 0 |
| Morningglory | 0 | 10 | 60 | 10 |
| Pigweed | 0 | 60 | 40 | 10 |
| Velvetleaf | 0 | 80 | 100 | 70 |
| Wheat | 0 | 0 | 0 | 0 |

31 g ai/ha Preemergence

| | | | | |
|---|---|---|---|---|
| Barnyardgrass | 0 | 0 | 0 | 0 |
| Corn | 0 | 0 | 0 | 0 |
| Crabgrass, Large | 0 | 0 | 10 | 0 |
| Foxtail, Giant | 0 | 0 | 0 | 0 |
| Morningglory | 0 | 0 | — | 0 |
| Pigweed | 0 | 0 | 20 | 0 |
| Velvetleaf | 0 | 0 | 0 | 0 |
| Wheat | 0 | 0 | 0 | 0 |

### Test B

Plant species in the flooded paddy test selected from rice (Oryza sativa), small-flower umbrella sedge (Cyperus difformis), duck salad (Heteranthera limosa), and barnyardgrass (Echinochloa crus-galli) were grown to the 2-leaf stage for testing. At time of treatment, test pots were flooded to 3 cm above the soil surface, treated by application of test compounds directly to the paddy water, and then maintained at that water depth for the duration of the test.

Treated plants and controls were maintained in a greenhouse for 13 to 15 days, after which time all species were visually compared to controls and visually evaluated. Plant response ratings, summarized in Table B, are based on a scale of 0 to 100 where 0 is no effect and 100 is complete control. A dash (-) response means no test result.

TABLE B

Compounds

| | | | |
|---|---|---|---|
| 1 | 2 | 3 | 4 |

250 g ai/ha Flood

| | | | | |
|---|---|---|---|---|
| Barnyardgrass | 0 | 0 | 20 | 15 |
| Ducksalad | 0 | 40 | 85 | 65 |
| Rice | 0 | 0 | 30 | 60 |
| Sedge, Umbrella | 0 | 55 | 75 | 65 |

62 g ai/ha Flood

| | | | | |
|---|---|---|---|---|
| Barnyardgrass | 0 | 0 | 0 | 0 |
| Ducksalad | 0 | 20 | 0 | 0 |
| Rice | 0 | 0 | 0 | 0 |
| Sedge, Umbrella | 0 | 0 | 0 | 0 |

| Compounds | | |
|---|---|---|
| 2 | 3 | 4 |

125 g ai/ha Flood

| | | | |
|---|---|---|---|
| Barnyardgrass | 0 | 0 | 0 |
| Ducksalad | 30 | 0 | 50 |
| Rice | 0 | 0 | 15 |
| Sedge, Umbrella | 45 | 50 | 50 |

31 g ai/ha Flood

| | | | |
|---|---|---|---|
| Barnyardgrass | 0 | 0 | 0 |
| Ducksalad | 0 | 0 | 0 |
| Rice | 0 | 0 | 0 |
| Sedge, Umbrella | 0 | 0 | 0 |

What is claimed is:

1. A compound selected from Formula 1, N-oxides and salts thereof, 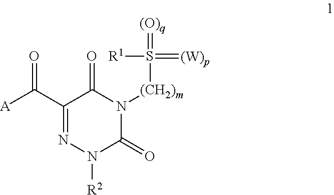
wherein
A is a radical selected from the group consisting of 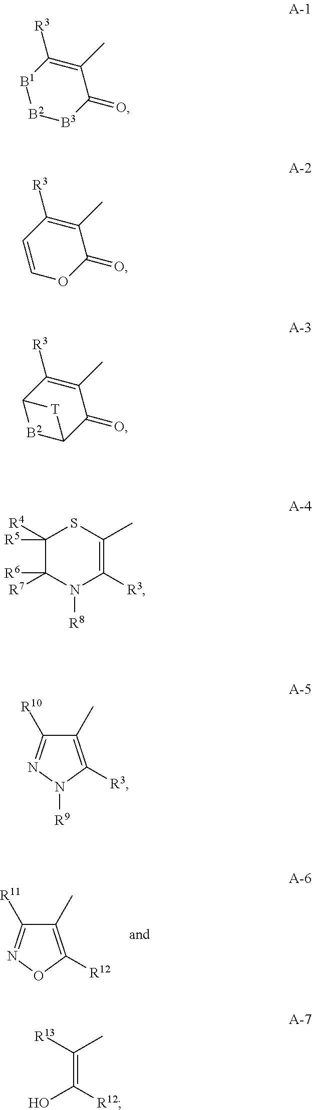
B¹ and B³ are each independently a radical selected from the group consisting of 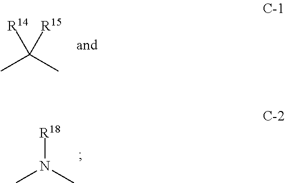
B² is a radical selected from the group consisting of 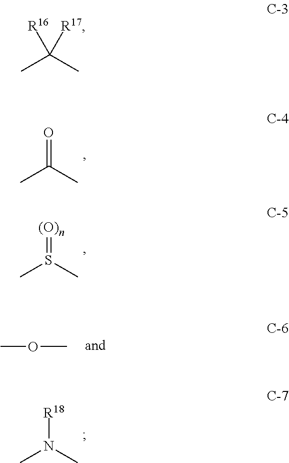
R¹ is C₁-C₆ alkyl, C₃-C₆ alkenyl, C₃-C₆ alkynyl, C₂-C₆ alkoxyalkyl, C₄-C₈ alkoxyalkenyl, C₄-C₈ alkoxyalkynyl, C₃-C₈ alkoxyalkoxyalkyl, C₄-C₁₀ cycloalkylalkyl, C₄-C₁₀ cycloalkoxylalkyl, oxiranyl(C₁-C₃ alkyl), oxetanyl(C₁-C₃ alkyl), tetrahydrofuranyl(C₁-C₃ alkyl) or tetrahydropyranyl(C₁-C₃ alkyl);
m is 1 through 5;
each W is independently O, N—CN, N—NO₂, N—S═O, N—R^{A}, N—OR^{B} or N—N(R^{C})₂;
R^{A} is H, CHO, C₁-C₄ alkyl, C₁-C₄ alkylcarbonyl, C₁-C₄ alkoxycarbonyl;
R^{B} is H or C₁-C₄ alkyl;
each R^{C} is H, CHO, C₁-C₄ alkyl, C₁-C₄ alkylcarbonyl, C₁-C₄ alkoxycarbonyl;
N(R^{C})₂ can be taken together to form K;
K is a ring containing, in addition to the nitrogen atom to which the substituent pair (R^{C})₂ is attached, from 2 to 6 atoms of carbon and optionally an additional atom of nitrogen, sulfur or oxygen, said ring optionally substituted with up to four substituents selected from the group consisting of C₁-C₂ alkyl, halogen, CN, NO₂ and C₁-C₂ alkoxy;
each p and q is independently 0 or 1;
T is C₁-C₆ alkylene or C₂-C₆ alkenylene;
R² is C₁-C₄ alkyl, C₂-C₄ alkenyl, C₁-C₄ cyanoalkyl, C₃-C₅ cycloalkyl, C₁-C₄ alkoxy, C₂-C₄ alkoxyalkyl or C₄-C₈ cycloalkylalkyl;
R³ is H, halogen, cyano, hydroxy, —O⁻M⁺, amino, nitro, —CHO, —C(═O)OH, —C(═O)NH₂, —C(═S)NH₂, —SH, —SO₂NH₂, —SO₂NHCN, —SO₂NHOH, —OCN, —SCN, —SF₅, —NHNH₂, —NHOH, —N═C═O, —N═C═S, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₂-C₆ alkynyloxy, C₃-C₆ haloalkynyloxy, C₂-C₈ alkoxyalkoxy, C₂-C₈ alkylcarbonyloxy, C₂-C₈ haloalkylcarbonyloxy, C₄-C₁₀ cycloalkylcarbonyloxy, C₃-C₁₀ alkylcarbonylalkoxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl, C₃-C₈ cycloalkylsulfonyl, C₁-C₆ alkylsulfonyloxy, C₁-C₆ alkylamino, C₂-C₈ dialkylamino, C₁-C₆ haloalkylamino, C₂-C₈ halodialkylamino, C₃-C₈ cycloalkylamino, C₂-C₈ alkylcarbonylamino, C₂-C₈ haloalkylcarbonylamino, C₁-C₆ alkylsulfonylamino or C₁-C₆ haloalkylsulfonylamino; or benzyloxy, phenyloxy, benzylcarbonyloxy, phenylcarbonyloxy, phenylsulfonyloxy, benzylsulfonyloxy, phenylthio, benzylthio, phenylsulfinyl, benzylsulfinyl, phenylsulfonyl or benzylsulfonyl, each optionally substituted on ring members with up to five substituents selected from R¹⁹;
M⁺ is an alkali metal cation or an ammonium cation;
R⁴, R⁵, R⁶ and R⁷ are each independently H, halogen, hydroxy, C₁-C₆ alkyl, C₂-C₆ alkenyl, C₂-C₆ alkynyl, C₁-C₆ haloalkyl, C₁-C₆ alkoxy, C₁-C₆ haloalkoxy, C₃-C₈ cycloalkoxy or C₃-C₈ halocycloalkoxy; or phenyl or benzyl, each optionally substituted on ring members with up to five substituents selected from R¹⁹;
R⁸ is H, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl or C₃-C₈ halocycloalkyl; or benzyl optionally substituted on ring members with up to five substituents selected from R¹⁹;
R⁹ is H, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₆-C₁₄ cycloalkylcycloalkyl, C₄-C₁₀ halocycloalkylalkyl, C₅-C₁₂ alkylcycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl or C₂-C₈ alkylthioalkyl;
R¹⁰ is H, halogen, C₁-C₆ alkyl, C₂-C₆ alkenyl, C₂-C₆ alkynyl or C₃-C₈ cycloalkyl;
R¹¹ is H, halogen, cyano, hydroxy, amino, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₄-C₁₀ halocycloalkylalkyl, C₅-C₁₂ alkylcycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl, C₂-C₈ alkylthioalkyl, C₂-C₈ alkylsulfinylalkyl or C₂-C₈ alkylsulfonylalkyl; or phenyl optionally substituted with up to five substituents selected from R¹⁹;
R¹² is H, halogen, cyano, hydroxy, amino, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₆-C₁₄ cycloalkylcycloalkyl, C₄-C₁₀ halocycloalkylalkyl, C₅-C₁₂ alkylcycloalkylalkyl, C₃-C₈ cycloalkenyl, C₃-C₈ halocycloalkenyl or C₂-C₈ alkoxycarbonylamino;
R¹³ is H, halogen, cyano, hydroxy, amino, nitro or C₂-C₈ alkoxycarbonyl;
n is 0, 1, or 2;
each R¹⁴, R¹⁵, R¹⁶ and R¹⁷ is independently H, halogen, cyano, hydroxy or C₁-C₆ alkyl; or
a pair of R¹⁴ and R¹⁶ is taken together as C₂-C₆ alkylene or C₂-C₆ alkenylene;
R¹⁸ is H, C₁-C₆ haloalkyl, C₂-C₆ haloalkenyl, C₁-C₆ alkoxy, C₁-C₆ haloalkoxy, C₃-C₈ cycloalkoxy, C₁-C₆ alkyl, C₂-C₆ alkenyl, C₂-C₆ alkynyl or C₃-C₈ cycloalkyl; and
each R¹⁹ is independently halogen, cyano, hydroxy, amino, nitro, —CHO, —C(═O)OH, —C(═O)NH₂, —C(═S)NH₂, —C(═O)NHCN, —C(═O)NHOH, —SH, —SO₂NH₂, —SO₂NHCN, —SO₂NHOH, —OCN, —SCN, —SF₅, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl, C₂-C₈ alkylthioalkyl, C₂-C₈ alkylsulfinylalkyl, C₂-C₈ alkoxyhaloalkyl, C₂-C₅ cyanoalkyl, C₁-C₆ hydroxyalkyl, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₂-C₈ alkoxyalkoxy, C₂-C₈ alkylcarbonyloxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl, C₃-C₈ cycloalkylsulfonyl, C₁-C₆ alkylamino, C₂-C₈ dialkylamino, C₁-C₆ haloalkylamino, C₂-C₈ halodialkylamino or C₃-C₈ cycloalkylamino;
provided when
i) W is O and each p and q is 1;
ii) p is 1 and q is 0; or
iii) each p and q is independently 0
then R¹ is other than C₁-C₆ alkyl.

2. The compound of claim 1 wherein
A is A-1, A-3, A-5 or A-6;
R¹ is C₁-C₆ alkyl, C₃-C₆ alkenyl, C₃-C₆ alkynyl, C₂-C₆ alkoxyalkyl, C₄-C₈ alkoxyalkenyl, C₄-C₈ alkoxyalkynyl, C₃-C₈ alkoxyalkoxyalkyl, C₄-C₁₀ cycloalkylalkyl, C₄-C₁₀ cycloalkoxylalkyl, oxiranyl(C₁-C₃ alkyl), oxetanyl(C₁-C₃ alkyl) or tetrahydrofuranyl(C₁-C₃ alkyl);
m is 1, 2, 3 or 4;
each W is independently O, N—CN, N—NO₂, N—S═O, N—R^{A} or N—OR^{B};
R^{A} is H, C₁-C₄ alkyl or C₁-C₄ alkylcarbonyl;
R^{B} is H or C₁-C₄ alkyl;
T is —CH₂CH₂— or —CH═CH—;
R² is C₁-C₄ alkyl, C₃-C₅ cycloalkyl, C₂-C₄ alkoxyalkyl or C₄-C₈ cycloalkylalkyl;
R³ is hydroxy, —O⁻M⁺, C₂-C₈ alkylcarbonyloxy, C₂-C₈ haloalkylcarbonyloxy, C₄-C₁₀ cycloalkylcarbonyloxy or C₃-C₁₀ alkylcarbonylalkoxy; or benzyloxy, phenyloxy, benzylcarbonyloxy, phenylcarbonyloxy, phenylsulfonyloxy or benzylsulfonyloxy, each optionally substituted on ring members with up to two substituents selected from R¹⁹;
R⁹ is C₁-C₆ alkyl;
R¹⁰ is H, halogen or C₁-C₆ alkyl;
R¹¹ is H or C₁-C₆ alkyl;
R¹² is H, halogen, cyano, C₁-C₆ alkyl or C₃-C₈ cycloalkyl;
R¹⁴ and R¹⁶ are taken alone and are H or C₁-C₆ alkyl; or
R¹⁴ and R¹⁶ are taken together as —CH₂CH₂CH₂— or —CH═CHCH₂—; and
R¹⁹ is independently halogen, cyano, hydroxy, nitro, —CHO, —SH, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₈ cycloalkyl, C₃-C₈ halocycloalkyl, C₄-C₁₀ alkylcycloalkyl, C₄-C₁₀ cycloalkylalkyl, C₃-C₈ cycloalkenyl, C₃-C₈ halocycloalkenyl, C₂-C₈ alkoxyalkyl, C₄-C₁₀ cycloalkoxyalkyl, C₃-C₁₀ alkoxyalkoxyalkyl, C₂-C₈ alkylthioalkyl, C₂-C₈ alkylsulfinylalkyl, C₂-C₈ alkoxyhaloalkyl, C₂-C₅ cyanoalkyl, C₁-C₆ hydroxyalkyl, C₁-C₆ alkoxy, C₁-C₆ haloalkoxy, C₃-C₈ cycloalkoxy, C₃-C₈ halocycloalkoxy, C₄-C₁₀ cycloalkylalkoxy, C₂-C₆ alkenyloxy, C₂-C₆ haloalkenyloxy, C₂-C₈ alkoxyalkoxy, C₂-C₈ alkylcarbonyloxy, C₁-C₆ alkylthio, C₁-C₆ haloalkylthio, C₃-C₈ cycloalkylthio, C₁-C₆ alkylsulfinyl, C₁-C₆ haloalkylsulfinyl, C₁-C₆ alkylsulfonyl, C₁-C₆ haloalkylsulfonyl or C₃-C₈ cycloalkylsulfonyl.

3. The compound of claim 2 wherein
A is A-1, A-3 or A-5;
B¹ is C-1;
B² is C-3;
B³ is C-1;
R¹ is C₁-C₆ alkyl, C₃-C₆ alkenyl, C₃-C₆ alkynyl, C₂-C₆ alkoxyalkyl, C₄-C₈ alkoxyalkenyl, C₄-C₈ alkoxyalkynyl, C₃-C₈ alkoxyalkoxyalkyl, C₄-C₁₀ cycloalkylalkyl, C₄-C₁₀ cycloalkoxylalkyl, oxiranyl(C₁-C₃ alkyl) or oxetanyl(C₁-C₃ alkyl);
m is 1, 2 or 3;
each W is independently O, N—CN, N—NO₂ or N—S═O;
T is —CH₂CH₂—;
R² is C₁-C₄ alkyl, C₃-C₅ cycloalkyl, C₂-C₄ alkoxyalkyl or C₄-C₈ cycloalkylalkyl;
R³ is hydroxy, —O⁻M⁺ or C₂-C₈ alkylcarbonyloxy; or phenylsulfonyloxy optionally substituted with up to two substituents selected from R¹⁹;
R⁹ is CH₂CH₃;
R¹⁰ is H or CH₃;
R¹¹ is H;
R¹² is H, halogen, cyano, C₁-C₆ alkyl or C₃-C₈ cycloalkyl;
each R¹⁴, R¹⁵, R¹⁶ and R¹⁷ is independently H, Cl or CH₃; and
R¹⁹ is independently halogen, nitro, C₁-C₆ alkyl, C₁-C₆ haloalkyl, C₁-C₆ alkoxy, C₁-C₆ haloalkoxy or C₁-C₆ alkylthio.

4. The compound of claim 3 wherein
A is A-1 or A-3;
R¹ is C₁-C₆ alkyl, C₃-C₆ alkenyl, C₃-C₆ alkynyl, C₂-C₆ alkoxyalkyl, C₄-C₈ alkoxyalkenyl, C₄-C₈ alkoxyalkynyl, C₃-C₈ alkoxyalkoxyalkyl, C₄-C₁₀ cycloalkylalkyl or C₄-C₁₀ cycloalkoxylalkyl;
R² is CH₃ or cyclopropyl:
m is 2;
each W is independently O;
each p and q is independently 1;
R³ is hydroxy or C₂-C₈ alkylcarbonyloxy;
R¹⁴ and R¹⁵ are both H; and
each R¹⁶ and R¹⁷ is independently H or CH₃.

5. The compound of claim 4 wherein
A is A-1;
R¹ is C₁-C₆ alkyl or C₄-C₁₀ cycloalkylalkyl;
R² is CH₃; and
R³ is hydroxy or —OC(═O)CH₂CH(CH₃)₂.

6. The compound of claim 5 wherein
R¹ is cyclopropylmethyl; and
R³ is hydroxy.

7. A herbicidal composition comprising a compound of claim 1 and at least one component selected from the group consisting of surfactants, solid diluents and liquid diluents.

8. A herbicidal composition comprising a compound of claim 1, at least one additional active ingredient selected from the group consisting of other herbicides and herbicide safeners, and at least one component selected from the group consisting of surfactants, solid diluents and liquid diluents.

9. A method for controlling the growth of undesired vegetation comprising contacting the vegetation or its environment with a herbicidally effective amount of a compound of claim 1.
